(19) United States
(12) Patent Application Publication
(10) Pub. No.: US 2026/0071144 A1
(43) Pub. Date: Mar. 12, 2026

(54) DETERGENTS WITH IMPROVED DYE TRANSFER INHIBITION

(71) Applicant: SYMRISE AG, Holzminden (DE)

(72) Inventors: Tony BARTOLINI, Herblay-sur-Seine (FR); Anne-Laure AZAIS, Poissy (FR)

(21) Appl. No.: 19/123,827

(22) PCT Filed: Oct. 25, 2022
(86) PCT No.: PCT/EP2022/079773

§ 371 Date: Apr. 24, 2025

(51) Int. Cl. C11D 3/00; C11D 1/14; C11D 1/72; C11D 1/83; C11D 3/20; C11D 3/386; C11D 3/48

(52) U.S. Cl. CPC C11D 3/0021; C11D 1/83; C11D 3/2044; C11D 3/2072; C11D 3/38618; C11D 3/38645; C11D 3/48; C11D 1/143; C11D 1/146; C11D 1/72

(57) ABSTRACT

The present invention relates to detergent compositions that comprise a dye transfer inhibitor, an effective amount of 1,2-heptanediol and/or 2,3-heptanediol or a specific type of dye transfer inhibitor boosting agents, such as alkanediols, glyceryl caprylate, 4-hydroxyacetophenone, ethyl hexyl glycerin or tropolone, and a surfactant, and the use of said detergent composition for the preparation of a detergent product for household, institutional and industrial application. Furthermore, the present invention relates to a method of treating a stained and/or soiled substrate using the detergents according to the present invention. Additionally, the present invention relates to the use of 1,2-heptanediol and/or 2,3-heptanediol or of specific substances as defined herein for boosting the dye transfer inhibitor activity in a detergent. Moreover, the present invention relates to a method of enhancing the activity of a dye transfer inhibitor in a detergent by adding an effective amount of 1,2-heptanediol and/or 2,3-heptanediol or of specific dye transfer inhibitor boosters, such as alkanediols, glyceryl caprylate, 4-hydroxyacetophenone, ethyl hexyl glycerin or tropolone to said detergent. Finally, the present invention relates to the use of 4-hydroxyacetophenone as a dye transfer inhibitor in a detergent composition.

### TECHNICAL FIELD

The present invention refers generally to the field of detergents. In particular, it relates to detergent compositions comprising specific dye transfer inhibitor boosters and having improved dye transfer inhibition.

More specifically, the present invention relates to detergent compositions that comprise a dye transfer inhibitor, an effective amount of 1,2-heptanediol and/or 2,3-heptanediol or a specific type of dye transfer inhibitor boosting agents, such as alkanediols, glyceryl caprylate, 4-hydroxyacetophenone, ethyl hexyl glycerin or tropolone, and a surfactant, and the use of said detergent composition for the preparation of a detergent product for household, institutional and industrial application. Furthermore, the present invention relates to a method of treating a stained and/or soiled substrate using the detergents according to the present invention. Additionally, the present invention relates to the use of 1,2-heptanediol and/or 2,3-heptanediol or of specific substances as defined herein for boosting the dye transfer inhibitor activity in a detergent. Moreover, the present invention relates to a method of enhancing the activity of a dye transfer inhibitor in a detergent by adding an effective amount of 1,2-heptanediol and/or 2,3-heptanediol or of specific dye transfer inhibitor boosters, such as alkanediols, glyceryl caprylate, 4-hydroxyacetophenone, ethyl hexyl glycerin or tropolone to said detergent. Finally, the present invention relates to the use of 4-hydroxyacetophenone as a dye transfer inhibitor in a detergent composition.

### BACKGROUND ART

One of the most persistent and troublesome problems arising during conventional laundering operations is the tendency of some coloured fabrics to release a dye or dyes into the laundering solution.

Changes in the colour impression of washed, that is to say clean, textiles, can be based, on the one hand, on the fact that dye components are removed from the textile by the washing process, so-called “fading”, and on the other hand, dyes detached from differently coloured textiles can deposit on the textile, so-called “discolouration”. The discolouration aspect can also play a role in uncoloured laundry items if they are washed together with coloured laundry items. This problem is commonly referred to in the art as “dye transfer”.

In order to avoid these undesired side effects when removing dirt from textiles by treatment with aqueous system, usually surfactant containing detergents contain active substances which prevent the detachment of dyes from the textile or prevent the deposition of detached dyes present in the wash liquor onto textile, in particular if they are provided as so-called colour detergents.

Such substances are referred to as colour or dye transfer inhibitors (DTI).

There are three major mechanisms for the action of dye transfer inhibitors: the prevention of dye release from the donor fabric by a fixing agent, the adsorption or degradation of dye molecules once they enter the laundry liquor, and the prevention of dye molecules in the laundry liquor from depositing onto the fabric via obstruction.

In the past, various polymers have been included in detergent compositions to inhibit dye transfer. For example, the prior art disclosed detergents for washing discolouration-sensitive textiles comprising several water-soluble polymers including N-vinylimidazole, N-vinyloxyzolidone, N-vinylpyrrolidone and copolymers thereof to inhibit dye transfer.

The problem with the use of dye transfer inhibition agents in detergents containing anionic surfactants is that some dye transfer inhibition agents interact with anionic surfactants, thereby reducing overall dye transfer inhibition performance.

Consequently, there is a clear requirement for the development of dye transfer inhibitors that do not present the limitations as described above.

The detergent industry is permanently searching for ingredients which can resolve these negative aspects.

Thus, there is still an ongoing need for substances with the ability for improving dye transfer inhibition in detergents.

Accordingly, it is therefore an object of the present invention to provide multi-use detergents with an enhanced dye transfer inhibition, and, thus, result in less discolouration laundering.

Furthermore, it is an object of the present invention to provide detergents that provide better dye transfer inhibition compared to detergents comprising a usual dye transfer inhibitor.

Furthermore, it is an object of the present invention to provide a method of treating a substrate that prevents or at least minimizes the transfer of colour of coloured textiles to uncoloured or differently coloured textiles during their joint washing and rinsing in an aqueous liquor.

It is another object of the present invention to provide substances, which are capable of enhancing the dye transfer inhibitor in a detergent.

It is still another object of the present invention, to provide a method of enhancing the activity of a dye transfer inhibitor in a detergent.

Finally, it is an object of the present invention, to provide for a new dye transfer inhibitor.

The detergent compositions of the current disclosure, comprising a combination of a dye transfer inhibitor and a dye transfer inhibitor boosting agent, are found, surprisingly, to provide a superior stability against dye transfer during laundry. By adding a dye transfer inhibitor boosting agent or a dye transfer inhibitor boosting cocktail as specified above to a detergent containing a dye transfer inhibitor transfer of colour of coloured textiles to uncoloured or differently coloured textiles during their joint washing in an aqueous liquor can be prevented or at least reduced. As a result, dye transfer, and, thus, discolouration during laundry does not occurs or is at least minimize. Thus, the detergents according to the present invention have a better overall performance compared to detergents without the addition of an inventive dye transfer inhibitor boosting agent. Thus, dye transfer or discolouration upon laundry is prevented or at least minimized.

Conversely, also because of the enhanced inhibitory effect by the addition of the dye transfer inhibitor boosting agent in the detergent of the present disclosure, it is possible to use less dye transfer inhibitor in the detergent composition to achieve a similar dye transfer inhibiting effect.

Because of the superior dye transfer inhibiting effect of the detergent of the present disclosure, it is possible for the composition to have reduced or to even be free of other stabilizers commonly found in existing detergents, such as hydrophilic optical brighteners which also provide a dye transfer inhibition action.

### SUMMARY OF THE INVENTION

The present invention was made in view of the disadvantages described above. To solve the above-mentioned drawbacks, the present invention provides a detergent composition that noticeably minimizes or prevents dye transfer, and, thus, discolouration, during laundry.

In order to accomplish the above problem, the present invention provides in a first aspect a detergent composition, comprising or consisting of
(a1) at least one dye transfer inhibitor;
(b1) 1,2-heptanediol;
(c1) at least one surfactant; and
(d1) optionally at least one enzyme or an enzyme formulation, comprising at least one enzyme;
or
(a2) at least one dye transfer inhibitor;
(b2) 2,3-heptanediol;
(c2) at least one surfactant; and
(d2) optionally at least one enzyme or an enzyme formulation, comprising at least one enzyme;
or
(a3) at least one dye transfer inhibitor;
(b3) a mixture comprising 1,2-heptanediol and 2,3-heptanediol;
(c3) at least one surfactant; and
(d3) optionally at least one enzyme or an enzyme formulation, comprising at least one enzyme.

In a second aspect, the present invention provides a detergent, comprising or consisting of
(a) at least one dye transfer inhibitor;
(b) at least one dye transfer inhibitor booster selected from the group consisting of
   (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (b^{II}) glyceryl caprylate;
   (b^{III}) 4-hydroxyacetophenone;
   (b^{IV}) ethyl hexyl glycerin;
   (b^{V}) tropolone; and
   any mixture thereof;
(c) at least one surfactant; and
(d) optionally at least one enzyme or an enzyme formulation, comprising at least one enzyme.

In a third aspect, the present invention provides for the use of the detergent composition according to the present invention as, or for the preparation of a detergent product.

In a fourth aspect, the present invention provides for a detergent product.

In a further aspect, the present invention provides for a method of treating a stained and/or soiled substrate, comprising the steps of
treating the substrate with the detergent composition or product according to the present invention; and
rinsing said substrate in water to remove said composition or product.

In another aspect, the present invention provides for the use of 1,2-heptanediol or 2,3-heptanediol or a mixture comprising 1,2-heptanediol and 2,3-heptanediol or at least one dye transfer inhibitor booster (b) selected from the group consisting of
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
(b^{II}) glyceryl caprylate;
(b^{III}) 4-hydroxyacetophenone;
(b^{IV}) ethyl hexyl glycerin;
(b^{V}) tropolone; and
any mixture thereof;
for enhancing the activity of a dye transfer inhibitor in a detergent.

In a still further aspect, the present invention provides for a method of enhancing the activity of a dye transfer inhibitor in a detergent, comprising the steps of
(i) providing a detergent comprising a dye transfer inhibitor; and
(ii) adding thereto an effective amount of 1,2-heptanediol or 2,3-heptanediol or a mixture comprising 1,2-heptanediol and 2,3-heptanediol or at least one dye transfer inhibitor boosting agent (b) selected from the group consisting of
   (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (b^{II}) glyceryl caprylate;
   (b^{III}) 4-hydroxyacetophenone;
   (b^{IV}) ethyl hexyl glycerin;
   (b^{V}) tropolone; and
   any mixture thereof.

In a final aspect, the present invention provides for the use of 4-hydroxyacetophenone as dye transfer inhibitor.

The present invention is specified in the appended claims. The invention itself, and its preferred variants, other objects and advantages, are however also apparent from the following detailed description in conjunction with the accompanying examples and figures.

All percentages are by weight unless otherwise indicated.

Numeric ranges recited within the specification and given in the form “x to y” include the values defining the range and include each integer within the defined range.

When multiple preferred numeric ranges are specified in this format, all ranges created by combining the various endpoints are also included.

In the context of the present invention, the term “comprising” means that the named components are essential, but other components may be added and is still embraced by the present invention.

The term “consisting of” as used according to the present invention means that the total amount of components (a) to (c) in a composition adds up to 100% by weight, based on the total weight of the composition, and signifies that the subject matter is closed-ended and can only include the limitations that are expressly recited.

Whenever reference is made to “comprising” it is intended to cover both meanings as alternatives, that is the meaning can be either “comprising” or “consisting of”, unless the context dictates otherwise.

In the context of the present invention, the term “at least one . . . ” means that the detergent according to the present invention can comprise either one or a mixture of two, three, four, five, six or even more different of the respective components following said term.

The term “and/or” expresses that a linkage exists, or an alternative is provided.

The term “optionally” means that the subsequently described component may but need not to be present in the detergent, and that the description includes variants, where the compound is included or variants, where the compound is absent.

The term “boosting” in the context of the present invention means “improving”, “enhancing”, “increasing”. Correspondingly, a “boosting agent” is an agent capable of “improving”, “enhancing”, “increasing” certain features or properties as defined herein, and in particular the dye transfer inhibiting effect of a dye transfer inhibitor of a detergent composition upon laundry.

As used herein, the term “alkyl” refers to saturated hydrocarbons having one or more carbon atoms, including straight-chain alkyl groups (such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, etc.), cyclic alkyl groups (or cycloalkyl or alicyclic or carbocyclic groups) (such as cyclopropyl, cyclopentyl, cyclohexyl, cycloheptyl, cyclooctyl, etc.), branched-chain alkyl groups (such as isopropyl, tert-butyl, sec-butyl, isobutyl, etc.) and alkyl substituted alkyl groups (such as cycloalkyl-substituted alkyl groups).

Unless otherwise specified, the term “alkyl” includes both unsubstituted alkyls and substituted alkyls. As used herein, the term “substituted alkyls” refers to alkyl groups having substituents, replacing one or more hydrogens on one or more carbons of the hydrocarbon backbone. Such substituents may include, for example, alkenyl, alkynyl, halogen, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonate, cyano, amino, imino, sulfhydryl, alkylthio, arylthiol, thiocarboxylate, sulfates, alkylsulfinyl, sulfonates, nitro, etc.

### DETAILED DESCRIPTION OF THE INVENTION

In a first aspect, the present invention relates to a detergent, comprising or consisting of
(a1) at least one dye transfer inhibitor;
(b1) 1,2-heptanediol;
(c1) at least one surfactant; and
(d1) optionally at least one enzyme or an enzyme formulation, comprising at least one enzyme.

Alternatively, the present invention relates in a first aspect to a detergent, comprising or consisting of
(a2) at least one dye transfer inhibitor;
(b2) 2,3-heptanediol;
(c2) at least one surfactant; and
(d2) optionally at least one enzyme or an enzyme formulation, comprising at least one enzyme.

In a further alternative, the present invention relates in a first aspect to a detergent, comprising or consisting of
(a3) at least one dye transfer inhibitor;
(b3) a mixture comprising 1,2-heptanediol and 2,3-heptanediol;
(c3) at least one surfactant; and
(d3) optionally at least one enzyme or an enzyme formulation, comprising at least one enzyme.

In a second aspect, the present invention relates to a detergent, comprising or consisting of
(a) at least one dye transfer inhibitor;
(b) at least one dye transfer inhibitor booster selected from the group consisting of
   (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (b^{II}) glyceryl caprylate;
   (b^{III}) 4-hydroxyacetophenone;
   (b^{IV}) ethyl hexyl glycerin;
   (b^{V}) tropolone; and
   any mixture thereof;
(c) at least one surfactant; and
(d) optionally at least one enzyme or an enzyme formulation, comprising at least one enzyme.

Detergents refer to compositions that find use in the removal of undesired compounds from items to be cleaned, such as textiles or fabrics. These deposits might be caused by soils or stains. The detergent composition may be used to e.g. clean textiles, fabrics for both household cleaning, institutional cleaning and industrial cleaning. The detergent can be used by the detergent composition itself or by a detergent product or by a use solution thereof.

Detergents are composed predominantly of surfactants or a mixture of surfactants. Other than surfactant, the detergents compositions normally consist of builders and chelating agents, co-builders and other polymer additives used for specific effects such as anti-redeposition, dye transfer inhibition, rheology modification.

The detergents according to the first and second aspect of the present invention are preferably used for removing stain and/or soil from textile, fabrics, laundry, etc.

The terms “detergent(s)” and “detergent composition(s)” are used equivalent in the present description; the term “detergent(s)” when used as such also embraces a “detergent composition” and vice versa.

Within the scope of the present invention the terms “cleaning” and “washing” are used synonymously and refer to the reduction and/or removal of deposits, i.e. the removal of undesired compounds from items to be cleaned.

These deposits might be formed by stains caused by tea, chocolate, coffee, grass, red wine, grass/mud, fruit juice, blood, tomato puree, unused motor oil, salad dressing balsamic, cooked beef fat, French squeezy mustard, make-up, and the like or by soils caused by grease, starch based soils such as rice, pasta, protein based soils such as egg yolk, chocolate, mayonnaise, lipstick starch based soil, and the like and other remaining on the surfaces. Deposits are thus any form of unwanted residues of impureness, of dirt, food, grease etc.

The term “substrate” in the context of the present invention includes fabrics, textiles, laundry, and the like which can be contaminated with stain and/or soil and can be treated by a washing process.

The detergents according to the present invention provides for both, reduced transfer of colour of coloured textiles to uncoloured or differently coloured textiles during their joint washing in an aqueous liquor, and, thus, improved performance.

### Dye Transfer Inhibitor/Component (a1, a2, a3, a)

The detergent according to the first aspect or the second aspect of the present invention comprises at least one dye transfer inhibitor as component (a1, a2, a3, a) that provide dry transfer inhibition.

A dye transfer inhibitor is a substance that prevents or at least minimizes the transfer of dyes from one textile to another during the laundry, i.e. when uncoloured laundry items are washed together with coloured laundry items or different coloured laundry items are washed together.

Generally, such dye transfer inhibiting agents include polyvinyl pyrrolidone polymers, polyamine N-oxide polymers, copolymer of N-vinylpyrrolidone and N-vinylimidazole, manganese phthalocyanine, peroxidases, and any mixture thereof.

Copolymers of N-vinylpyrrolidone and N-vinylimidazole polymers (referred to as a class as “PVPVI”) are also preferred for use herein. Preferably the PVPVI has an average molecular weight range from 5,000 to 1,000,000, more preferably from 5,000 to 200,000, and most preferably from 10,000 to 20,000. The PVPVI copolymers typically have a molar ratio of N-vinylimidazole to N-vinylpyrrolidone from 1:1 to 0.2:1, more preferably from 0.8:1 to 0.3:1, most preferably from 0.6:1 to 0.4:1. These copolymers can be either linear or branched.

The present invention detergent compositions also can employ a polyvinylpyrrolidone (“PVP”) having an average molecular weight of from about 5,000 to about 400,000, preferably from about 5,000 to about 200,000, and more preferably from about 5,000 to about 50,000. PVP's are known to persons skilled in the detergent field. Compositions containing PVP can also contain polyethylene glycol (“PEG”) having an average molecular weight from about 500 to about 100,000, preferably from about 1,000 to about 10,000. Preferably, the ratio of PEG to PVP on a ppm basis delivered in wash solutions is from about 2:1 to about 50:1, and more preferably from about 3:1 to about 10:1.

More specifically, the polyamine N-oxide polymers preferred for use herein are described in U.S. Pat. No. 6,491,728, incorporated herein by reference. Any polymer backbone can be used as long as the amine oxide polymer formed is water-soluble and has dye transfer inhibiting properties. Examples of suitable polymeric backbones are polyvinyls, polyalkylenes, polyesters, polyethers, polyamide, polyimides, polyacrylates and mixtures thereof. These polymers include random or block copolymers where one monomer type is an amine N-oxide and the other monomer type is an N-oxide. The amine N-oxide polymers typically have a ratio of amine to the amine N-oxide of 10:1 to 1:1,000,000. However, the number of amine oxide groups present in the polyamine oxide polymer can be varied by appropriate copolymerization or by an appropriate degree of N-oxidation. The polyamine oxides can be obtained in almost any degree of polymerization. Typically, the average molecular weight is within the range of 500 to 1,000,000; more preferred 1,000 to 500,000; most preferred 5,000 to 100,000. This preferred class of materials can be referred to as “PVNO”. The most preferred polyamine N-oxide useful in the detergents herein is poly(4-vinylpyridine-N-oxide) which as an average molecular weight of about 50,000 and an amine to amine N-oxide ratio of about 1:4.

Suitable dye transfer inhibitors for the detergent according to the first aspect and second aspect of the present invention are selected from the group consisting of polyamine-N-oxide polymers, copolymers of N-vinylpyrrolidone and N-vinylimidazole, polyvinylpyrrolidone polymers, poylvinyloxazolidones, polyvinylimidazoles, manganese phthalocyanine, copolymers based on vinylmonomers and carboxamides, pyrrolidone group containing polyesters and polyamides, grafted polyamidoamines and polyethyleneimines, polyvinyl alcohols, copolymers based on acrylamidoalkenylsulfonic acids, polyvinylpyridine-N-oxide, poly-N-carboxymethyl-4-vinylpyridiumchlorid, and any mixture thereof.

In a preferred variant, the dye transfer inhibitor is selected from the group consisting of copolymers of N-vinylpyrrolidone and N-vinylimidazole, polyvinylpyrrolidone polymers, and any mixture thereof.

The above specified dye transfer inhibitors can be used either individually or in the form of mixtures of two, or even more dye transfer inhibitors.

### Dye Transfer Inhibitor Boosting Agent/Component (b1, b2, b3, b)

The detergent according to the first and second aspect of the present invention further includes at least one dye transfer inhibitor boosting agent or dye transfer inhibitor booster as component (b1, b2, b3, b). The terms “dye transfer inhibitor boosting agent” and “dye transfer inhibitor booster” are used in the present invention interchangeably.

Dye transfer inhibitor boosting agents within the meaning of the present invention are (b1) 1,2-heptanediol, (b2) 2,3-heptanediol, (b3) a mixture of 1,2-heptanediol and 2,3-heptanediol; (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol; (b^{II}) glyceryl caprylate; (b^{III}) 4-hydroxyacetophenone; (b^{IV}) ethyl hexyl glycerin; (b^{V}) tropolone; and any mixture thereof.

The dye transfer inhibitor boosting agents (b1, b2, b3, b) as specified above were found to efficiently enhance the inhibition of a dye transfer inhibitor in a detergent used during laundry, i.e. washing and rinsing, and, thus reduce or minimize or prevent the transfer of colour of coloured textiles to uncoloured or differently coloured textiles during their joint laundry. In this way, the overall performance of the detergent is improved in comparison to a detergent without such a dye transfer inhibitor boosting agent.

The component (b) in the detergent according to the first aspect of the present invention is either 1,2-heptanediol (b1) or 2,3-heptanediol (b2), or a mixture comprising both heptanediols, i.e. 1,2-heptanediol plus 2,3-heptanediol (b3).

1,2-Heptanediol belongs to the category of alkanediols and is a straight chain alkanediol with the general formula:

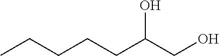

It has a carbon chain with 7 carbon atoms and the two functional OH groups of the alkanediol are in alpha,beta position and chemically bonded to the C1 and C2 carbon atoms in the alkanediol chain.

2,3-Heptanediol belongs to the category of alkanediols and is a straight chain alkanediol with the general formula:

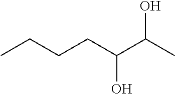

It has a carbon chain with 7 carbon atoms and the two functional OH groups of the alkanediol are in beta,gamma position and chemically bonded to the C2 and C3 carbon atoms in the alkanediol chain.

The dye transfer inhibitor boosting agent (b) in the detergent according to the second aspect of the present invention is selected from the group consisting of
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
(b^{II}) glyceryl caprylate;
(b^{III}) 4-hydroxyacetophenone;
(b^{IV}) ethyl hexyl glycerin;
(b^{V}) tropolone; and
any mixture thereof.

Alkanediols are glycols, i.e. any of a class of organic compounds belonging to the alcohol family; in the molecule of a glycol, two hydroxyl (—OH) groups are attached to different carbon atoms of a carbon chain.

Straight chain 1,2-alkanediols have been used for more than 15 years as multifunctional actives. Short chain 1,2-alkanediols are amphiphilic compounds and thus, like 1,2-pentanediol, 1,2-hexanediol and 1,2-heptanediol, are soluble both in water and oils. In contrast, 1,2-octanediol is a solid and tends to precipitate or recrystallize in oily solutions as well as in water at 0.5%. On the other hand, 1,2-decanediol is a solid and soluble only in oils. Apart from moisturizing, some 1,2-alkanediols are used as viscosity modifiers.

The dye transfer inhibitor boosting agent (b^{I}) of the detergent according to the second aspect of the present invention is in a first alternative at least one linear alkanediol having a carbon chain of 5 to 14 carbon atoms.

Moreover, in a second alternative of this second aspect, the dye transfer inhibitor boosting agent (b^{I}) may include a first linear alkanediol in combination with a second linear alkanediol, preferably at least one first linear alkanediol having a carbon chain of 5 to 14 carbon atoms and at least one second linear alkanediol having a carbon chain of 5 to 14 carbon atoms. Therefore, the invention also entails a mixture comprising a first and a second alkanediol as described herein.

Since the first linear alkanediol of the invention can be selected from the same lists and types of compounds as the linear alkanediol according to the first alternative of the second aspect, in the following, reference is made to the linear alkanediol in general, which can also be the first linear alkanediol. In mixtures of first and second linear alkanediols, where these are specifically different, the specific terms “first” and “second” will be used to distinguish the two alkanediol components.

As used in this document, the phrase “at least one linear alkanediol” or “at least one first linear alkanediol” means that the composition can comprise one linear alkanediol having a carbon chain of 5 to 14 carbon atoms or can comprise one first linear alkanediol having a carbon chain of 5 to 14 carbon atoms or can comprise more than one linear alkanediol or can comprise more than one linear alkanediol or more than one first linear alkanediol having a carbon chain of 5 to 14 carbon atoms, i.e. two, three, four or more different linear alkanediols or first linear alkanediols having a carbon chain of 5 to 14 carbon atoms.

The at least one linear alkanediol or the at least one first linear alkanediol according to the present invention consists of a chain of 5 to 14 carbon atoms joined to each other by single covalent bonds with two OH functional groups attached to two different carbon atoms in the chain.

The at least one linear alkanediol or the at least one first linear alkanediol having a carbon chain of 5 to 14 carbon atoms in the detergent according to the second aspect of the present invention is selected from the group consisting of pentanediol, hexanediol, heptanediol, octanediol, nonanediol, decanediol, undecanediol, dodecanediol, tridecanediol, and tetradecanediol.

In a preferred variant, the at least one linear alkanediol or the at least one first linear alkanediol has a carbon chain of 5 to 13 carbon atoms and is selected from the group consisting of pentanediol, hexanediol, heptanediol, octanediol, nonanediol, decanediol, undecanediol, dodecanediol and tridecanediol.

In a more preferred variant, the at least one linear alkanediol or the at least one first linear alkanediol has a carbon chain of 5 to 10 carbon atoms and is selected from the group consisting of pentanediol, hexanediol, heptanediol, octanediol, nonanediol, and decanediol.

In a more preferred variant, the at least one linear alkanediol or the at least one first linear alkanediol is selected from the group consisting of alkanediols having a lower number of carbon atoms of 5 to 8, i.e. pentanediol, hexanediol, heptanediol, octanediol, and any mixture thereof, or is selected from the group consisting of alkanediols having a number of carbon atoms of 6 to 8, i.e. hexanediol, heptanediol, octanediol, and any mixture thereof, or is selected from the group consisting of alkanediols having a number of carbon atoms of 7 and 8, i.e. heptanediol, octanediol, and any mixture thereof.

In a still more preferred variant, the at least one linear alkanediol or the at least one first linear alkanediol is selected from the group consisting of alkanediols having a higher number of carbon atoms of 9 to 14, i.e. nonanediol, decanediol, undecanediol, dodecanediol, tridecanediol, tetradecanediol, and any mixture thereof, or is selected from the group consisting of alkanediols having a number of carbon atoms of 9 to 13, i.e. nonanediol, decanediol, undecanediol, dodecanediol, tridecanediol, and any mixture thereof, or is selected from the group consisting of alkanediols having a number of carbon atoms of 9 to 12, i.e. nonanediol, decanediol, undecanediol, dodecanediol, and any mixture thereof, or is selected from the group consisting of alkanediols having a number of carbon atoms of 9 to 11, i.e. nonanediol, decanediol, undecanediol, and any mixture thereof, or is selected from the group consisting of alkanediols having a number of carbon atoms of 9 and 10, i.e. nonanediol, decanediol, and any mixture thereof.

In a still more preferred variant, the at least one linear alkanediol or the at least one first linear alkanediol is either pentanediol, hexanediol, heptanediol or octanediol, or any mixture thereof.

In a still more preferred variant, the at least one linear alkanediol or the at least one first linear alkanediol is either nonanediol, decanediol, undecanediol or dodecanediol, or any mixture thereof.

In a most preferred variant, the at least one linear alkanediol or the at least first linear alkanediol is heptanediol.

In a second alternative, the detergent according to the second aspect of the present invention comprises as dye transfer inhibitor boosting agent (b) a mixture comprising at least one first linear alkanediol having a carbon chain of 5 to 14 carbon atoms and one or more second linear alkanediol having a carbon chain of 5 to 14 carbon atoms which is/are different from the first linear alkanediol.

This means that the dye transfer inhibitor boosting agent (b) is an alkanediol mixture comprising at least one first linear alkanediol having a carbon chain of 5 to 14 carbon atoms and one or more, i.e. two, three, four or more second linear alkanediols having a carbon chain of 5 to 14 carbon atoms. In this alternative, the first linear alkanediol can be any of the alkanediols as described herein for the linear alkanediol in general and in particular for the first alternative of the second aspect.

For example, the mixture can include one first linear alkanediol and one, two, three or more second linear alkanediols; or the mixture can include two first linear alkanediols and one, two, three or more second linear alkanediols, etc. with the proviso, that in each mixture, the first linear alkanediols and the second linear alkanediols are different from each other.

The second linear alkanediol preferably consists of a chain of 5 to 14 carbon atoms joined to each other by single covalent bonds with two OH functional groups attached to two different carbon atoms in the chain.

The at least one second linear alkanediol having a carbon chain of 5 to 14 carbon atoms in the detergent according to the second aspect of the present invention is selected from the group consisting of pentanediol, hexanediol, heptanediol, octanediol, nonanediol, decanediol, undecanediol, dodecanediol, tridecanediol, and tetradecanediol.

In a preferred variant, the at least one second linear alkanediol has a carbon chain of 5 to 13 carbon atoms and is selected from the group consisting of pentanediol, hexanediol, heptanediol, octanediol, nonanediol, decanediol, undecanediol, dodecanediol, and tridecanediol.

In a more preferred variant, the at least one second linear alkanediol has a carbon chain of 5 to 10 carbon atoms and is selected from the group consisting of pentanediol, hexanediol, heptanediol, octanediol, nonanediol, and decanediol.

In a more preferred variant, the at least one second linear alkanediol is selected from the group consisting of pentanediol, hexanediol, heptanediol, octanediol and nonanediol, most preferably heptanediol, octanediol, and nonanediol.

The phrase “different from each other means” that the first linear alkanediols and the second linear alkanediols in the mixture are either different with regard to the length of their carbon chain, i.e. number of the carbon atoms, or with regard to their constitutional isomerism.

Likewise, the number of the carbon atoms of the first linear alkanediols and the second linear alkanediols in the mixture can also be same. For example, the first linear alkanediol and the second linear alkanediol have a carbon chain of 7 carbon atoms, but the first linear alkanediol and the second linear alkanediol are different with regard to their constitutional isomerism or with regard to their stereoisomerism.

If both the first and the second alkanediol is for example heptanediol, then the second linear alkanediol heptanediol is a different constitutional isomer or stereoisomer from the first linear alkanediol, according to the second alternative of the second aspect.

In a preferred variant, the detergent according to the second aspect of the present invention comprises a mixture comprising at least one first linear alkanediol having a carbon chain of 5 to 14 carbon atoms and one or more second linear alkanediol having a carbon chain of 5 to 14 carbon atoms wherein the number of the carbon atoms of the first and the second alkanediol is either same or different.

If both, the first and the second alkanediol have the same number of carbon atoms, such an alkanediol combination is herein also referred to as “homo alkanediol mixture” or “homo combination”. For example, the first linear alkanediol and the second linear alkanediol have a carbon chain of 7 carbon atoms, but the first linear alkanediol and the second linear alkanediol are different with regard to their constitutional isomerism or in regard to their stereoisomerism.

If the first and the second alkanediol have a different number of carbon atoms, such an alkanediol combination is herein also referred to as “hetero alkanediol mixture” or “hetero combination”. For example, the first linear alkanediol has a carbon chain of 7 carbon atoms and the second linear alkanediol has a carbon chain of 8 carbon atoms.

However, beyond that, the first linear alkanediol and the second linear alkanediol can be different in regard to their constitutional isomerism or with regard to their stereoisomerism.

In a preferred variant the present invention relates to a detergent, wherein the at least one linear alkanediol or the first linear alkanediol is selected from the group consisting of pentanediol, hexanediol, heptanediol, octanediol, nonanediol, decanediol, undecanediol, dodecanediol, tridecanediol, and tetradecanediol; and/or the second linear alkanediol is selected from the group consisting of pentanediol, hexanediol, heptanediol, octanediol, nonanediol, decanediol, undecanediol, dodecanediol, tridecanediol, and tetradecanediol.

Particular preferred is a dye transfer inhibitor boosting agent mixture, wherein the at least first linear alkanediol is selected from an alkanediol having a lower number of carbon atoms from 5 to 8 and wherein the one or more second alkanediol is selected from an alkanediol having a higher number of carbon atoms from 9 to 14.

Most preferred is a dye transfer inhibitor boosting agent mixture, wherein the at least first linear alkanediol is selected from the group consisting of pentanediol, hexanediol, heptanediol, octanediol, and any mixture thereof, and the one or more second alkanediol is selected from the group consisting of nonanediol, decanediol, undecanediol, dodecanediol, tridecanediol, tetradecanediol, and any mixture thereof.

The term “alkanediol” within the context of the present invention also includes its constitutional isomers or position isomers. Constitutional isomers are compounds that have the same molecular formula and different connectivity. Position isomers, a particular form of constitutional isomerism, are structural isomers that can be viewed as differing only on the position of a functional group on a parent structure, which in this case, in particular, is the position of the two alcohol functions.

Depending on the number of the carbon atoms of the carbon chain of the alkanediol, there are various position isomers of the alkanediol: (x,x+1) constitutional isomers; (x,x+2) constitutional isomers; (x,x+3) constitutional isomers; etc. and alpha,omega constitutional isomers when the alcohol functions are at the terminal ends of the carbon chain, wherein x stands for the number of the carbon atom in the alkanediol chain, to which the OH groups of the alkanediol are chemically bonded. For example: if x is 1, the two OH groups of the alkanediol are chemically bonded to the C1 and C2 carbon atoms in the alkanediol chain; if x is 2, the two OH groups of the alkanediol are chemically bonded to the C2 and C3 carbon atoms in the alkanediol chain, etc.

In the (x,x+1) constitutional isomers, the two OH functional groups are vicinal attached to two different adjacent carbon atoms in the chain. In the (x,x+2) constitutional isomers, the two OH functional groups are attached to two different carbon atoms in the chain where the two carbon atoms are separated by one C atom. In the (x,x+3) constitutional isomers, the two OH functional groups are attached to two different carbon atoms in the chain where the two carbon atoms are separated by two C atoms. In the alpha,omega constitutional isomers, the two functional groups are attached to the first C atom and to the terminal C atom.

In a preferred variant of the detergent according to the second aspect of the present invention, the linear alkanediol having a carbon chain of 5 to 14 carbon atoms, is preferably a vicinal (x,x+1) diol, selected from the group consisting of a 1,2-diol, 2,3-diol, 3,4-diol, 4,5-diol, further (x,x+1) diols, and mixtures thereof, preferably an alpha,beta-1,2-constitutional isomer.

In a more preferred variant of the detergent according to the second aspect of the present invention, the first linear alkanediol and/or the second linear alkanediol having a carbon chain of 5 to 14 carbon atoms is a vicinal (x,x+1) diol, selected from the group consisting of a 1,2-diol, 2,3-diol, 3,4-diol, 4,5-diol, further (x,x+1) diols, and mixtures thereof, preferably an alpha,beta-1,2-constitutional isomer.

Thus, according to a preferred variant of the detergent according to the second aspect of the present invention, the at least one linear alkanediol, the first linear alkanediol and/or the second linear alkanediol is an (x,x+1) constitutional isomer, wherein x stands for the number of the carbon atom in the alkanediol chain, to which the OH groups of the alkanediol are chemically bonded, in particular a 1,2-alkanediol, a 2,3-alkanediol, a 3,4-alkanediol, or mixtures thereof, preferably a 1,2-alkanediol or a 2,3-alkanediol.

In a further preferred variant of the detergent according to the second aspect of the present invention, the linear alkanediol having a carbon chain of 5 to 14 carbon atoms, is preferably a non-vicinal (x,x+2) diol, selected from the group consisting of a 1,3-diol, 2,4-diol, 3,5-diol, further (x,x+2) diols, and mixtures thereof, preferably an alpha,gamma-1,3-constitutional isomer.

In a preferred variant of the detergent according to the second aspect of the present invention, the first linear alkanediol and/or the second linear alkanediol having a carbon chain of 5 to 14 carbon atoms is a non-vicinal (x,x+2) diol, selected from the group consisting of a 1,3-diol, 2,4-diol, 3,5-diol, 4,6-diol, further (x,x+2) diols, and mixtures thereof, preferably an alpha,gamma-1,3-constitutional isomer.

In a further preferred variant of the detergent according to the second aspect of the present invention, the linear alkanediol having a carbon chain of 5 to 14 carbon atoms, is preferably a non-vicinal (x,x+3) diol, selected from the group consisting of a 1,4-diol, 2,5-diol, further (x,x+3) diols, and mixtures thereof, preferably an alpha,delta-1,4-constitutional isomer.

In a preferred variant of the detergent according to the second aspect of the present invention, the first linear alkanediol and/or the second linear alkanediol having a carbon chain of 5 to 14 carbon atoms is a non-vicinal (x,x+3) diol, selected from the group consisting of a 1,4-diol, 2,5-diol, further (x,x+3) diols, and mixtures thereof, preferably an alpha,delta-1,4-constitutional isomer.

In a preferred variant of the detergent according to the second aspect of the invention, the linear alkanediol or the first linear alkanediol and/or the second linear alkanediol is preferably an alpha,omega alkanediol, more preferably, 1,7-heptanediol or 1,8-octanediol.

According to the present invention, vicinal (x,x+1) diols are most preferred, such as alpha,beta or beta,gamma or gamma,delta etc.

In a still more preferred variant of the detergent according to the second aspect of the present invention, the linear alkanediol and in particular the first linear alkanediol and/or the second linear alkanediol, is a 1,2-alkanediol, a 2,3-alkanediol, a 3,4-alkanediol, or mixtures thereof, more preferred 2,3-alkanediol.

The 1,2-alkanediols of the linear alkanediol, in particular the first linear alkanediol having a carbon chain of 5 to 14 carbon atoms and/or the second linear alkanediol having a carbon chain of 5 to 14 carbon atoms, can preferably be those as represented by the following formulae:

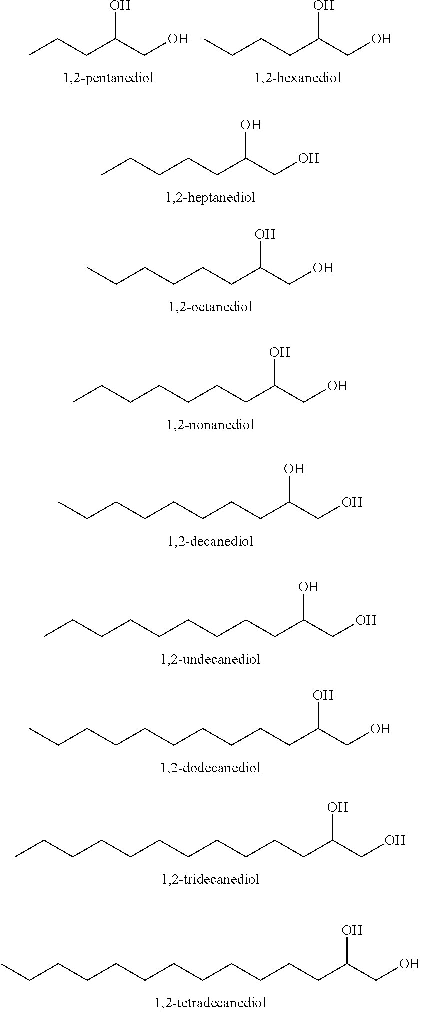

The 2,3-alkanediols of the linear alkanediol of the invention, in particular the first linear alkanediol having a carbon chain of 5 to 14 carbon atoms and/or the second linear alkanediol having a carbon chain of 5 to 14 carbon atoms, can preferably be those as represented by the following formulae:

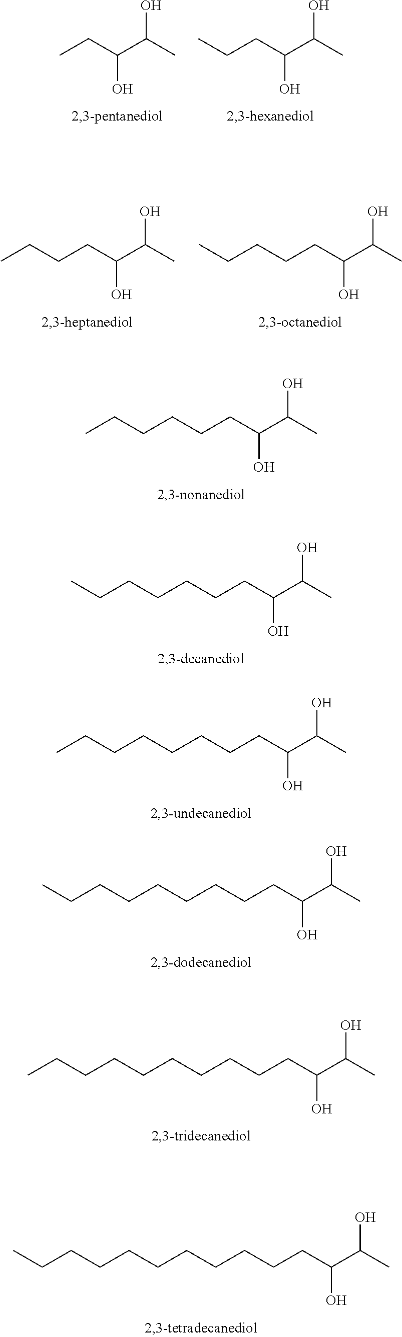

The 3,4-alkanediols of the linear alkanediol, preferably the first linear alkanediol having a carbon chain of 5 to 14 carbon atoms and/or the second linear alkanediol having a carbon chain of 5 to 14 carbon atoms, can preferably be those as represented by the following formulae:

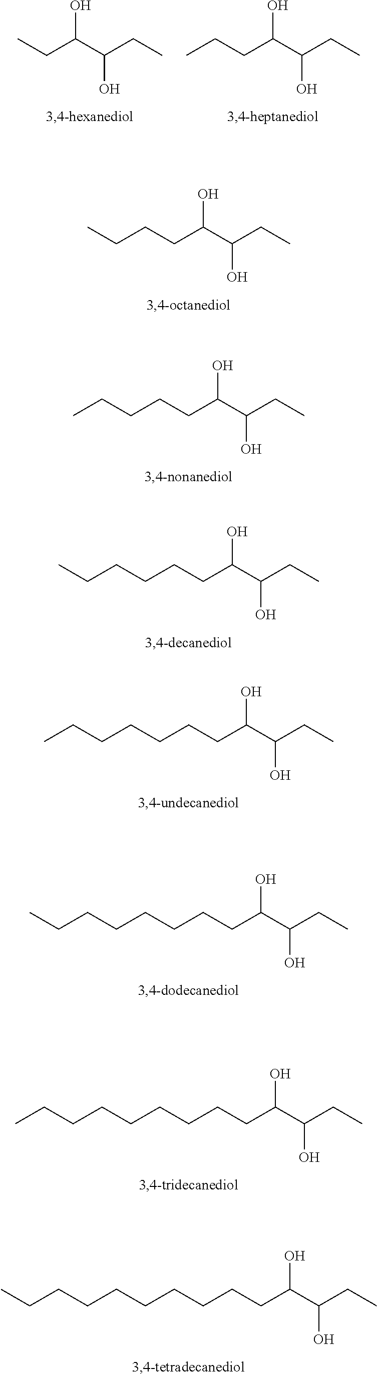

In a preferred variant of the detergent composition according to the second aspect of the present invention, the linear alkanediol or the first linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanedioll, 3,4-tetradecanediol,
and any mixture thereof.

According to a preferred variant, in the detergent according to the present invention the linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecenediol, 2,3-tetradecanediol, and any mixture thereof.

Of the aforesaid linear alkanediols or the first linear alkanediols, the following (x,x+1) constitutional isomers are preferred: 1,2-pentanediol, 2,3-pentanediol, 1,2-hexanediol, 2,3-hexanediol, 1,2-heptanediol, 2,3-heptanediol, 2,3-octanediol, 2,3-nonanediol, 2,3-decanediol, 2,3-undecanediol, 2,3-dodecanediol, 2,3-tridecanediol or mixtures thereof. Said alkanediols are liquid at a purity of 90 to 99%.

Of the aforesaid liquid alkanediols 1,2-pentanediol, 2,3-pentanediol, 1,2-hexanediol, 2,3-hexanediol, 1,2-heptanediol, 2,3-heptanediol, 2,3-octanediol, 2,3-nonanediol, or mixtures of said liquid alkanediols are particularly preferred.

In a further preferred variant of the detergent according to the second aspect of the present invention, the linear alkanediol or the first linear alkanediol is selected from the group consisting of:
1,2-pentanediol, 2,3-pentanediol,
1,2-hexanediol, 2,3-hexanediol,
1,2-heptanediol, 2,3-heptanediol,
1,2-octanediol, 2,3-octanediol, and any mixture thereof.

More preferred, in the detergent according to the second aspect of the present invention, the linear alkanediol or the first linear alkanediol is selected from the group consisting of 1,2-pentanediol, 2,3-pentanediol, and mixtures thereof, or is selected from the group consisting of 1,2-heptanediol, 2,3-heptanediol, and mixtures thereof. However, the linear alkanediol or the first linear alkanediol can also preferably be selected from the group consisting of 1,2-octanediol, 2,3-octanediol, and mixtures thereof.

Even more preferred, in the detergent according to the second aspect of the present invention, the linear alkanediol or the first linear alkanediol is an alpha,beta or a beta,gamma diol as either 1,2-heptanediol or 2,3-heptandediol or a mixture thereof. However, the linear alkanediol or the first linear alkanediol can also preferably be an alpha,beta or a beta,gamma diol as either 1,2-octanediol or 2,3-octanediol or a mixture thereof. A mixture comprising 1,2-heptanediol and 2,3-octanediol or a mixture comprising 1,2-octanediol and 2,3-heptanediol is also possible.

Most preferred, the linear alkanediol or the first linear alkanediol is 1,2-pentanediol or 2,3-pentanediol or 1,2-hexanediol or 2,3-hexanediol or 1,2-heptanediol or 2,3-heptanediol or 1,2-octanediol or 2,3-octanediol or 1,2-nonanediol or 2,3-nonanediol.

Likewise, in a further preferred variant of the detergent according to the second aspect of the present invention, the linear alkanediol or the first linear alkanediol is selected from the group consisting of 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

More preferred, in the detergent according to the second aspect of the present invention, the linear alkanediol or the first linear alkanediol is selected from the group consisting of 1,2-nonanediol, 2,3-nonanediol, and mixtures thereof, or can also be preferably selected from the group consisting of 1,2-decanediol, 2,3-decanediol, and mixtures thereof, or can also be preferably selected from the group consisting of 1,2-undecanediol, 2,3-undecanediol, and mixtures thereof.

In a more preferred variant, the at least one linear alkanediol or the at least one first linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, or is selected from the group consisting of 1,2-alkanediols having a number of carbon atoms of 6 to 8, i.e. 1,2-hexanediol, 1,2-heptanediol, 1,2-octanediol, and any mixture thereof, or is selected from the group consisting of 1,2-alkanediols having a number of carbon atoms of 7 and 8, i.e. 1,2-heptanediol, 1,2-octanediol, and any mixture thereof.

In a still more preferred variant, the at least one linear alkanediol or the at least one first linear alkanediol is either 1,2-pentanediol or 1,2-hexanediol or 1,2-heptanediol or 1,2-octanediol or any mixture thereof.

In a most preferred variant, the at least one linear alkanediol or the at least first linear alkanediol is 1,2-heptanediol.

It was found that these alkanediols particularly enhance the inhibitory effect of a dye transfer inhibitor in a detergent. 1,2-Alkanediols having a lower number of carbon atoms are thus efficient for use as dye transfer inhibition boosting agents in detergents comprising a dye transfer inhibitor.

In a still more preferred variant, the at least one linear alkanediol or the at least one first linear alkanediol is selected from the group consisting of 1,2-alkanediols having a higher number of carbon atoms of 9 to 14, i.e. 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 9 to 13, i.e. 1,2-nonanediol, 1,2-decanediol, 1,2-undecanediol, 1,2-dodecanediol, 1,2-tridecanediol, and any mixture thereof, or is selected from the group consisting of 1,2-alkanediols having a number of carbon atoms of 9 to 12, i.e. 1,2-nonanediol, 1,2-decanediol, 1,2-undecanediol, 1,2-dodecanediol, and any mixture thereof, or is selected from the group consisting of 1,2-alkanediols having a number of carbon atoms of 9 to 11, i.e. 1,2-nonanediol, 1,2-decanediol, 1,2-undecanediol, and any mixture thereof, or is selected from the group consisting of 1,2-alkanediols having a number of carbon atoms of 9 and 10, i.e. 1,2-nonanediol, 1,2-decanediol, and any mixture thereof.

In a still more preferred variant, the at least one linear alkanediol or the at least one first linear alkanediol is either 1,2-nonanediol or 1,2-decanediol or 1,2-undecanediol or 1,2-dodecanediol or any mixture thereof.

According to a preferred variant, the at least one linear alkanediol or the at least one first linear alkanediol is selected from the group consisting of 1,2-alkanediols having a higher number of carbon atoms, and more specifically more than 10 carbon atoms, i.e. 11, 12, 13, or 14 carbon atoms.

It was found that these alkanediols show outstanding dye transfer inhibitor boosting properties. 1,2-Alkanediols having a higher number of carbon atoms, and more specifically more than 10 carbon atoms, are thus efficient for use as dye transfer inhibitor boosting agents in detergents comprising a dye transfer inhibitor.

In a still more preferred variant, the linear alkanediol or the first linear alkanediol is selected from the group consisting of 2,3-alkanediols having a lower number of carbon atoms of 5 to 8, i.e. 2,3-pentanediol, 2,3-hexanediol, 2,3-heptanediol, 2,3-octanediol, and any mixture thereof, or is selected from the group consisting of 2,3-alkanediols having a number of carbon atoms of 6 to 8, i.e. 2,3-hexanediol, 2,3-heptanediol, 2,3-octanediol, and any mixture thereof, or is selected from the group consisting of 2,3-alkanediols having a number of carbon atoms of 7 and 8, i.e. 1,2-heptanediol, 1,2-octanediol, and any mixture thereof.

In a still more preferred variant, the at least one linear alkanediol or the at least one first linear alkanediol is either 2,3-pentanediol or 2,3-hexanediol or 2,3-heptanediol or 2,3-octanediol or any mixture thereof.

In a most preferred variant, the at least one linear alkanediol or the at least first linear alkanediol is 2,3-heptanediol.

It was found that these alkanediols particularly enhance the inhibitory effect of a dye transfer inhibitor in a detergent. 2,3-Alkanediols having a lower number of carbon atoms are thus efficient for use as dye transfer inhibition boosting agents in detergents comprising a dye transfer inhibitor.

In a still more preferred variant, the at least one linear alkanediol or the at least one first linear alkanediol is selected from the group consisting of 2,3-alkanediols having a higher number of carbon atoms of 9 to 14, i.e. 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 9 to 13, i.e. 2.3-nonanediol, 2,3-decanediol, 2,3-undecanediol, 2,3-dodecanediol, 2,3-tetradecanediol, and any mixture thereof, or is selected from the group consisting of 2,3-alkanediols having a number of carbon atoms of 9 to 12, i.e. 2.3-nonanediol, 2,3-decanediol, 2,3-undecanediol, 2,3-dodecanediol, and any mixture thereof, or is selected from the group consisting of 2,3-alkanediols having a number of carbon atoms of 9 to 11, i.e. 2,3-nonanediol, 2,3-decanediol, 2,3-undecanediol, and any mixture thereof, or is selected from the group consisting of 2,3-alkanediols having a number of carbon atoms of 9 and 10, i.e. 2,3-nonanediol, 2,3-decanediol, and any mixture thereof.

In a still more preferred variant, the at least one linear alkanediol or the at least one first linear alkanediol is either 2,3-nonanediol, 2,3-decanediol, 2,3-undecanediol or 2,3-dodecanediol, or any mixture thereof.

According to a preferred variant, the at least one linear alkanediol or the at least one first linear alkanediol is selected from the group consisting of 2,3-alkanediols having a higher number of carbon atoms, and more specifically more than 10 carbon atoms, i.e. 11, 12, 13 or 14 carbon atoms.

It was found that these alkanediols show outstanding dye transfer inhibitor boosting properties. 2,3-Alkanediols having a higher number of carbon atoms, and more specifically more than 10 carbon atoms, are thus efficient for use as dye transfer inhibitor boosting agents in detergents comprising a dye transfer inhibitor.

In a preferred variant of the detergent according to the second aspect of the present invention, the second linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octancediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanedioll, 3,4-tetradecanediol, and any mixture thereof.

According to a preferred variant, in the detergent according to the present invention the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, and any mixture thereof.

Of the aforesaid second linear alkanediols, the following (x,x+1) constitutional isomers are preferred: 1,2-pentanediol, 2,3-pentanediol, 1,2-hexanediol, 2,3-hexanediol, 1,2-heptanediol, 2,3-heptanediol, 2,3-octanediol, 2,3-nonanediol, 2,3-decanediol, 2,3-undecanediol, 2,3-dodecanediol, or 2,3-tridecanediol. Said alkanediols are liquid at a purity of 90 to 99%.

Of the aforesaid liquid alkanediols 1,2-pentanediol, 2,3-pentanediol, 1,2-hexanediol, 2,3-hexanediol, 1,2-heptanediol, 2,3-heptanediol, 2,3-octanediol, 2,3-nonanediol or mixtures of said liquid alkanediols are particularly preferred.

In a further preferred variant of the detergent according to the second aspect of the present invention, the second linear alkanediol is selected from the group consisting of:
1,2-pentanediol, 2,3-pentanediol,
1,2-hexanediol, 2,3-hexanediol,
1,2-heptanediol, 2,3-heptanediol,
1,2-octanediol, 2,3-octanediol, and any mixture thereof.

More preferred, in the detergent according to the second aspect of the present invention, the second linear alkanediol is selected from the group consisting of 1,2-pentanediol, 2,3-pentanediol, and mixtures thereof, or is selected from the group consisting of 1,2-heptanediol, 2,3-heptanediol, and mixtures thereof. However, the second linear alkanediol can also preferably be selected from the group consisting of 1,2-octanediol, 2,3-octanediol, and mixtures thereof.

Even more preferred, in the detergent according to the second aspect of the present invention, the second linear alkanediol is an alpha,beta or a beta,gamma diol as either 1,2-pentanediol or 2,3-pentanediol or a mixture thereof. However, the second linear alkanediol can also preferably be an alpha,beta or a beta,gamma diol as either 1,2-hexanediol or 2,3-hexanediol or a mixture thereof. A mixture comprising 1,2-pentanediol and 2,3-hexanediol or a mixture comprising 2,3-pentanediol and 1,2-hexanediol is also possible.

Most preferred, the second linear alkanediol is 1,2-pentanediol or 2,3-pentanediol or 1,2-hexanediol or 2,3-hexanediol or 1,2-heptanediol or 2,3-heptanediol, or 2,3-octanediol or 2,3-nonanediol.

Likewise, in a further preferred variant of the detergent according to the second aspect of the present invention, the second linear alkanediol is selected from the group consisting of 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

More preferred, in the detergent according to the second aspect of the present invention, the second linear alkanediol is selected from the group consisting of 1,2-nonanediol, 2,3-nonanediol, and mixtures thereof, or can also be preferably selected form the group consisting of 1,2-decanediol, 2,3-decanediol, and mixtures thereof, or can also be preferably selected from the group consisting of 1,2-undecanediol, 2,3-undecanediol, and mixtures thereof.

In a more preferred variant, the second linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, or is selected from the group consisting of 1,2-alkanediols having a number of carbon atoms of 6 to 8, i.e. 1,2-hexanediol, 1,2-heptanediol, 1,2-octanediol, and any mixture thereof, or is selected from the group consisting of 1,2-alkanediols having a number of carbon atoms of 7 and 8, i.e. 1,2-heptanediol, 1,2-octanediol, and any mixture thereof.

In a still more preferred variant, the second linear alkanediol is either 1,2-pentanediol or 1,2-hexanediol or 1,2-heptanediol or 1,2-octanediol or any mixture thereof.

In a most preferred variant, the second linear alkanediol is 1,2-heptanediol.

It was found that these alkanediols particularly enhance the inhibitory effect of a dye transfer inhibitor in a detergent. 1,2-Alkanediols having a lower number of carbon atoms are thus efficient for use as dye transfer inhibition boosting agents in detergents comprising a dye transfer inhibitor.

In a still more preferred variant, the second linear alkanediol is selected from the group consisting of 1,2-alkanediols having a higher number of carbon atoms of 9 to 14, i.e. 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 9 to 13, i.e. 1,2-nonanediol, 1,2-decanediol, 1,2-undecanediol, 1,2-dodecanediol, 1,2-tridecanediol, and any mixture thereof, or is selected from the group consisting of 1,2-alkanediols having a number of carbon atoms of 9 to 12, i.e. 1,2-nonanediol, 1,2-decanediol, 1,2-undecanediol, 1,2-dodecanediol, and any mixture thereof, or is selected from the group consisting of 1,2-alkanediols having a number of carbon atoms of 9 to 11, i.e. 1,2-nonanediol, 1,2-decanediol, 1,2-undecanediol, and any mixture thereof, or is selected from the group consisting of 1,2-alkanediols having a number of carbon atoms of 9 and 10, i.e. 1,2-nonanediol, 1,2-decanediol, and any mixture thereof.

In a still more preferred variant, the second linear alkanediol is either 1,2-nonanediol or 1,2-decanediol or 1,2-undecanediol or 1,2-dodecanediol or any mixture thereof.

According to a preferred variant, the second linear alkanediol is selected from the group consisting of 1,2-alkanediols having a higher number of carbon atoms, and more specifically more than 10 carbon atoms, i.e. 11, 12, 13 or 14 carbon atoms.

It was found that these alkanediols show outstanding dye transfer inhibitor boosting properties. 1,2-Alkanediols having a higher number of carbon atoms, and more specifically more than 10 carbon atoms, are thus efficient for use as dye transfer inhibitor boosting agents in detergents comprising a dye transfer inhibitor.

In a still more preferred variant, the second linear alkanediol is selected from the group consisting of 2,3-alkanediols having a lower number of carbon atoms of 5 to 8, i.e. 2,3-pentanediol, 2,3-hexanediol, 2,3-heptanediol, 2,3-octanediol, and any mixture thereof, or is selected from the group consisting of 2,3-alkanediols having a number of carbon atoms of 6 to 8, i.e. 2,3-hexanediol, 2,3-heptanediol, 2,3-octanediol, and any mixture thereof, or is selected from the group consisting of 2,3-alkanediols having a number of carbon atoms of 7 and 8, i.e. 1,2-heptanediol, 1,2-octanediol, and any mixture thereof.

In a still more preferred variant, the second linear alkanediol is either 2,3-pentanediol or 2,3-hexanediol or 2,3-heptanediol or 2,3-octanediol or any mixture thereof.

In a most preferred variant, the second linear alkanediol is 2,3-heptanediol.

It was found that these alkanediols particularly enhance the inhibitory effect of a dye transfer inhibitor in a detergent. 2,3-Alkanediols having a lower number of carbon atoms are thus efficient for use as dye transfer inhibition boosting agents in detergents comprising a dye transfer inhibitor.

In a still more preferred variant, the second linear alkanediol is selected from the group consisting of 2,3-alkanediols having a higher number of carbon atoms of 9 to 14, i.e. 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 9 to 13, i.e. 2.3-nonanediol, 2,3-decanediol, 2,3-undecanediol, 2,3-dodecanediol, 2,3-tridecanediol, and any mixture thereof, or is selected from the group consisting of 2,3-alkanediols having a number of carbon atoms of 9 to 12, i.e. 2.3-nonanediol, 2,3-decanediol, 2,3-undecanediol, 2,3-dodecanediol, and any mixture thereof, or is selected from the group consisting of 2,3-alkanediols having a number of carbon atoms of 9 to 11, i.e. 2,3-nonanediol, 2,3-decanediol, 2,3-undecanediol, and any mixture thereof, or is selected from the group consisting of 2,3-alkanediols having a number of carbon atoms of 9 and 10, i.e. 2,3-nonanediol, 2,3-decanediol, and any mixture thereof.

In a still more preferred variant, the second linear alkanediol is either 2,3-nonanediol or 2,3-decanediol or 2,3-undecanediol or 2,3-dodecanediol or any mixture thereof.

According to a preferred variant, the second linear alkanediol is selected from the group consisting of 2,3-alkanediols having a higher number of carbon atoms, and more specifically more than 10 carbon atoms, i.e. 11, 12, 13 or 14 carbon atoms.

It was found that these alkanediols show outstanding dye transfer inhibitor boosting properties. 2,3-Alkanediols having a higher number of carbon atoms, and more specifically more than 10 carbon atoms, are thus efficient for use as dye transfer inhibitor boosting agents in detergents comprising a dye transfer inhibitor.

In a further preferred variant, in the detergent composition according to the second aspect of the present invention the at least one linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof; and/or
the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

In a more preferred variant, the detergent composition according to the second aspect of the present invention which comprises a mixture or a combination comprising at least one first linear alkanediol and one or more second linear alkanediol thus includes any one of the following mixtures/combinations:
1,2-pentanediol in combination with one of 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-hexanediol in combination with one of 1,2-pentanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-heptanediol in combination with one of 1,2-pentanediol, 1,2-hexanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-octanediol in combination with one of 1,2-pentanediol, 1,2-hexanediol, 1,2-heptanediol, 1,2-nonanediol, 1,2-decanediol, 1,2-undecanediol, 1,2-dodecanediol, 1,2-tridecanediol, or 1,2-tetradecanediol; or
1,2-nonanediol in combination with one of 1,2-pentanediol, 1,2-hexanediol, 1,2-heptanediol, 1,2-octanediol, 1,2-decanediol, 1,2-undecanediol, 1,2-dodecanediol, 1,2-tridecanediol, or 1,2-tetradecanediol; or
1,2-decanediol in combination with one of 1,2-pentanediol, 1,2-hexanediol, 1,2-heptanediol, 1,2-octanediol, 1,2-nonanediol, 1,2-undecanediol, 1,2-dodecanediol, 1,2-tridecanediol, or 1,2-tetradecanediol; or
1,2-undecanediol in combination with one of 1,2-pentanediol, 1,2-hexanediol, 1,2-heptanediol, 1,2-octanediol, 1,2-nonanediol, 1,2-decanediol, 1,2-dodecanediol, 1,2-tridecanediol, or 1,2-tetradecanediol; or
1,2-dodecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-tridecanediol, or 1,2-tetradecanediol; or
1,2-tridecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tetradecanediol; or
1,2-tetradecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tridecanediol; or
2,3-pentanediol in combination with one of 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-hexanediol in combination with one of 1,2-pentanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-heptanediol in combination with one of 1,2-pentanediol, 1,2-hexanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-octanediol in combination with one of 1,2-pentanediol, 1,2-hexanediol, 1,2-heptanediol, 1,2-nonanediol, 1,2-decanediol, 1,2-undecanediol, 1,2-dodecanediol, 1,2-tridecanediol, or 1,2-tetradecanediol; or
2,3-nonanediol in combination with one of 1,2-pentanediol, 1,2-hexanediol, 1,2-heptanediol, 1,2-octanediol, 1,2-decanediol, 1,2-undecanediol, 1,2-dodecanediol, 1,2-tridecanediol, or 1,2-tetradecanediol; or
2,3-decanediol in combination with one of 1,2-pentanediol, 1,2-hexanediol, 1,2-heptanediol, 1,2-octanediol, 1,2-nonanediol, 1,2-undecanediol, 1,2-dodecanediol, 1,2-tridecanediol, or 1,2-tetradecanediol; or
2,3-undecanediol in combination with one of 1,2-pentanediol, 1,2-hexanediol, 1,2-heptanediol, 1,2-octanediol, 1,2-nonanediol, 1,2-decanediol, 1,2-dodecanediol, 1,2-tridecanediol, or 1,2-tetradecanediol; or
2,3-dodecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-tridecanediol, or 1,2-tetradecanediol; or
2,3-tridecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tetradecanediol;
2,3-tetradecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tridecanedio; or
2,3-pentanediol in combination with one of 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol; or
2,3-hexanediol in combination with one of 2,3-pentanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol; or
2,3-heptanediol in combination with one of 2,3-pentanediol, 2,3-hexanediol, 2,3-octanediol, 2,3-nonanediol, 2,3-decanediol, 2,3-undecanediol, 2,3-dodecanediol, 2,3-tridecanediol, or 2,3-tetradecanediol; or
2,3-octanediol in combination with one of 2,3-pentanediol, 2,3-hexanediol, 2,3-heptanediol, 2,3-nonanediol, 2,3-decanediol, 2,3-undecanediol, 2,3-dodecanediol, 2,3-tridecanediol, or 2,3-tetradecanediol; or
2,3-nonanediol in combination with one of 2,3-pentanediol, 2,3-hexanediol, 2,3-heptanediol, 2,3-octanediol, 2,3-decanediol, 2,3-undecanediol, 2,3-dodecanediol, 2,3-tridecanediol, or 2,3-tetradecanediol; or
2,3-decanediol in combination with one of 2,3-pentanediol, 2,3-hexanediol, 2,3-heptanediol, 2,3-octanediol, 2,3-nonanediol, 2,3-undecanediol, 2,3-dodecanediol, 2,3-tridecanediol, or 2,3-tetradecanediol; or
2,3-undecanediol in combination with one of 2,3-pentanediol, 2,3-hexanediol, 2,3-heptanediol, 2,3-octanediol, 2,3-nonanediol, 2,3-decanediol, 2,3-dodecanediol, 2,3-tridecanediol, or 2,3-tetradecanediol; or
2,3-dodecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-tridecanediol, or 2,3-tetradecanediol; or
2,3-tridecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, or 2,3-tetradecanediol; or
2,3-tetradecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol or 2,3-tridecanediol.

In a particular preferred variant, in the detergent according to the second aspect of the present invention, the linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof.

In a particularly preferred variant, the detergent according to the second aspect of the present invention which comprises a mixture or a combination comprising at least one first linear alkanediol and one or more second linear alkanediol includes any one of the following mixtures/combinations:
a mixture comprising 1,2-pentanediol and 2,3-pentanediol; or
a mixture comprising 1,2-hexanediol and 2,3-hexanediol; or
a mixture comprising 1,2-heptanediol and 2,3-heptanediol; or
a mixture comprising 1,2-octanediol and 2,3-octanediol; or
a mixture comprising 1,2-nonanediol and 2,3-nonanediol; or
a mixture comprising 1,2-decanediol and 2,3-decanediol; or
a mixture comprising 1,2-undecanediol and 2,3-undecanediol; or
a mixture comprising 1,2-dodecanediol and 2,3-dodecanediol; or
a mixture comprising 1,2-tridecanediol and 2,3-tridecanediol; or
a mixture comprising 1,2-tetradecanediol and 2,3-tetradecanediol.

In said homo alkanediol mixtures the first linear alkanediol and the second linear alkanediol have the same number of carbon atoms.

Particularly favorable is a mixture including 1,2-pentanediol in combination with 2,3-pentanediol or a mixture including 1,2-heptanediol in combination with 2,3-heptanediol, or a mixture including 1,2-octanediol in combination with 2,3-octanediol and/or 3,4-octanediol.

Due to their outstanding dye transfer inhibitor boosting effect a homo alkanediol mixture comprising 1,2-nonanediol and 2,3-nonanediol or a homo alkanediol mixture comprising 1,2-decanediol and 2,3-decanediol or a homo alkanediol mixture comprising 1,2-undecanediol and 2,3-undecanediol are most preferred.

The above specified homo alkanediol mixtures according to the second aspect of the present invention, comprising a 1,2-alkanediol and a 2,3-alkanediol are characterized by a synergistically intensified action, i.e. the alkanediol mixtures enhance dye transfer inhibition of a dye transfer inhibitor in a detergent in a synergistic way compared to their respective single 1,2-alkanediol or 2,3-alkanediol substances.

Said synergistic effect or action in enhancing the dye transfer inhibitory effect is found for the homo mixture including 1,2-pentanediol and 2,3-pentanediol.

Said synergistic effect in enhancing the dye transfer inhibitory effect is also observed for the homo mixture including 1,2-hexanediol and 2,3-hexanediol.

The homo mixture including 1,2-heptanediol and 2,3-heptanediol is particularly beneficial since it has a particular pronounced synergistic effect on the day transfer inhibition in a detergent.

The alkanediol mixture comprising 1,2-octanediol and 2,3-octanediol or the alkanediol mixture comprising 1,2-nonanediol and 2,3-nonanediol are particularly advantageous, since the mixtures are effective in synergistically enhancing the dye transfer inhibition effect of a day transfer inhibitor in a detergent.

Also, the alkanediol mixture comprising 1,2-decanediol and 2,3-decanediol or the alkanediol mixture comprising 1,2-undecanediol and 2,3-undecanediol synergistically enhances the dye transfer inhibition effect of a day transfer inhibitor in a detergent.

A dye transfer inhibitor boosting effect is also true for an alkanediol mixture including 1,2-dodecanediol and 2,3-dodecanediol or an alkanediol mixture including 1,2-tridecanediol and 2,3-tridecanediol.

The afore-mentioned synergistically effect against a dye transfer inhibitor in a detergent is particularly pronounced for the homo mixture including 1,2-heptanediol and 2,3-heptanediol or the homo mixture including 1,2-octanediol and 2,3-octanediol or the homo mixture including 1,2-nonanediol and 2,3-nonanediol.

The afore specified homo alkanediol mixtures including a 1,2-alkanediol and the corresponding 2,3-alkanediol display a remarkably synergistic activity and are clearly superior to the individually corresponding 1,2-alkanediols or 2,3-alkanediols and having the same concentration.

In a particular preferred variant, the detergent according to the second aspect of the present invention which comprises a mixture or a combination comprising at least one first linear alkanediol and one or more second linear alkanediol thus may include any of the following mixtures/combinations:
a mixture comprising 1,2-heptanediol and 1,2-pentanediol; or
a mixture comprising 1,2-heptanediol and 1,2-hexanediol; or
a mixture comprising 1,2-heptanediol and 1,2-octanediol; or
a mixture comprising 1,2-heptanediol and 1,2-nonanediol; or
a mixture comprising 1,2-heptanediol and 1,2-decanediol; or
a mixture comprising 1,2-heptanediol and 1,2-undecanediol; or
a mixture comprising 1,2-heptanediol and 1,2-dodecanediol; or
a mixture comprising 1,2-heptanediol and 1,2-tridecanediol.

Surprisingly, the above specified alkanediol mixtures according to the second aspect of the present invention, comprising a first linear alkanediol and a second linear alkanediol, are characterized by synergistically intensified action, i.e. the alkanediol mixtures boost the dye transfer inhibitor activity in a detergent in a synergistic way compared to the corresponding individual 1,2-alkanediol or 2,3-alkanediol substances.

In a particular preferred variant, the detergent according to the second aspect of the present invention which comprises a mixture or a combination comprising at least one first linear alkanediol and one or more second linear alkanediol thus may include the following mixture/combination:
a mixture comprising 1,2-hexanediol and 1,2-octanediol.

Surprisingly, the said alkanediol mixture has a particularly pronounced dye transfer inhibitor enhancing effect.

Still more preferred is a dye transfer inhibitor boosting agent mixture, wherein the at least first linear alkanediol is selected from a 1,2-alkanediol having a lower number of carbon atoms from 5 to 8 and the one or more second alkanediol is selected from a 1,2-alkanediol having a higher number of carbon atoms from 9 to 14.

Most preferred is a dye transfer inhibitor boosting agent mixture, wherein the at least first linear alkanediol is selected from the group consisting of 1,2-pentanediol, 1,2-hexanediol, 1,2-heptanediol, 1,2-octanediol, and any mixture thereof, and the one or more second alkanediol is selected from the group consisting of 1,2-nonanediol, 1,2-decanediol, 1,2-undecanediol, 1,2-dodecanediol, 1,2-tridecanediol, 1,2-tetradecanediol, and any mixture thereof.

Most preferred is a dye transfer inhibitor boosting agent blend, wherein the at least one first linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, and the one or more second alkanediol is selected from the group consisting of 1,2-alkanediols having a higher number of carbon atoms of 9 to 13, i.e. 1,2-nonanediol, 1,2-decanediol, 1,2-undecanediol, 1,2-dodecanediol, 1,2-tridecanediol, and any mixture thereof.

Surprisingly, such alkanediol mixtures of short chain alkanediols and long chain alkanediols have a particularly pronounced dye transfer inhibitor boosting effect.

More preferred are such alkanediol mixtures, wherein the difference between the number of carbon atoms of the at least first linear alkanediol and the number of carbon atoms of the one or more second alkanediol is at least 2 carbon atoms. In those alkanediol mixtures, short-chained and long-chained alkanediols are combined with each other resulting in improved enzyme stabilization.

Still more preferred is a dye transfer inhibitor boosting agent mixture, wherein the difference between the number of carbon atoms of the at least first linear alkanediol and the number of carbon atoms of the one or more second alkanediol is at least 3 carbon atoms. With such alkanediol mixtures, the enzyme stabilization effect is particularly pronounced.

Such combinations may include any of the following mixtures/combinations:
1,2-pentanediol in combination with one of 1,2-octanediol, 1,2-nonanediol, 1,2-decanediol, 1,2-undecanediol, 1,2-dodecanediol, 1,2-tridecanediol, or 1,2-tetradecanediol;
1,2-hexanediol in combination with one of 1,2-nonanediol, 1,2-decanediol, 1,2-undecanediol, 1,2-dodecanediol, 1,2-tridecanediol, or 1,2-tetradecanediol;
1,2-heptanediol in combination with one of 1,2-decanediol, 1,2-undecanediol, 1,2-dodecanediol, 1,2-tridecanediol, or 1,2-tetradecanediol; and
1,2-octanediol in combination with one of 1,2-undecanediol, 1,2-dodecanediol, 1,2-tridecanediol, or 1,2-tetradecanediol.

In a preferred variant according to the second aspect of the present invention in the detergent the linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol and mixtures thereof.

In a more preferred variant of the detergent according to the second aspect of the present invention, the linear alkanediol is selected from the group consisting of 2,3-pentanediol, 2,3-hexanediol, 2,3-heptanediol, 2,3-octanediol, 2,3-nonanediol, and mixtures thereof.

Surprisingly, the addition of 2,3-pentanediol, 2,3-hexanediol, 2,3-heptanediol as well as other 2,3-alkanediols such as 2,3-octanediol, 2,3-nonanediol, 2,3-decanediol, 2,3-undecanediol, 2,3-dodecanediol, 2,3-tridecanediol, and 2,3-tetradecanediol to a detergent comprising a dye transfer inhibitor result in an improved dye transfer inhibiting effect, compared to a composition without the addition of an 2,3-alkanediol.

According to a particularly preferred variant, the detergent according to the present invention comprises at least one dye transfer inhibitor boosting agent selected from the group consisting of at least one linear 1,2-alkanediol having a carbon chain of 5 to 8 atoms, or a mixture comprising at least one first linear 1,2-alkanediol having a carbon chain of 5 to 8 carbon atoms and one or more second linear 1,2-alkanediol having a carbon chain of 5 to 8 carbon atoms, which is different from the first linear alkanediol.

In a still more preferred variant, the detergent according to the present invention comprises at least one dye transfer inhibitor boosting agent selected from the group consisting of at least one linear 1,2-alkanediol having a carbon chain of 6 to 7 atoms, or a mixture comprising at least one first linear 1,2-alkanediol having a carbon chain of 6 to 7 carbon atoms and one or more second linear 1,2-alkanediol having a carbon chain of 6 to 7 carbon atoms, which is different from the first linear alkanediol.

Surprisingly, it was found that these short-chained 1,2-alkanediols are particularly suitable dye transfer inhibitor boosting agents and which can also efficiently be incorporated into a broad range of detergents. It was found that these alkanediols show outstanding dye transfer inhibitor boosting properties during laundry. Such detergents show improved cleaning properties compared to a detergents without the addition of such substances.

According to a particularly preferred variant, the detergent according to the present invention comprises at least one dye transfer inhibitor boosting agent selected from the group consisting of at least one linear 1,2-alkanediol having a carbon chain of 9 to 14 atoms, or a mixture comprising at least one first linear 1,2-alkanediol having a carbon chain of 9 to 14 carbon atoms and one or more second linear 1,2-alkanediol having a carbon chain of 9 to 14 carbon atoms, which is different from the first linear alkanediol.

In a more preferred variant, the detergent according to the present invention comprises at least one dye transfer inhibitor boosting agent selected from the group consisting of at least one linear 1,2-alkanediol having a carbon chain of 10 to 13 atoms, or a mixture comprising at least one first linear 1,2-alkanediol having a carbon chain of 10 to 13 carbon atoms and one or more second linear 1,2-alkanediol having a carbon chain of 10 to 13 carbon atoms, which is different from the first linear alkanediol.

In a still more preferred variant, the detergent according to the present invention comprises at least one dye transfer inhibitor boosting agent selected from the group consisting of at least one linear 1,2-alkanediol having a carbon chain of 11 to 12 atoms, or a mixture comprising at least one first linear 1,2-alkanediol having a carbon chain of 11 to 12 carbon atoms and one or more second linear 1,2-alkanediol having a carbon chain of 11 to 12 carbon atoms, which is different from the first linear alkanediol.

Surprisingly, it was found that these long-chained alkanediols are particularly suitable dye transfer inhibitor boosting agents and which can also efficiently be incorporated into a broad range of detergents. It was found that these alkanediols show distinguished dye transfer inhibitor boosting properties during laundry. Such detergents show improved cleaning properties compared to detergents without the addition of such substances.

In a most preferred variant, the detergent composition according to the present invention comprises at least dye transfer inhibitor booster selected from the group consisting of at least one linear 1,2-alkanediol having a log Pow value of ≤1, or a mixture comprising at least one first linear 1,2-alkanediol having a log Pow value of ≤1 and one or more second linear 1,2-alkanediol having a log Pow value of ≤1, which is different from the first linear 1,2-alkanediol.

The 1,2-alkanediols having a log Pow value of ≤1 are selected from the group consisting of 1,2-pentanediol (log Pow=0.06), 1,2-hexanediol (log Pow=0.58), 1,2-heptanediol (log Pow=0.9), and any mixture thereof. Said 1,2-alkanediols are more soluble in water.

The Pow value is the partition coefficient of a chemical compound for the two-phase system consisting of the two immiscible solvents n-octanol and water at equilibrium. This value is therefore a comparison of the solubility of the solute in these two liquids. Hence the partition coefficient measures how hydrophilic or hydrophobic a chemical substance is.

The log Pow value is a constant defined in the following manner:

Log Pow=log 10 (Partition Coefficient)

Partition Coefficient, P=[n-octanol]/[water]

where [ ] indicates the concentration of solute in the organic and/or aqueous partition. The log Pow value is determined at a standard temperature of 25° C.

The log Pow value ≤1 means the compound has a higher affinity for the aqueous phase (it is more hydrophilic) and, thus, more soluble in water; a log Pow value ≥1 denotes a higher concentration in the lipid phase (i.e., the compound is more lipophilic) and, thus, more soluble in fat-like solvents.

Surprisingly, it was found that 1,2-alkanediols having a log Pow value of ≤1 are particularly suitable dye transfer inhibitor boosters, which can also efficiently be incorporated into a broad range of detergents. Detergents comprising 1,2-alkanediols having a log Pow value of ≤1 show improved dye transfer inhibition properties compared to detergents without the addition of such 1,2-alkanediols.

In a still further preferred variant, the detergent composition according to the present invention comprises at least one dye transfer inhibitor booster selected from the group consisting of at least one linear 1,2-alkanediol having a log Pow value of 1, or a mixture comprising at least one first linear 1,2-alkanediol having a log Pow value of 1 and one or more second linear 1,2-alkanediol having a log Pow value of >1, which is different from the first linear 1,2-alkanediol.

The 1,2-alkanediols having a log Pow value of ≥1 are selected from the group consisting of 1,2-octanediol (log Pow=2.1), 1,2-nonanediol, 1,2-decanediol, 1,2-undecanediol, 1,2-dodecanediol, 1,2-tridecanediol, 1,2-tetradecanediol, and any mixture thereof. Said 1,2-alkanediols are more soluble in fat-like solvents, for example n-octanol.

Surprisingly, it was found that 1,2-alkanediols having a log Pow value of ≥1 are particularly suitable dye transfer inhibitor boosters, which can also efficiently be incorporated into a broad range of detergents. Detergents comprising 1,2-alkanediols having a log Pow value of ≥1 show improved dye transfer inhibition properties compared to detergents without the addition of such 1,2-alkanediols.

The term “alkanediol” within the context of the present invention also includes its stereoisomers. Stereoisomers are molecules that have the same molecular formula and differ only in how their atoms are arranged in three-dimensional space. In accordance with said definition, the linear alkanediol of the invention or the first linear alkanediol having a carbon chain of 5 to 14 carbon atoms or the second linear alkanediol having a carbon chain of 5 to 14 carbon atoms as described above in detail encompass the following stereoisomers:

1,2-alkanediol stereoisomers:

| | |
|---|---|
| (2S)-pentane-1,2-diol, | (2R)-pentane-1,2-diol, |
| (2S)-hexane-1,2-diol, | (2R)-hexane-1,2-diol, |
| (2S)-heptane-1,2-diol, | (2R)-heptane-1,2-diol, |
| (2S)-octane-1,2-diol, | (2R)-octane-1,2-diol, |
| (2S)-nonane-1,2-diol, | (2R)-nonane-1,2-diol, |
| (2S)-decane-1,2-diol, | (2R)-decane-1,2-diol, |
| (2S)-undecane-1,2-diol, | (2R)-undecane-1,2-diol, |
| (2S)-dodecane-1,2-diol, | (2R)-dodecane-1,2-diol, |
| (2S)-tridecane-1,2-diol, | (2R)-tridecane-1,2-diol, |
| (2S)-tetradecane-1,2-diol, | (2R)-tetradecane-1,2-diol, |

2,3-alkanediol stereoisomers:

| | |
|---|---|
| (2S,3S)-pentane-2,3-diol, | (2R,3R)-pentane-2,3-diol, |
| (2S,3S)-hexane-2,3-diol, | (2R,3R)-hexane-2,3-diol, |
| (2S,3S)-heptane-2,3-diol, | (2R,3R)-heptane-2,3-diol, |
| (2S,3S)-octane-2,3-diol, | (2R,3R)-octane-2,3-diol, |
| (2S,3S)-nonane-2,3-diol, | (2R,3R)-nonane-2,3-diol, |
| (2S,3S)-decane-2,3-diol, | (2R,3R)-decane-2,3-diol, |
| (2S,3S)-undecane-2,3-diol, | (2R,3R)-undecane-2,3-diol, |
| (2S,3S)-dodecane-2,3-diol, | (2R,3R)-dodecane-2,3-diol, |
| (2S,3S)-tridecane-2,3-diol, | (2R,3R)-tridecane-2,3-diol, |
| (2S,3S)-tetradecane-2,3-diol, | (2R,3R)-tetradecane-2,3-diol, |
| (2S,3R)-pentane-2,3-diol, | (2R,3S)-pentane-2,3-diol, |
| (2S,3R)-hexane-2,3-diol, | (2R,3S)-hexane-2,3-diol, |
| (2S,3R)-heptane-2,3-diol, | (2R,3S)-heptane-2,3-diol, |
| (2S,3R)-octane-2,3-diol, | (2R,3S)-octane-2,3-diol, |
| (2S,3R)-nonane-2,3-diol, | (2R,3S)-nonane-2,3-diol, |
| (2S,3R)-decane-2,3-diol, | (2R,3S)-decane-2,3-diol, |
| (2S,3R)-undecane-2,3-diol, | (2R,3S)-undecane-2,3-diol, |
| (2S,3R)-dodecane-2,3-diol, | (2R,3S)-dodecane-2,3-diol, |
| (2S,3R)-tridecane-2,3-diol, | (2R,3S)-tridecane-2,3-diol, |
| (2S,3R)-tetradecane-2,3-diol, | (2R,3S)-tetradecane-2,3-diol. |

3,4-alkanediol stereoisomers:

| | |
|---|---|
| (3R,4R)-pentane-3,4-diol, | (3S,4S)-pentane-3,4-diol, |
| (3R,4R)-hexane-3,4-diol, | (3S,4S)-hexane-3,4-diol, |
| (3R,4R)-heptane-3,4-diol, | (3S,4S)-heptane-3,4-diol, |
| (3R,4R)-octane-3,4-diol, | (3S,4S)-octane-3,4-diol, |
| (3R,4R)-nonane-3,4-diol, | (3S,4S)-nonane-3,4-diol, |
| (3R,4R)-decane-3,4-diol, | (3S,4S)-decane-3,4-diol, |
| (3R,4R)-undecane-3,4-diol, | (3S,4S)-undecane-3,4-diol, |
| (3R,4R)-dodecane-3,4-diol, | (3S,4S)-dodecane-3,4-diol, |
| (3R,4R)-tridecane-3,4-diol, | (3S,4S)-tridecane-3,4-diol, |
| (3R,4R)-tetradecane-3,4-diol, | (3S,4S)-tetradecane-3,4-diol, |
| (3R,4S)-pentane-3,4-diol, | (3S,4R)-pentane-3,4-diol, |
| (3R,4S)-hexane-3,4-diol, | (3S,4R)-hexane-3,4-diol, |
| (3R,4S)-heptane-3,4-diol, | (3S,4R)-heptane-3,4-diol, |
| (3R,4S)-octane-3,4-diol, | (3S,4R)-octane-3,4-diol, |
| (3R,4S)-nonane-3,4-diol, | (3S,4R)-nonane-3,4-diol, |
| (3R,4S)-decane-3,4-diol, | (3S,4R)-decane-3,4-diol, |
| (3R,4S)-undecane-3,4-diol, | (3S,4R)-undecane-3,4-diol, |
| (3R,4S)-dodecane-3,4-diol, | (3S,4R)-dodecane-3,4-diol, |
| (3R,4S)-tridecane-3,4-diol, | (3S,4R)-tridecane-3,4-diol, |
| (3R,4S)-tetradecane-3,4-diol, | (3S,4R)-tetradecane-3,4-diol. |

In the context of the present text, the terms “1,2-diol”, “2,3-diol” or “3,4-diol” includes both the corresponding S-configured enantiomers and also the R-enantiomeras well as arbitrary mixtures of these S- and R-configured enantiomers, i.e. mixtures of racemates of the respective diols.

The alkanediol mixture of the detergent according to the first aspect of the present invention comprises the 1,2-heptanediol and the 2,3-heptanediol in a ratio in a range of 50:50 to 99.9:0.1, preferably in a ratio in a range of 75:25 to 99:1, more preferred in a ratio in a range of 80:20 to 98:2 or still more preferred in a ratio in a range of 90:10 to 95:5.

In the detergent according to the first aspect of the present invention, 1,2-heptanediol and 2,3-heptanediol are comprised in the mixture preferably in a ratio in a range of 98:2 to 99.9:0.1.

In the detergents according to the first aspect of the present invention, 1,2-heptanediol and 2,3-heptanediol are comprised in the alkanediol mixture preferably in a ratio in a range of 95:5 to 99.9:0.1.

Preferably, 1,2-heptanediol and 2,3-heptanediol are comprised in the mixture of the detergent according to the first aspect of the present invention in a ratio of ≥95:5, more preferred in a ratio of ≥96:≤4; still more preferred in a ratio of ≥97:≤3, and most preferred in a ratio of ≥98:≤2.

Most of all the mixtures of the detergent according to the first aspect of the present invention comprises 1,2-heptanediol and 2,3-heptanediol in a ratio of ≥95:≤5, including the ratios 95.5:≤4.5; ≥96:≤4; ≥96.5:≤3.5; ≥97:≤3; ≥97.5:2.5 and 98.0:≤2.0.

Even more preferred the alkanediol mixture of the detergent according to the first aspect of the present invention comprises 1,2-heptanediol and 2,3-heptanediol in a ratio of ≥98:≤2, including the ratios of ≥98.1:≤1.9; ≥98.2:≤1.8; ≥98.3:≤1.7; ≥98.4:≤1.6; ≥98.5:≤1.5; ≥98.6:≤1.4; ≥98.7:≤1.3; ≥98.8:≤1.2; 98.9:≤1.1; ≥99:≤1.0; ≥99.1:≤0.9; ≥99.2:≤0.8; ≥99.3:≤0.7; ≥99.4:≤0.6; ≥99.5:≤0.5; ≥99.6:≤0.4; ≥99.7:≤0.3; ≥99.8:≤0.2 and ≥99.9:≤0.1.

The first linear alkanediol and the second linear alkanediol as defined in detail above, are present in the alkanediol mixture according to the second aspect of the present invention in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

In the detergent according to the second aspect of the present invention, the first linear alkanediol and the second linear alkanediol are comprised in the mixture preferably in a ratio in a range of 98:2 to 99.9:0.1

In the detergent according to second aspect of the present invention, the first linear alkanediol and the second alkanediol are comprised in the alkanediol mixture preferably in a ratio in a range of 95:5 to 99.9:0.1.

Preferably, the first linear alkanediol and the second alkanediol are comprised in the mixture of the detergent according to the second aspect of the present invention in a ratio of ≥95:≤5, more preferred in a ratio of ≥96:≤4; still more preferred in a ratio of ≥97:≤3, and most preferred in a ratio of ≥98:≤2.

Most of all the mixtures of the detergent according to the second aspect of the present invention comprises the first linear alkanediol and the second linear alkanediol in a ratio of ≥95:≤5, including the ratios 95.5:≤4.5; ≥96:≤4; ≥96.5:≤3.5; ≥97:≤3; ≥97.5:2.5 and ≥98.0:≤2.0.

Even more preferred the alkanediol mixture of the detergent according to the second aspect of the present invention comprises the first linear alkanediol and the second alkanediol in a ratio of ≥98:≤2, including the ratios of ≥98.1:≤1.9; ≥98.2:≤1.8; ≥98.3≤1.7; ≥98.4:≤1.6; ≥98.5:≤1.5; ≥98.6:≤1.4; ≥98.7:≤1.3; ≥98.8:≤1.2; ≥98.9:≤1.1; ≥99:≤1.0; 99.1:≤0.9; 99.2:≤0.8; ≥99.3:≤0.7; ≥99.4:≤0.6; ≥99.5:≤0.5; ≥99.6:≤0.4; ≥99.7:≤0.3; ≥99.8:≤0.2 and ≥99.9:≤0.1.

Alternatively, said ratio ranges for the first and second alkanediol are switched, such that the second alkanediol is the main component and the first alkanediol is the secondary component.

In an advantageous variant according to the second aspect of the present invention, the alkanediol mixture comprises as first linear alkanediol an 1,2-alkanediol, such as 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol, and as second linear alkanediol the corresponding 2,3-alkanediols, such as 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

Likewise, for said alkanediol mixtures the ratios of first linear alkanediol second alkanediol or ranges of ratios as described above are also applicable.

In a still further variant, according to the second aspect of the present invention, the alkanediol mixture comprises as first linear alkanediol an 2,3-alkanediol, such as 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, and as second linear alkanediol the corresponding 1,2-alkanediols, such as 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

Likewise, for said alkanediol mixtures the ratios of first linear alkanediol second alkanediol or ranges of ratios as described above are also applicable.

In a more advantageous variant according to the second aspect of the present invention, in the alkanediol mixtures comprising a combination of a 1,2-alkanediol as first linear alkanediol and the corresponding 2,3-alkanediol as second linear alkanediol, such as
1,2-pentanediol and 2,3-pentanediol, or
1,2-hexanediol and 2,3-hexanediol, or
1,2-heptanediol and 2,3-heptanediol, or
1,2-octanediol and 2,3-octanediol, or
1,2-nonanediol and 2,3-nonanediol, or
1,2-decanediol and 2,3-decanediol, or
1,2-undecanediol and 2,3-undecenaediol, or
1,2-dodecanediol and 2,3-dodecanediol, or
1,2-tridecanediol and 2,3-tridecanediol, or
1,2-tetradecanediol and 2,3-tetradecanediol,
the first linear alkanediol and the second linear alkanediol are present in a ratio in a range of 50:50 to 99.9:0.1, preferably in a ratio in a range of 75:25 to 99:1, more preferred in a ratio in a range of 80:20 to 98:2 or still more preferred in ratio in a range of 90:10 to 95:5.

Likewise, for said alkanediol mixtures the ratios of first linear alkanediol second alkanediol or ranges of ratios as described above are also applicable.

By these mixing ratios the afore mentioned alkanediol mixtures show a synergistically intensified dye transfer inhibitor boosting effect in comparison with the corresponding individual substances.

A preferred variant according to the second aspect the present invention also encompasses a mixture including as first linear alkanediol 1,2-hexanediol and as second linear alkanediol 1,2-octanediol either in a ratio in a range of 50:50 to 99.9:0.1, preferably in a ratio in a range of 75:25 to 99:1, more preferred in a ratio in a range of 80:20 to 98:2 or still more preferred in a ratio in a range of 90:10 to 95:5.

Thus, according to another preferred variant, the present invention relates to a detergent as specified herein,
(i) wherein the mixture comprising 1,2-heptanediol and 2,3-heptanediol comprises the 1,2-heptanediol and the 2,3-heptanediol in a ratio in a range of 50:50 to 99.9:0.1, preferably in a ratio in a range of 75:25 to 99:1, more preferred in a ratio in a range of 80:20 to 98:2, still more preferred in a ratio of 90:10 to 95:5; or
(ii) wherein the mixture comprising at least one first linear alkanediol and one or more second linear alkanediol comprises the first linear alkanediol and the second alkanediol in a ratio in a range of 50:50 to 99.9:0.1, preferably in a ratio in a range of 75:25 to 99:1, more preferred in a ratio in a range of 80:20 to 98:2, still more preferred in a ratio of 90:10 to 95:5.

By these mixing ratios the afore mentioned mixtures show a synergistical dye transfer inhibitor boosting activity in a detergent in direct comparison with the corresponding individual alkanediol substances.

The alkanediols are obtained either by synthesis from petrochemical or other fossil fuel sources by known methods such as olefin bis-hydroxylation, hydrolysis from epoxide or various chemical transformations or from bioderived feedstock by fermentation or from bio-based natural and renewable feedstock such as biomass by catalytic synthesis as it is described in US 2019/0241491 A1 and US 2020/0189995 A1. The alkanediols used according to the present invention comprise either petrochemically derived and biobased natural and renewable feedstock derived alkanediols. Preferably, the alkanediols are from bio-based sources and are thus bio-alkanediols.

Beyond the above specified alkanediols, the dye transfer inhibitor boosting agent of the detergent according to the second aspect of the present invention is either (b^{II}) glyceryl caprylate, or (b^{III}) 4-hydroxyacetophenone, or (b^{IV}) ethyl hexyl glycerin, or (b^{V}) tropolone, or any mixture of the aforementioned agents.

Glyceryl caprylate (b^{II})

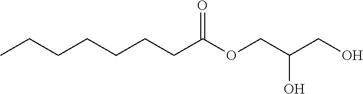

is a natural emollient derived from glycerine and plant fatty acids, usually appearing as a white waxy solid. This ingredient is used in many skincare products for its emollient and moisturising properties, to help maintain the balance of moisture in the skin. In additional, glyceryl caprylate (b^{II}) is used as antimicrobial in cosmetic preparations.

It was surprisingly found that the oily, surface-active co-emulsifier glyceryl caprylate is a further suitable dye transfer inhibitor boosting agent within the meaning of the present invention.

4-hydroxyacetophenone (4-HAP) (b^{III})

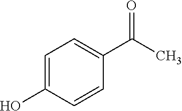

possesses oxidation-inhibiting, fungicidal and bacterial growth-inhibiting properties and is therefore used to stabilize cosmetic preparations.

It was surprisingly found that the 4-HAP is a further suitable dye transfer inhibitor boosting agent and dye transfer inhibitor within the meaning of the present invention.

Ethyl hexyl glycerin (EHG) (b^{IV})

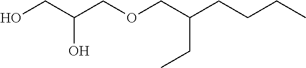

is a relatively new cosmetic ingredient that is used for its surfactant, dispersant, emollient, skin-conditioning and antimicrobial properties. Ethyl hexyl glycerin (EHG or octoxyglycerin) is a glyceryl ether and a vicinal diol.

It was surprisingly found that EHG is suitable to improve inhibition of a dye transfer inhibitor in a detergent within the meaning of the present invention.

Tropolone (b^{V})

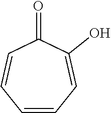

is known for its antibacterial, antifungal, anti-inflammatory, antioxidant, and chelating properties and is therefore used in cosmetic formulations.

It was surprisingly found that tropolone act as booster for a dye transfer inhibitor in a detergent within the meaning of the present invention.

The above specified dye transfer inhibitor boosting agents (b^{II}) (b^{III}), (b^{IV}) and (b^{V}) can be used in the detergent composition either individually or in the form of mixtures of two, or even more dye transfer inhibitor boosting agents.

Similarly, the above specified single dye transfer inhibitor boosting agents (b^{II}) (b^{III}), (b^{IV}) and (b^{V}) or mixtures or two or three dye transfer inhibitor boosting agents (b^{II}) (b^{III}), (b^{IV}) and (b^{V}) can also be used in the detergent composition in mixture with one or two alkanediol(s) dye transfer inhibitor boosting agents (b^{I}) as defined herein. Preferably, such mixtures contain two, or even more dye transfer inhibitor boosting agents as defined herein.

In a particular preferred variant, the at least one dye transfer inhibitor boosting agent (b) in the detergent according to the second aspect of the present invention includes any of the following mixtures/combinations:
a mixture comprising (b^{II}) glyceryl caprylate and (b^{III}) 4-hydroxyacetophenone; or
a mixture comprising (b^{II}) glyceryl caprylate and (b^{IV}) ethyl hexyl glycerin; or
a mixture comprising (b^{II}) glyceryl caprylate and (b^{V}) tropolone; or
a mixture comprising (b^{III}) 4-hydroxyacetophenone and (b^{IV}) ethyl hexyl glycerin; or
a mixture comprising (b^{III}) 4-hydroxyacetophenone and (b^{V}) tropolone; or
a mixture comprising (b^{IV}) ethyl hexyl glycerin and (b^{V}) tropolone; or
a mixture comprising (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above, and (b^{II}) glyceryl caprylate; or
a mixture comprising (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above, and (b^{III}) 4-hydroxyacetophenone; or
a mixture comprising (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above, and (b^{IV}) ethyl hexyl glycerin; or
a mixture comprising (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above, and (b^{V}) tropolone.

However, a particular pronounced dye transfer inhibitor boosting effect can be observed for the following dye transfer inhibitor boosting agents:
1,2-pentanediol;
1,2-hexanediol;
1,2-heptanediol;
1,2-octanediol;
1,2-nonanediol;
1,2-decanediol;
1,2-undecanediol;
1,2-dodecanediol;
1,2-tridecanediol;
1,2-tetradecanediol;
glyceryl caprylate;
4-hydroxyacetophenone;
ethyl hexyl glycerin;
tropolone;
a mixture comprising 1,2-hexanediol and 1,2-octanediol;
a mixture comprising 1,2-hexanediol and 1,2-octanediol and tropolone; and
a mixture comprising 4-hydroxyacetophenone and 1,2-octanediol.

For the detergent according to the present invention, the list of dye transfer inhibitor boosting agents (b1, b2, b3, b) specified herein can be arbitrary combined with the list of dye transfer inhibitors specified herein.

In a particular advantageously variant, the detergent according to the second aspect of the present invention comprises one of the following combinations of components (a) and (b):
polyamine-N-oxide polymers plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
copolymers of N-vinylpyrrolidone and N-vinylimidazole plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
polyvinylpyrrolidone polymers plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
poylvinyloxazolidones plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
polyvinylimidazoles plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
manganese phthalocyanine plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
copolymers based on vinylmonomers and carboxamides plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
pyrrolidone group containing polyesters or polyamides plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
grafted polyamidoamines or polyethyleneimines plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
polyvinyl alcohols plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
copolymers based on acrylamidoalkenylsulfonic acids plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
polyvinylpyridin-N-oxid plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
poly-N-carboxymethyl-4-vinylpyridiumchlorid plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone.

In a more preferred variant, the detergent composition according to the second aspect of the present invention comprises one of the following combinations of components (a) and (b):
copolymers of N-vinylpyrrolidone and N-vinylimidazole plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
polyvinylpyrrolidone polymers plus one or more of the following dye transfer inhibitor boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone.

In a most preferred variant, the detergent composition according to the second aspect of the present invention comprises one of the following combinations of components (a) and (b):
copolymers of N-vinylpyrrolidone and N-vinylimidazole plus 1,2-pentanediol;
copolymers of N-vinylpyrrolidone and N-vinylimidazole plus 1,2-hexanediol;
copolymers of N-vinylpyrrolidone and N-vinylimidazole plus 1,2-heptanediol;
copolymers of N-vinylpyrrolidone and N-vinylimidazole plus 1,2-octanediol;
copolymers of N-vinylpyrrolidone and N-vinylimidazole plus glyceryl caprylate;
copolymers of N-vinylpyrrolidone and N-vinylimidazole plus 4-hydroxyacetophenone;
copolymers of N-vinylpyrrolidone and N-vinylimidazole plus ethyl hexyl glycerin;
copolymers of N-vinylpyrrolidone and N-vinylimidazole plus tropolone;
copolymers of N-vinylpyrrolidone and N-vinylimidazole plus a mixture comprising 1,2-hexanediol and 1,2-octanediol;
copolymers of N-vinylpyrrolidone and N-vinylimidazole plus a mixture comprising 1,2-hexanediol and 1,2-octanediol and tropolone;
copolymers of N-vinylpyrrolidone and N-vinylimidazole plus a mixture comprising 4-hydroxyacetophenone and 1,2-octanediol;
polyvinylpyrrolidone polymers plus 1,2-pentanediol;
polyvinylpyrrolidone polymers plus 1,2-hexanediol;
polyvinylpyrrolidone polymers plus 1,2-heptanediol;
polyvinylpyrrolidone polymers plus 1,2-octanediol;
polyvinylpyrrolidone polymers plus glyceryl caprylate;
polyvinylpyrrolidone polymers plus 4-hydroxyacetophenone;
polyvinylpyrrolidone polymers plus ethyl hexyl glycerin;
polyvinylpyrrolidone polymers plus tropolone;
polyvinylpyrrolidone polymers plus a mixture comprising 1,2-hexanediol and 1,2-octanediol;
polyvinylpyrrolidone polymers plus a mixture comprising 1,2-hexanediol and 1,2-octanediol and tropolone; or
polyvinylpyrrolidone polymers plus a mixture comprising 4-hydroxyacetophenone and 1,2-octanediol.

In a most preferred variant, the detergent composition according to the second aspect of the present invention comprises one of the following combinations of components (a) and (b):
copolymers of N-vinylpyrrolidone and N-vinylimidazole plus 1,2-nonanediol;
copolymers of N-vinylpyrrolidone and N-vinylimidazole plus 1,2-decanediol;
copolymers of N-vinylpyrrolidone and N-vinylimidazole plus 1,2-undecanediol;
copolymers of N-vinylpyrrolidone and N-vinylimidazole plus 1,2-dodecanediol;
copolymers of N-vinylpyrrolidone and N-vinylimidazole plus 1,2-tridecanediol;
copolymers of N-vinylpyrrolidone and N-vinylimidazole plus 1,2-tetradecanediol;
polyvinylpyrrolidone polymers plus 1,2-nonanediol;
polyvinylpyrrolidone polymers plus 1,2-decanediol;
polyvinylpyrrolidone polymers plus 1,2-undecanediol;
polyvinylpyrrolidone polymers plus 1,2-dodecanediol;
polyvinylpyrrolidone polymers plus 1,2-tridecanediol; or
polyvinylpyrrolidone polymers plus 1,2-tetradecanediol.

It was found that the above specified combinations in a detergent composition according to the present invention result in a superior dye transfer inhibitor increasing effect upon laundry. The improved inhibitory effect upon laundry in turn results in a better performance compared to detergent compositions without a dye transfer inhibitor boosting agent.

### Surfactant/Component (c1, c2, c3, c)

The detergent composition according to the first and second aspect of the present invention includes at least one surfactant. (c1, c2, c3, c).

Surfactants are added for a number of reasons, the main purposes being their washing and surface-active properties. They remove stains and soils from the clothing or surfaces and keep it suspended in the washing solution. Some surfactants perform other functions such as foam inhibition.

The detergent according to the present invention may comprise any kind of surfactant, namely anionic surfactants, cationic surfactants, nonionic surfactants, amphoteric/zwitterionic surfactant, and any mixture thereof

Suitable surfactants which can be incorporated into the detergent composition according to the present invention are:

### Anionic Surfactants

Suitable anionic surfactants for the detergent composition according to the present invention may include any conventional anionic surfactants. Typical examples for anionic surfactants encompass:
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide;
   and any mixture thereof.

In a preferred variant of the detergent composition according to the first and second aspect of the present invention, the anionic surfactant is selected from the group consisting of
C10 to C13 alkyl benzene sulfonates;
C12 to C15 alkyl sulfates;
C12 to C14 alkyl sulfates, ethoxylated with 1 to 3 moles ethylene oxide;
C12 to C16 alpha-olefin sulfonates;
C8 to C18 alkyl carboxylates, ethoxylated with 3 to 10 moles ethylene oxide;
   and any mixture thereof.

In a more preferred variant of the detergent composition according to the first and second aspect of the present invention, the anionic surfactant is selected from the group consisting of
dodecyl benzene sulfonate;
dodecyl sulfate;
dodecyl sulfate, ethoxylated with 2 moles ethylene oxide;
C12 to C14 alpha-olefin sulfonates;
C18 alkyl carboxylates, ethoxylated with 9 to 10 moles ethylene oxide;
   and any mixture thereof.

For laundry detergents, the anionic surfactant is most preferred selected from the group consisting of dodecyl benzene sulfonate, dodecyl sulfate, dodecyl sulfate, ethoxylated with 2 moles ethylene oxide, and any mixture thereof.

### Cationic Surfactants

Suitable cationic surfactants for the detergent composition according to the present invention may include any conventional cationic surfactants. Typical examples for cationic surfactants encompass:
quaternary C8 to C18 alkyl ethanolamines;
quaternary C8 to C18 alkyl ammonium compounds;
C8 to C18 alkyl ammonium methosulfates;
   and any mixture thereof.

In a preferred variant of the detergent composition according to the first and second aspect of the present invention, the cationic surfactant is selected from the group consisting of
quaternary C12 to C18 alkyl ethanolamines;
quaternary C12 to C18 alkyl ammonium compounds;
C12 to C18 alkyl ammonium methosulfates;
   and any mixture thereof.

In a more preferred variant of the detergent composition according to the first and second aspect of the present invention, the cationic surfactant is selected from the group consisting of
quaternary C16 to C18 alkyl ethanolamines;
quaternary C16 to C18 alkyl ammonium compounds;
C14 to C18 alkyl ammonium methosulfates;
   and any mixture thereof.

For fabric softener, the cationic surfactant is most preferred selected form the group consisting of C14 to C18 alkyl ammonium methosulfates, and any mixture thereof.

### Non-Ionic Surfactants

Suitable non-ionic surfactants for the detergent composition according to the present invention may include any conventional non-ionic surfactants. Typical examples for non-ionic surfactants encompass:
C6 to C18 fatty alcohols, ethoxylated with 1 to 12 moles ethylene oxide;
alkoxylated C6 to C18 fatty alcohols such as
   C6 to C18 fatty alcohols, ethoxylated with 1 to 25 moles ethylene oxide,
   C6 to C18 fatty alcohols, propoxylated with 1 to 15 moles propylene oxide,
   C6 to C18 fatty alcohols, butoxylated with 1 to 10 moles butylene oxide,
   and combinations thereof;
C6 to C18 sophorolipids;
C6 to C18 rhamnolipids;
C5 to C18 alkyl polyglycosides;
C6 to C18 alkanolamides;
C6 to C18 fatty acid ester alkoxylates;
   and any mixture thereof.

In a preferred variant of the detergent composition according to the first and second aspect of the present invention, the non-ionic surfactant is selected from the group consisting of
C8 to C15 fatty alcohols, ethoxylated with 3 to 8 moles ethylene oxide;
alkoxylated C8 to C15 fatty alcohols such as
   C8 to C15 fatty alcohols, ethoxylated with 1 to 25 moles ethylene oxide,
   C8 to C15 fatty alcohols, propoxylated with 1 to 15 moles propylene oxide,
   C8 to C15 fatty alcohols, butoxylated with 1 to 10 moles butylene oxide,
   and combinations thereof;
C8 to C18 sophorolipids;
C8 to C18 rhamnolipids;
C7 to C15 alkyl polyglycosides;
C8 to C15 alkanolamides;
C8 to C15 fatty acid ester alkoxylates;
   and any mixture thereof.

In a more preferred variant of the detergent composition according to the first and second aspect of the present invention, the non-ionic surfactant is selected from the group consisting of
C10 to C18 sophorolipids;
C10 to C18 rhamnolipids;
C8 to C14 alkyl polyglycosides;
Cocamide DEA/MEA;
C10 to C14 fatty acid ester alkoxylates;
   and any mixture thereof.

In a still more preferred variant of the detergent composition according to the first and second aspect of the present invention, the non-ionic surfactant is selected from the group consisting of
C10 to C18 sophorolipids;
C10 to C18 rhamnolipids;
C8 to C14 alkyl polyglycosides;
   and any mixture thereof.

Said non-ionic detergents are particularly beneficial for preparing “green” detergents compositions.

For laundry detergents, the non-ionic surfactant is most preferred selected from the group consisting of C10 to C18 sophorolipids, C10 to C18 rhamnolipids, C8 to C14 alkyl polyglycosides, and any mixture thereof.

In a further preferred variant, for laundry detergents the non-ionic surfactant is selected from the group consisting of C12 to C14 fatty alcohols, ethoxylated with 7 moles ethylene oxide, C13 to C15 fatty alcohols, ethoxylated with 7 moles ethylene oxide, and any mixture thereof.

### Amphoteric/Zwitterionic Surfactants

Suitable amphoteric/zwitterionic surfactants for the detergent composition according to the present invention may include any conventional amphoteric/zwitterionic surfactants. Typical examples for amphoteric/zwitterionic surfactants encompass:
C10 to C18 N-(alkyl)-N,N-dimethylamine oxide;
C10 to C18 N-(alkyl)-N,N-bis(2-hydroxyethyl)amine oxide;
C10 to C18 alkyl amido propyl dimethyl amine oxide;
C10 to C18 alkylbetaines;
C10 to C18 alkylamidobetaines;
C10 to C18 sulfobetaines;
   and any mixture of the above surfactants.

In a preferred variant of the detergent composition according to the present invention, the amphoteric/zwitterionic surfactant is selected from the group consisting of
C10 to C15 N-(alkyl)-N,N-dimethylamine oxide;
C10 to C15 N-(alkyl)-N,N-bis(2-hydroxyethyl)amine oxide;
C10 to C15 alkyl amido propyl dimethyl amine oxide;
C10 to C15 alkylbetaines;
C10 to C15 alkylamidobetaines;
C10 to C15 sulfobetaines;
   and any mixture of the above surfactants.

In a more preferred variant of the detergent composition according to the first and second aspect of the present invention, the amphoteric/zwitterionic surfactant is selected from the group consisting of
C12 to C14 N-(alkyl)-N,N-dimethylamine oxides;
C12 to C14 N-(alkyl)-N,N-bis(2-hydroxyethyl)amine oxides;
C12 to C14 alkyl amido propyl dimethyl amine oxides;
C12 to C14 alkylbetaines;
C12 to C14 alkylamidobetaines;
C12 to C14 sulfobetaines;
   and any mixture of the above surfactants.

The above numeric ranges recited with respect of the number of C atoms of the surfactants, given in the form “Cx to Cy” include the values defining the range and include each integer within the defined range, the range C10 to C18 includes C10, C11, C12, C13, C14, C15, C16, C17 and C18. For example, the term “C10 to C18 alkyl” includes decyl, undecyl, dodecyl, tridecyl, tetradecyl, pentadecyl, hexadecyl, heptadecyl and octadecyl. Analogously, the term “C12 to C14 alkyl” includes dodecyl, tridecyl and tetradecyl. For example, the term “C6 to C18 fatty alcohols” includes fatty alcohols having a carbon chain with 6, 7, 8, 9, 10, 11, 12, 13, 14, 15, 16, 17, or 18 carbon atoms. Analogously, the term “C6 to C18 rhamnolipids” includes structures comprising a rhamnolipid and a carbon chain having 6, 7, 8, 9, 10, 11, 12, 13, 14, 15, 16, 17 or 18 carbon atoms.

The above specified surfactants can be used in the detergent according to the present invention either singular or in the form of mixtures of two, three, or even more surfactants, either from the same surfactant category (anionic, cationic, non-ionic, amphoteric/zwitterionic) or as mixture of surfactants of different surfactant categories.

### Enzyme or Enzyme Formulation/Component (d1, d2, d3, d)

The detergent composition according to the first aspect or the second aspect of the present invention optionally comprises at least one enzyme as component (d1, d2, d3, d) that provide additional cleaning performance, by removing stain and/or soil, and/or fabric care benefits.

Enzymes are known as effective chemicals for use with detergents and other cleaning agents to break down soils. Enzymes break down soils, make them more soluble, and enable surfactants to remove them from a surface to provide enhanced cleaning of a substrate. Specifically, enzymes can provide desirable activity for removal of, for example, protein-based, carbohydrate-based, or triglyceride-based stains from substrates. In addition, enzymes also help to improve wash results at lower temperatures. As a result, enzymes have been used for various cleaning applications in order to digest or degrade soils such as grease, oils (e.g. vegetable oils or animal fat), protein, carbohydrate, or the like. For example, enzymes may be added as a component of a composition for laundry, textiles, ware washing, cleaning-in-place, cleaning drains, floors, carpets, medical or dental instruments, meat cutting tools, hard surfaces, personal care, or the like.

Enzymes suitable for the detergents can act by degrading or altering one or more types of soil residues encountered on a fabric or textile thus removing the soil or making the soil more removable by a surfactant or other component of the detergent composition. Both degradation and alteration of soil residues can improve detergency by reducing the physicochemical forces that bind the soil to the textile or fabric being cleaned, e.g., the soil becomes more water soluble. For example, one or more proteases can cleave complex, macro molecular protein structures present in soil residues into simpler short chain molecules which are, of themselves, more readily desorbed from surfaces, solubilized or otherwise more easily removed by detersive solutions containing said proteases.

Detersive enzymes according to the present invention have a cleaning, destaining, desoiling, or otherwise beneficial effect as a component of a detergent for laundry, textiles, carpets, or the like.

Enzymes that can be used in the detergent composition according to the present invention include enzymes that provide desirable activity for removal of protein-based, carbohydrate-based, or lipid-based (fat or oil-based) stains and/or soils for laundry and textile cleaning and destaining; for carpet cleaning and destaining; and the like.

Suitable enzymes used according to the first aspect and second aspect of the present invention are selected from the group consisting of proteases, amylases, lipases, cellulases, cutinases, gluconases, peroxidases, pectinases, mannanases, esterases, hemicellulases, xylanases, phospholipases, pectate lyases, keratinases, reductases, nucleases (including Dnase and/or Rnase), phenoloxidases, lipoxygenases, ligninases, pullulanases, tannases, pentosanases, malanases, β-glucanases, arabinosidases, hyaluronidases, chondroitinases, oxidoreductases, and any mixture thereof.

More preferred, the enzyme is selected from the group consisting of proteases, amylases, lipases, cellulases, mannanases, pectate lyases, and any mixture thereof.

The enzymes used according to the present invention are of any suitable origin, such as vegetable, animal, bacterial, fungal or yeast origin.

Proteases: Any protease or mixture of proteases, from any source, can be used in the detergents, provided that the selected enzyme is stable in the desired pH range (between about 6 and about 9). For example, the protease enzymes can be derived from a plant, an animal, or a microorganism such as a yeast, a mold, or a bacterium. Preferred protease enzymes include, but are not limited to, the enzymes derived from Bacillus subtilis, Bacillus licheniformis and Streptomyces griseus. Protease enzymes derived from B. subtilis are most preferred. The protease can be purified or a component of a microbial extract, and either wild type or variant (either chemical or recombinant). Exemplary proteases are commercially available under the following trade names Alcalase®, Blaze®, Savinase®, Esperase®, Progress UNO™, Liquanase® and Pristine®, each available from Novozymes; and Preferenz® P and Excellenz® P, each available from DUPONT/IFF.

Amylases: Any amylase or mixture of amylases, from any source, can be used in the detergents, provided that the selected enzyme is stable in the desired pH range (between about 6 and about 9). For example, the amylase enzymes can be derived from a plant, an animal, or a microorganism such as a yeast, a mould, or a bacterium. Preferred amylase enzymes include, but are not limited to, those derived from a Bacillus, such as B. licheniformis, B. amyloliquefaciens, B. subtilis, or B. stearothermophilus. Amylase enzymes derived from B. subtilis are most preferred. The amylase can be purified or a component of a microbial extract, and either wild type or variant (either chemical or recombinant). Preferred amylases are commercially available under the trade names Stainzyme® and Amplify®, each available from Novozymes; and Preferenz® S, available from DUPONT/IFF.

Lipases: Any lipase or mixture of lipases, from any source, can be used in the detergents, provided that the selected enzyme is stable in the desired pH range (between about 6 and about 9). For example, the lipase enzymes can be derived from a plant, an animal, or a microorganism such as a fungus or a bacterium. Preferred protease enzymes include, but are not limited to, the enzymes derived from a Pseudomonas, such as Pseudomonas stutzeri ATCC 19.154, or from a Humicola, such as Humicola lanuginosa (typically produced recombinantly in Aspergillus oryzae). The lipase can be purified or a component of a microbial extract, and either wild type or variant (either chemical or recombinant). Preferred lipases are commercially available under the trade names Lipex®, available from Novozymes, and Preferenz® L, available from DUPONT/IFF.

Cellulases: Any cellulase or mixture of cellulases, from any source, can be used in the detergents, provided that the selected enzyme is stable in the desired pH range (between about 6 and about 9). For example, the cellulase enzymes can be derived from a plant, an animal, or a microorganism such as a fungus or a bacterium. Preferred cellulase enzymes include, but are not limited to, those derived from Humicola insolens, Humicola strain DSM1800, or a cellulase 212-producing fungus belonging to the genus Aeromonas and those extracted from the hepatopancreas of a marine mollusc, Dolabella Auricula Solander. The cellulase can be purified or a component of a microbial extract, and either wild type or variant (either chemical or recombinant. Preferred cellulases are commercially available under the trade names Celluclean® and Carezyme®, each available from Novozymes; and Revitalenz®, available from DUPONT/IFF.

Preferred enzyme selections depend upon the conditions of final utility, including the physical product form, use pH, use temperature, and soil types to be degraded or altered and are influenced by factors such as pH-activity and/or stability optima, thermostability, and stability to active detergents, builders and the like. The enzyme can be chosen to provide optimum activity and stability for any given set of utility conditions. In this respect, bacterial or fungal enzymes are preferred.

Protease enzymes, amylase enzymes and lipase enzymes are the most used enzymes in detergents. The protease enzymes are particularly advantageous for cleaning soils containing protein, e.g. egg, milk, meat residue, or the like. The amylase enzymes are particularly advantageous for removing starch-based soils, such as pasta and rice. The lipase enzymes are particularly advantageous for cleaning soils including fat/grease.

As one skilled in the art shall ascertain, enzymes are designed to work with specific types of soils. For example, laundry applications may use a protease enzyme as it is effective at the high temperatures of the wash machines and is effective in reducing protein-based soils. Protease enzymes are particularly advantageous for cleaning soils containing protein, such as blood, cutaneous scales, mucus, grass, food (e.g. egg, milk, spinach, meat residue, tomato sauce), or the like.

According to the invention, the enzyme composition may be varied based on the particular cleaning application and the types of soils in need of cleaning. For example, the temperature of a particular cleaning application will impact the enzymes selected for an enzyme composition according to the invention. Laundry applications, for example, clean laundry at temperatures in excess of approximately 40° C., or in excess of approximately 50° C., or between approximately 65° C. to 90° C., and enzymes such as proteases are desirable due to their ability to retain enzymatic performance at such elevated temperatures.

Preferably, the at least one enzyme is selected from the group consisting of a protease, an amylase, a lipase, a cellulase, a gluconase, a peroxidase, or a mixture thereof.

In some variants, the enzyme in the detergent composition is a protease, an amylase, a lipase, a cellulase, a gluconase, a peroxidase, a mannanase, or any mixture thereof.

Preferably the enzyme in the detergent composition is a mixture of protease, an amylase, a lipase, a cellulase and/or pectate lyase.

Preferred enzymes in detergents according to the present invention include a protease, an amylase, a lipase, a cellulase, or a combination thereof.

Preferred detersive enzymes in the deterrent composition include a hydrolase such as a protease, an amylase, a lipase, or a combination thereof.

Preferably, the enzyme in the detergent composition is a protease, amylase, lipase, cellulose, peroxidase, gluconase, or any mixture thereof.

In a still more preferred variant, the enzyme in the detergents disclosed here is a protease, amylase, lipase, or any mixture thereof.

Still more preferred, the enzyme in the detergent composition is a protease, an amylase, or a mixture thereof.

Still more preferred, the enzyme in the detergent composition is a protease, a lipase, or a mixture thereof.

Still more preferred, the enzyme in the detergent composition is selected from an amylase, a lipase, or a mixture thereof.

In some other embodiments, the enzyme in the detergent composition is a protease.

In yet some other variant, the enzyme in the detergent composition is an amylase.

In yet some other variant, the enzyme in the detergent composition is a lipase.

In yet some other variant, the enzyme in the detergent composition is a cellulase.

Preferred enzymes in detergent and compositions according to the present invention for laundry or textiles include a protease, a cellulase, a lipase, a peroxidase, or a combination thereof.

Preferred enzymes in detergent and compositions for carpets include a protease, an amylase, or a combination thereof.

For a stain remover, the enzymes are preferably selected from the group consisting of protease, amylase, lipase, mannanase, pectate lyase.

For a fabric softener, the enzymes are preferably cellulases.

In order to increase the bleaching effect, oxidoreductases are optionally added to the detergent composition according to the first and second aspect of the present invention.

The oxidoreductases are selected from the group consisting of oxidases, oxygenases, catalases, peroxidases, such as halo-, chloro-, bromo-, lignin-, glucose- or manganese-peroxidases, dioxygenases or laccases, such as phenoloxidases and polyphenoloxidases, and any mixture thereof.

Commercial enzymes are obtainable in liquid or dried form (i.e. puck, powder, etc.), are sold as raw aqueous solutions or in assorted purified, processed and compounded forms established in the prior art, and include about 0.1 to about 80% by weight active enzyme generally in combination with stabilizers, buffers, cofactors, impurities and inert vehicles. The actual active enzyme content depends upon the method of manufacture and is not critical; assuming the detergent has the desired enzymatic performance.

This includes for example the solid enzyme preparations obtained by granulation, extrusion or lyophilization or, particularly in the case of liquid or gel-like agents, solutions of the enzymes, advantageously as concentrated as possible, low in water and/or with added stabilizers. Alternatively, the enzymes can be encapsulated both for the solid and for the liquid administration form, for example by spray drying or extrusion of the enzyme solution together with a preferably natural polymer, or in the form of capsules, for example those in which the enzymes are enclosed, such as in a solidified gel, or in those of the core-shell type, in which an enzyme-containing core is coated with a protective layer that is impermeable to water, air, and/or chemicals. Further active substances, for example stabilizers, emulsifiers, pigments, bleaches or dyes, can additionally be applied in superimposed layers. Such capsules are applied using methods known per se, for example by vibratory or roll granulation or in fluidized bed processes. Advantageously, such granulates are low in dust, for example as a result of the application of polymeric film formers and are storage-stable on account of the coating. Furthermore, it is possible to package two or more enzymes together so that a single granulate exhibits multiple enzyme activities.

A valuable reference on enzymes is “Industrial Enzymes”, Scott, D., in Kirk-Othmer Encyclopedia of Chemical Technology, 3^{rd} Edition, (editors Grayson, M. and EcKroth, D.) Vol. 9, pp. 173 224, John Wiley & Sons, New York, 1980, which is incorporated herein in its entirety.

In a preferred variant according to the first and second aspect of the present invention, the enzyme added to the detergent is a single enzyme.

In some other variants, the enzyme added to the detergent composition is preferably an enzyme cocktail of two, three, four or even more different enzymes. Typically, for laundry detergents an enzyme cocktail contains from two (preferably protease and amylase) to six enzymes.

In a more preferred variant, the at least one enzyme is added to the detergent composition according to the present invention as enzyme formulation in mixture with one or more stabilizer(s), preferably with one or more enzyme stabilizers, and optionally buffers, additives, and the like.

Preferably, an enzyme stabilizer is added to the enzyme formulation for stabilizing the enzyme in the detergent composition from loss of performance (i.e. retain enzymatic activity or enzymatic retention). The enzymes are stabilized by the enzyme stabilizer through a physical protection by means of a protective layer.

The enzyme formulation may vary based upon the particular enzymes employed.

The at least one enzyme employed herein is stabilized by the presence of water-soluble sources of calcium and/or magnesium ions in the finished detergents which provide such ions to the enzymes. Calcium ions are generally somewhat more effective than magnesium ions and are preferred herein if only one type of cation is being used. Typical detergents, especially liquids, comprise from 1 to 30, preferably from 2 to 20, more preferably from 5 to 15, and most preferably from 8 to 12, millimoles of calcium ion per litre of finished composition.

It is to be understood that the foregoing levels of calcium and/or magnesium ions are sufficient to provide enzyme stability. More calcium and/or magnesium ions can be added to the compositions to provide an additional measure of grease removal performance. Accordingly, as a general proposition the compositions herein will typically comprise from 0.01 to 2% by weight of a water-soluble source of calcium or magnesium ions, or both. The amount can vary, of course, with the amount and type of enzyme employed in the composition.

Additional enzyme stability can be provided by the presence of various other art-disclosed stabilizers, especially borate species; see U.S. Pat. No. 4,537,706, which is incorporated herein in its entirety.

One group of stabilizers are reversible protease inhibitors. Benzamidine hydrochloride, borax, boric acids, boronic acids or their salts or esters are frequently used for this purpose, including in particular derivatives having aromatic groups. Typically, such enzyme stabilizers are used at levels in the compositions from 0.05 to 5%, more preferably from 0.075 to 3% by weight of boric acid or other borate compound capable of forming boric acid in the composition (calculated on the basis of boric acid). Boric acid is preferred, although other compounds such as boric oxide, borax and other alkali metal borates (e.g., sodium ortho-, meta- and pyroborate, and sodium pentaborate) are suitable. Substituted boric acids (e.g., phenylboronic acid, butane boronic acid, and p-bromo phenylboronic acid) can also be used in place of boric acid.

Also peptide aldehydes, i.e. oligopeptides having a reduced C-terminus, in particular those from 2 to 50 monomers, or hydrogen sulfite adducts thereof are used for this purpose. The peptidic reversible protease inhibitors include, but are not limited to, ovomucoid and leupeptin. Specific, reversible peptide inhibitors for the protease subtilisin and fusion proteins from proteases and specific peptide inhibitors are also suitable for this purpose.

Further enzyme stabilizers are amino alcohols such as mono-, di-, triethanol- and propanolamine and mixtures thereof, aliphatic carboxylic acids up to C12, such as succinic acid, other dicarboxylic acids or salts of the acids mentioned.

End-capped fatty acid amide alkoxylates are also suitable for this purpose.

Preferably, the enzyme stabilizer in the enzyme formulation is selected from the group consisting of polyols such as glycol, such as monopropylene glycol, glycerine, mannitol, isomaltol, lactic, sorbitol, xylitol, threitol, erythritol, arabitol; amino alcohols such as mono-, di-, triethanolamine and -propanolamine; aliphatic carboxylic acids up to C12, such as succinic acid and salts thereof; dicarboxylic acids and salts thereof; end-capped fatty acid amide alkoxylates; salts, preferably calcium and magnesium salts, such as calcium chloride, calcium formate, magnesium chloride, magnesium formate; reversible enzyme inhibitors such as borate-containing compositions, such as 4-FBPA, boron-free inhibitors, such as disubstituted alaninamide, sodium formate; and any mixture thereof.

The enzyme formulation with the enzyme stabilizer is added to the detergent composition in such amounts, that the enzyme stabilizer is present in the detergent composition in an amount of 0.0001 to 5% by weight, based on the total weight of the detergent. Preferably, the enzyme stabilizer is present in an amount of 0.001 to 4% by weight, based on the total weight of the detergent composition. Most preferred, the detergent composition includes the enzyme stabilizer in an amount of 0.01 to 3% by weight, based on the total weight of the composition.

Alternatively, and still more preferred, the at least one enzyme is added to the detergent according to the first and second aspect of the present invention as enzyme formulation in mixture with 1,2-heptanediol and/or 2,3-heptanediol or a specific type of dye transfer inhibitor booster (b), such as alkanediols, glyceryl caprylate, 4-hydroxyacetophenone, ethyl hexyl glycerin or tropolone, and optionally buffers, additives, and the like.

In a further preferred variant, the at least one enzyme is added to the detergent composition according to the first and second aspect of the present invention as enzyme formulation in mixture with an enzyme stabilizer and with 1,2-heptanediol and/or 2,3-heptanediol or a specific type of dye transfer inhibitor booster (b), such as alkanediols, glyceryl caprylate, 4-hydroxyacetophenone, ethyl hexyl glycerin or tropolone, and optionally buffers, and the like.

Surprisingly, it turned out that in such formulations the addition of 1,2-heptanediol and/or 2,3-heptanediol or a specific type of dye transfer inhibitor booster (b), such as alkanediols, glyceryl caprylate, 4-hydroxyacetophenone, ethyl hexyl glycerin or tropolone, enhances or boosts the effect of the enzyme stabilizers as specified above in such mixtures.

Unexpectedly, the combination of 1,2-heptanediol and/or 2,3-heptanediol or a specific type of dye transfer inhibitor booster (b), such as alkanediols, glyceryl caprylate, 4-hydroxyacetophenone, ethyl hexyl glycerin or tropolone, and an enzyme stabilizer results in an enhanced enzyme stabilizing effect in the detergent composition comprising an enzyme, in comparison to the use of the single enzyme stabilizer without the use of such dye transfer inhibitor boosters.

For the detergent composition according to the present invention, the list of the dye transfer inhibitor boosting agents (b1, b2, b3, b) specified herein can be arbitrary combined with the list of the enzyme stabilizers.

A remarkable enzyme stabilizing enhancing effect is observed, when one of the following dye transfer inhibitor boosting agents is used in combination with one or more of the above specified enzyme stabilizers:
1,2-pentanediol;
1,2-hexanediol;
1,2-heptanediol;
1,2-octanediol;
1,2-nonanediol;
1,2-decanediol;
1,2-undecanediol;
1,2-dodecanediol;
1,2-tridecanediol;
1,2-tetradecanediol;
glyceryl caprylate;
4-hydroxyacetophenone;
ethyl hexyl glycerin;
tropolone;
a mixture comprising 1,2-hexanediol and 1,2-octanediol;
a mixture comprising 1,2-hexanediol and 1,2-octanediol and tropolone; and
a mixture comprising 4-hydroxyacetophenone and 1,2-octanediol.

### Optional Further Components

Within the context of the present invention, it is also possible, and in some cases advantageous, to combine the detergents according to the first aspect or second aspect of the present invention with other active substances and/or additives, depending on the purpose of the composition, in order to obtain a ready-for-use composition or formulation. The active ingredients provide desired properties and functionalities to the detergents according to the present invention. The term “functional ingredient” or “functional additive” includes an ingredient that provides a beneficial property in a particular use. Some particular examples of functional ingredients are discussed in more detail below. However, a broad variety of other functional ingredients may be used.

The detergents according to the present invention may comprise any of the ingredients customarily found in such compositions, such as, for example organic solvents, builders, and additional auxiliaries such as soil repellents, thickeners, colourants and fragrances or the like

Preferably, the detergent according to the present invention can advantageously be combined or varied with at least one active substance and/or at least one (functional) additive, such as for example solvents, builders, bleaching agents, soil release agents, dispersing agents, foam inhibitors, sequestrant agents, chelating agents, anti-redeposition agents, dye scavengers, dyes, greying inhibitors, optical brighteners, ultraviolet light absorbers, thickeners or rheology modifiers, hydrotropes, solubility modifiers, pH-adjusting agents, buffers, solvents, anti-static agents, anti-wrinkling agents, antimicrobial agents, odor removal/odor capturing agents, ultraviolet light protection agents, fragrances, sanitizing agents, disinfecting agents, water repellency agents, insect repellency agents, anti-pilling agents, souring agents, mildew removing agents, allergicide agents, and any mixture thereof.

### Organic Solvents

Liquid light-duty detergents or heavy-duty detergents may comprise organic solvents, preferably those miscible with water. Polydiols, ethers, alcohols, ketones, amides and/or esters are preferably used as the organic solvent for this in amounts of 0 to 90 wt. %, preferably 0.1 to 70 wt. %, particularly 0.1 to 60 wt. %. Low molecular weight polar substances, such as for example, methanol, ethanol, propylene carbonate, acetone, acetonylacetone, diacetone alcohol, ethyl acetate, 2-propanol, ethylene glycol, propylene glycol, glycerine, diethylene glycol, dipropylene glycol monomethyl ether and dimethylformamide or their mixtures are preferred.

### Builders

Zeolites: Fine crystalline, synthetic zeolites containing bound water can be used as builders, for example, preferably zeolite A and/or P. Zeolite MAP® (commercial product of the Crosfield company), is particularly preferred as the zeolite P. However, zeolite X and mixtures of A, X, Y and/or P are also suitable. A co-crystallized sodium/potassium aluminum silicate from Zeolite A and Zeolite X, which is available as Vegobond® RX. (commercial product from Condea Augusta S.p.A.), is also of particular interest. Preferably, the zeolite can be used as a spray-dried powder. For the case where the zeolite is added as a suspension, this can comprise small amounts of nonionic surfactants as stabilizers, for example, 1 to 3 wt. %, based on the zeolite, of ethoxylated C12-C18 fatty alcohols with 2 to 5 ethylene oxide groups, C12-C14 fatty alcohols with 4 to 5 ethylene oxide groups or ethoxylated isotridecanols. Suitable zeolites have an average particle size of less than 10 μm (test method: volumetric distribution Coulter counter) and preferably comprise 18 to 22 wt. %, particularly 20 to 22 wt. % of bound water. Apart from this, phosphates can also be used as builders.

Layered silicates: Suitable substitutes or partial substitutes for phosphates and zeolites are crystalline, layered sodium silicates. These types of crystalline layered silicates are described, for example, in European Patent Application EP 0164514 A1. Preferred crystalline layered silicates are those obtained for example, from the process described in International Patent Application WO 91/08171 A1.

Amorphous silicates: Preferred builders also include amorphous sodium silicates with a modulus (Na₂O:SiO₂ ratio) of 1:2 to 1:3.3, preferably 1:2 to 1:2.8 and more preferably 1:2 to 1:2.6, which dissolve with a delay and exhibit multiple wash cycle properties. The delay in dissolution compared with conventional amorphous sodium silicates can have been obtained in various ways, for example, by surface treatment, compounding, compressing/compacting or by over-drying. In the context of this invention, the term “amorphous” also means “X-ray amorphous”. In other words, the silicates do not produce any of the sharp X-ray reflexions typical of crystalline substances in X-ray diffraction experiments, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This is to be interpreted to mean that the products have microcrystalline regions between 10 and a few hundred nm in size, values of up to at most 50 nm and especially up to at most 20 nm being preferred. This type of X-ray amorphous silicates, which similarly possess a delayed dissolution in comparison with the customary water glasses, are described, for example, in German Patent Application DE 4400024 A1. Compacted/densified amorphous silicates, compounded amorphous silicates and over dried X-ray-amorphous silicates are particularly preferred.

Phosphates: Also the generally known phosphates can also be added as builders, in so far that their use should not be avoided on ecological grounds. The sodium salts of the orthophosphates, the pyrophosphates and especially the tripolyphosphates are particularly suitable. Their content is generally not more than 25 wt. %, preferably not more than 20 wt. %, each based on the finished composition. In some cases it has been shown that particularly tripolyphosphates, already in low amounts up to maximum 10 wt. %, based on the finished composition, in combination with other builders, lead to a synergistic improvement of the secondary washing power. Preferred amounts of phosphates are under 10 wt. %, particularly 0 wt. %.

### Co-Builders

Polycarboxylic acids: Useful organic co-builders are, for example, the polycarboxylic acids usable in the form of their sodium salts of polycarboxylic acids, wherein polycarboxylic acids are understood to be carboxylic acids that carry more than one acid function. These include, for example, citric acid, adipic acid, succinic acid, glutaric acid, malic acid, tartaric acid, maleic acid, fumaric acid, sugar acids, aminocarboxylic acids, nitrilotriacetic acid (NTA) and its derivatives and mixtures thereof. Preferred salts are the salts of polycarboxylic acids such as citric acid, adipic acid, succinic acid, glutaric acid, tartaric acid, sugar acids and mixtures thereof.

Organic acids: Acids per se can also be used. Besides their building effect, the acids also typically have the property of an acidifying component and, hence also serve to establish a relatively low and mild pH in detergents or cleansing compositions. Citric acid, succinic acid, glutaric acid, adipic acid, gluconic acid and any mixtures thereof are particularly mentioned in this regard. Further suitable acidifiers are the known pH regulators such as sodium hydrogen carbonate and sodium hydrogen sulfate.

Polymers: Particularly suitable polymeric co-builders are polyacrylates, which preferably have a molecular weight of 2,000 to 20,000 g/mol. By virtue of their superior solubility, preferred representatives of this group are again the short-chain polyacrylates, which have molecular weights of 2,000 to 10,000 g/mol and, more particularly, 3,000 to 5,000 g/mol. Suitable polymers can also include substances that consist partially or totally of vinyl alcohol units or its derivatives.

Further suitable copolymeric polycarboxylates are particularly those of acrylic acid with methacrylic acid and of acrylic acid or methacrylic acid with maleic acid. Copolymers of acrylic acid with maleic acid, which comprise 50 to 90 wt. % acrylic acid and 50 to 10 wt. % maleic acid, have proven to be particularly suitable. Their relative molecular weight, based on free acids, generally ranges from 2,000 to 70,000 g/mol, preferably 20,000 to 50,000 g/mol and especially 30,000 to 40,000 g/mol. The (co)polymeric polycarboxylates can be added either as an aqueous solution or preferably as powder. In order to improve the water solubility, the polymers can also comprise allylsulfonic acids as monomers, such as, for example, allyloxybenzene sulfonic acid and methallyl sulfonic acid as in the EP 0727448 B1.

Biodegradable polymers comprising more than two different monomer units are particularly preferred, examples being those comprising, as monomers, salts of acrylic acid and of maleic acid, and also vinyl alcohol or vinyl alcohol derivatives, as in DE 4300772 A1, or those comprising, as monomers, salts of acrylic acid and of 2-alkylallyl sulfonic acid, and also sugar derivatives. Further preferred copolymers are those that are described in German Patent Applications DE 4303320 A1 and DE 4417734 A1 and preferably include acrolein and acrylic acid/acrylic acid salts or acrolein and vinyl acetate as monomers.

Similarly, other preferred builders are polymeric aminodicarboxylic acids, salts or precursors thereof. Those polyaspartic acids or their salts and derivatives disclosed in German Patent Application DE 19540086 A1 as having a bleach-stabilizing action in addition to co-builder properties are particularly preferred.

Further suitable builders are polyacetals that can be obtained by treating dialdehydes with polyol carboxylic acids that possess 5 to 7 carbon atoms and at least 3 hydroxyl groups, as described in European Patent Application EP 0280223 A1. Preferred polyacetals are obtained from dialdehydes like glyoxal, glutaraldehyde, terephthalaldehyde as well as their mixtures and from polycarboxylic acids like gluconic acid and/or glucoheptonic acid.

Carbohydrates. Further suitable organic co-builders are dextrins, for example, oligomers or polymers of carbohydrates that can be obtained by the partial hydrolysis of starches. The hydrolysis can be carried out using typical processes, for example, acidic or enzymatic catalyzed processes. The hydrolysis products preferably have average molecular weights in the range of 400 to 500,000 g/mol. A polysaccharide with a dextrose equivalent (DE) of 0.5 to 40 and, more particularly, 2 to 30 is preferred, the DE being an accepted measure of the reducing effect of a polysaccharide in comparison with dextrose, which has a DE of 100. Both maltodextrins with a DE between 3 and 20 and dry glucose syrups with a DE between 20 and 37 and also so-called yellow dextrins and white dextrins with relatively high molecular weights of 2,000 to 30,000 g/mol may be used. A preferred dextrin is described in British Patent Application 94 19 091.

The oxidized derivatives of such dextrins concern their reaction products with oxidizing compositions that are capable of oxidizing at least one alcohol function of the saccharide ring to the carboxylic acid function. Such oxidized dextrins and processes for their manufacture are known for example, from European Patent Applications EP 0232202 A1. A product oxidized at C6 of the saccharide ring can be particularly advantageous.

Oxydisuccinates and other derivatives of disuccinates, preferably ethylenediamine disuccinate are also further suitable co-builders. Here, ethylene diamine-N,N′-disuccinate (EDDS), the synthesis of which is described for example, in U.S. Pat. No. 3,158,615, is preferably used in the form of its sodium or magnesium salts. In this context, glycerine disuccinates and glycerine trisuccinates are also particularly preferred, such as those described in U.S. Pat. No. 4,524,009. Suitable addition quantities in zeolite-containing and/or silicate-containing formulations range from 3 to 15% by weight.

Lactones: Other useful organic co-builders are, for example, acetylated hydroxycarboxylic acids and salts thereof which optionally may also be present in lactone form and which contain at least 4 carbon atoms, at least one hydroxyl group and at most two acid groups. Such co-builders are described, for example, in International Patent Application WO 1995 020029 A1.

### Bleaching Compounds, Bleaching Agents and Bleach Activators

The detergents according to the present invention can optionally contain bleaching agents or bleaching compositions containing a bleaching agent and one or more bleach activators. When present, bleaching agents will typically be at levels of from about 1 to about 30%, more typically from about 5 to about 20%, of the detergent, especially for fabric laundering. If present, the amount of bleach activators will typically be from about 0.1 to about 60%, more typically from about 0.5 to about 40% of the bleaching composition comprising the bleaching agent-plus-bleach activator.

The bleaching agents used herein can be any of the bleaching agents useful for detergents in textile cleaning, hard surface cleaning, or other cleaning purposes that are known. These include oxygen bleaches as well as other bleaching agents. Perborate bleaches, e.g., sodium perborate (e.g., mono- or tetra-hydrate) can be used herein.

Another category of bleaching agent that can be used without restriction encompasses percarboxylic acid bleaching agents and salts thereof. Suitable examples of this class of agents include magnesium monoperoxyphthalate hexahydrate, the magnesium salt of meta-chloro perbenzoic acid, 4-nonylamino-4-oxoperoxybutyric acid and diperoxydodecanedioic acid.

Peroxygen bleaching agents can also be used. Suitable peroxygen bleaching compounds include sodium carbonate peroxyhydrate and equivalent “percarbonate” bleaches, sodium pyrophosphate peroxyhydrate, urea peroxyhydrate, and sodium peroxide. Persulfate bleach (e.g., OXONEO®, manufactured commercially by DuPont) can also be used.

A preferred percarbonate bleach comprises dry particles having an average particle size in the range from about 500 micrometres to about 1,000 micrometres, not more than about 10% by weight of said particles being smaller than about 200 micrometres and not more than about 10% by weight of said particles being larger than about 1,250 micrometres. Optionally, the percarbonate can be coated with silicate, borate or water-soluble surfactants. Percarbonate is available from various commercial sources.

Mixtures of bleaching agents can also be used.

In a preferred variant, the bleaching agent is selected from the group consisting of
chlorine bleaches, selected from the group consisting of sodium hypochlorite (NaOCl);
peroxygen bleaches, selected from the group consisting of
hydrogen peroxide (H2O2), alkali metal peroxide;
alkali metal perborates (SPB);
alkali metal percarbonates (SPC);
alkali metal perphosphates;
alkali metal persulfates;
percarboxylic acid bleaches and salts thereof, such as . . .
photoactivated bleaches, selected from sulfonated zinc and aluminium phthalocyanines;
chlorine or bromine releasing bleaches, such as heterocyclic N-bromo and N-chloroamides, such as trichloroisocyanuric acid, tribromoisocyanuric acid, dibromoisocyanuric acid and dichloroisocyanuric acid; hydantoin compounds, such as 1,3-dichloro-5,5-dimethylhydantoin;
   and any mixture thereof.

In a still more preferred are peroxygen bleaches and percarboxylic acid bleaches, particularly H2O2 used in stain remover and peracetic acid used in laundry powder detergent.

Peroxygen bleaching agents, the perborates, the percarbonates, etc., are preferably combined with bleach activators, which lead to the in-situ production in aqueous solution (i.e. during the washing process) of the peroxy acid corresponding to the bleach activator. The nonanoyloxybenzene sulfonate (NOBS) and tetraacetyl ethylene diamine (TAED) activators are typical, and mixtures thereof can also be used.

Preferred amido-derived bleach activators include (6-octanamido-caproyl)oxybenzene-sulfonate, (6-nonanamidocaproyl)oxybenzenesulfonate, (6-decanamido-caproyl)oxybenzenesulfonate, and mixtures thereof.

Another class of bleach activators comprises the benzoxazine-type activators disclosed in U.S. Pat. No. 4,966,723, incorporated herein by reference.

Highly preferred lactam activators include benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, nonanoyl valerolactam, 3,5,5-trimethylhexanoyl valerolactam and mixtures thereof, optionally adsorbed into solid carriers, e.g acyl caprolactams, preferably benzoyl caprolactam, adsorbed into sodium perborate.

Bleaching agents other than oxygen bleaching agents are also known in the art and can be utilized herein. One type of non-oxygen bleaching agent of particular interest includes photoactivated bleaching agents such as the sulfonated zinc and/or aluminium phthalocyanines. If used, detergents will typically contain from about 0.025 to about 1.25% by weight of such bleaches, especially sulfonate zinc phthalocyanine.

If desired, the bleaching compounds can be catalyzed by means of a manganese compound. Such manganese-based catalysts are well known in the art and include Mn^{IV}₂ (u-O)₃ (1,4,7-trimethyl-1,4,7-triazacyclononane)₂(PF₆)₂, Mn^{III}₂ (u-O)₁ (u-OAc)₂ (1,4,7-trimethyl-1,4,7-triazacyclononane)₂(ClO₄)₂, Mn^{IV}₄ (u-O)₆ (1,4,7-triazacyclononane)₄ (ClO₄)₄, Mn^{III}Mn^{IV}₄ (u-O)₁ (u-OAc)₂ (1,4,7-trimethyl-1,4,7-triazacyclononane)₂ (ClO₄)₃, Mn^{IV} (1,4,7-trimethyl-1,4,7-triazacyclononane)-(OCH₃)₃ (PF₆), and mixtures thereof.

As a practical matter, and not by way of limitation, the compositions and processes herein can be adjusted to provide on the order of at least one part per ten million of the active bleach catalyst species in the aqueous washing liquor and will preferably provide from about 0.1 ppm to about 700 ppm, more preferably from about 1 ppm to about 500 ppm, of the catalyst species in the laundry liquor.

### Soil Release Agents

Any polymeric soil release agent known to those skilled in the art can optionally be employed in the detergents and processes of this invention. Polymeric soil release agents are characterized by having both hydrophilic segments, to hydrophilize the surface of hydrophobic fibers, such as polyester and nylon, and hydrophobic segments, to deposit upon hydrophobic fibers and remain adhered thereto through completion of washing and rinsing cycles and, thus, serve as an anchor for the hydrophilic segments. This can enable stains occurring subsequent to treatment with the soil release agent to be more easily cleaned in later washing procedures.

The polymeric soil release agents useful herein especially include those soil release agents having: (a) one or more nonionic hydrophile components consisting essentially of (i) polyoxyethylene segments with a degree of polymerization of at least 2, or (ii) oxypropylene or polyoxypropylene segments with a degree of polymerization of from 2 to 10, wherein said hydrophile segment does not encompass any oxypropylene unit unless it is bonded to adjacent moieties at each end by ether linkages, or (iii) a mixture of oxyalkylene units comprising oxyethylene and from 1 to about 30 oxypropylene units wherein said mixture contains a sufficient amount of oxyethylene units such that the hydrophile component has hydrophilicity great enough to increase the hydrophilicity of conventional polyester synthetic fibre surfaces upon deposit of the soil release agent on such surface, said hydrophile segments preferably comprising at least about 25% oxyethylene units and more preferably, especially for such components having about 20 to 30 oxypropylene units, at least about 5 0% oxyethylene units; or (b) one or more hydrophobic components comprising (i) C₃ oxyalkylene terephthalate segments, wherein, if said hydrophobic components also comprise oxyethylene terephthalate, the ratio of oxyethylene terephthalate:C₃ oxyalkylene terephthalate units is about 2:1 or lower, (ii) C₄-C₆ alkylene or oxy C₄-C₆ alkylene segments, or mixtures therein, (iii) poly (vinyl ester) segments, preferably polyvinyl acetate), having a degree of polymerization of at least 2, or (iv) C₁-C₄ alkyl ether or C₄ hydroxyalkyl ether substituents, or mixtures therein, wherein said substituents are present in the form of C₁-C₄ alkyl ether or C₄ hydroxyalkyl ether cellulose derivatives, or mixtures therein, and such cellulose derivatives are amphiphilic, whereby they have a sufficient level of C₁-C₄ alkyl ether and/or C₄ hydroxyalkyl ether units to deposit upon conventional polyester synthetic fiber surfaces and retain a sufficient level of hydroxyls, once adhered to such conventional synthetic fibre surface, to increase fibre surface hydrophilicity, or a combination of (a) and (b).

Typically, the polyoxyethylene segments of (a) (i) will have a degree of polymerization of from about 200, although higher levels can be used, preferably from 3 to about 150, more preferably from 6 to about 100. Suitable oxy C₄-C₆ alkylene hydrophobic segments include, but are not limited to, end-caps of polymeric soil release agents.

Polymeric soil release agents useful in the present invention also include cellulosic derivatives such as hydroxyether cellulosic polymers, copolymeric blocks of ethylene terephthalate or propylene terephthalate with polyethylene oxide or polypropylene oxide terephthalate, and the like. Such agents are commercially available and include hydroxyethers of cellulose such as METHOCEL® (Dow). Cellulosic soil release agents for use herein also include those selected from the group consisting of C₁-C₄ alkyl and C₄ hydroxyalkyl cellulose.

Soil release agents characterized by poly(vinyl ester) hydrophobic segments include graft copolymers of poly(vinyl ester), e.g., C₁-C₆ vinyl esters, preferably poly(vinyl acetate) grafted onto polyalkylene oxide backbones, such as polyethylene oxide backbones, see EP 0 219 048, incorporated herein in its entirety. Commercially available soil release agents of this kind include the SOKALAN® type of material, e.g., SOKALAN® HP-22, available from BASF.

One type of preferred soil release agent is a copolymer having random blocks of ethylene terephthalate and polyethylene oxide (PEO) terephthalate. The molecular weight of this polymeric soil release agent preferably is in the range of from about 25,000 to about 55,000.

Another preferred polymeric soil release agent is a polyester with repeat units of ethylene terephthalate units contains 10-15% by weight of ethylene terephthalate units together with 90-80% by weight of polyoxyethylene terephthalate units, derived from a polyoxyethylene glycol of average molecular weight 300-5000. Examples of this polymer include the commercially available material ZELCON® 5126 (from DuPont) and MILEASE® T (from ICI).

Another preferred polymeric soil release agent is a sulfonated product of a substantially linear ester oligomer comprised of an oligomeric ester backbone of terephthaloyl and oxyalkyleneoxy repeat units and terminal moieties covalently attached to the backbone. These soil release agents are described fully in U.S. Pat. No. 4,968,451. Other suitable polymeric soil release agents include the terephthalate polyesters of U.S. Pat. No. 4,711,730, the anionic end-capped oligomeric esters of U.S. Pat. No. 4,721,580, the block polyester oligomeric compounds of U.S. Pat. No. 4,702,857, and anionic, especially sulfoaroyl, end-capped terephthalate esters of U.S. Pat. No. 4,877,896 all cited patents incorporated herein in their entirety.

Still another preferred soil release agent is an oligomer with repeat units of terephthaloyl units, sulfoisoterephthaloyl units, oxyethyleneoxy and oxy-1,2-propylene units. The repeat units form the backbone of the oligomer and are preferably terminated with modified isethionate end-caps. A particularly preferred soil release agent of this type comprises about one sulfoisophthaloyl unit, 5 terephthaloyl units, oxyethyleneoxy and oxy-1,2-propyleneoxy units in a ratio of from about 1.7 to about 1.8, and two end-cap units of sodium 2-(2-hydroxyethoxy)-ethanesulfonate. Said soil release agent also comprises from about 0.5 to about 20% by weight of the oligomer, of a crystalline-reducing stabilizer, preferably selected from the group consisting of xylene sulfonate, cumene sulfonate, toluene sulfonate, and mixtures thereof.

If utilized, soil release agents will generally comprise from about 0.01 to about 10.0% by weight, based on the total weight of the detergents, typically from about 0.1 to about 5%, preferably from about 0.2 to about 3.0%.

### Dispersing Agents

Polymeric dispersing agents can advantageously be utilized at levels from about 0.1 to about 7% by weight, based on the total weight of the in the detergents, especially in the presence of zeolite and/or layered silicate builders. Suitable polymeric dispersing agents include polymeric polycarboxylates and polyethylene glycols, although others known in the art can also be used. It is believed, though it is not intended to be limited by theory, that polymeric dispersing agents enhance overall detergent builder performance, when used in combination with other builders (including lower molecular weight polycarboxylates) by crystal growth inhibition, particulate soil release peptization, and anti-redeposition.

Polymeric polycarboxylate materials can be prepared by polymerizing or copolymerizing suitable unsaturated monomers, preferably in their acid form. Unsaturated monomeric acids that can be polymerized to form suitable polymeric polycarboxylates include acrylic acid, maleic acid (or maleic anhydride), fumaric acid, itaconic acid, aconitic acid, mesaconic acid, citraconic acid and methylenemalonic acid. The presence in the polymeric polycarboxylates herein or monomeric segments, containing no carboxylate radicals such as vinylmethyl ether, styrene, ethylene, etc. is suitable provided that such segments do not constitute more than about 40% by weight.

Particularly suitable polymeric polycarboxylates can be derived from acrylic acid. Such acrylic acid-based polymers which are useful herein are the water-soluble salts of polymerized acrylic acid. The average molecular weight of such polymers in the acid form preferably ranges from about 2,000 to 10,000, more preferably from about 4,000 to 7,000 and most preferably from about 4,000 to 5,000. Water-soluble salts of such acrylic acid polymers can include, for example, the alkali metal, ammonium and substituted ammonium salts. Soluble polymers of this type are known materials. Use of polyacrylates of this type in detergents has been disclosed, for example U.S. Pat. No. 3,308,067.

Acrylic/maleic-based copolymers can also be used as a preferred component of the dispersing/anti-redeposition agent. Such materials include the water-soluble salts of copolymers of acrylic acid and maleic acid. The average molecular weight of such copolymers in the acid form preferably ranges from about 2,000 to 100,000, more preferably from about 5,000 to 75,000, most preferably from about 7,000 to 65,000. The ratio of acrylate to maleate segments in such copolymers will generally range from about 30:1 to about 1:1, more preferably from about 10:1 to 2:1. Water-soluble salts of such acrylic acid/maleic acid copolymers can include, for example, the alkali metal, ammonium and substituted ammonium salts. Soluble acrylate/maleate copolymers of this type are known materials which are described in EP 0193360 A1, which also describes such polymers comprising hydroxypropylacrylate. Still other useful dispersing agents include the maleic/acrylic/vinyl alcohol terpolymers, for example, a 45/45/10 terpolymer of acrylic/maleic/vinyl alcohol.

Another polymeric material which can be included is polyethylene glycol (PEG). PEG can exhibit dispersing agent performance as well as act as a clay soil removal-antiredeposition agent. Typical molecular weight ranges for these purposes range from about 500 to about 100,000, preferably from about 1,000 to about 50,000, more preferably from about 1,500 to about 10,000.

Polyaspartate and polyglutamate dispersing agents can also be used, especially in conjunction with zeolite builders. Dispersing agents such as polyaspartate preferably have a molecular weight (avg.) of about 10,000.

### Foam Inhibitors/Suds Suppressors

Especially when used in automatic washing processes, it can be advantageous to add conventional foam inhibitors to the compositions. Suitable foam inhibitors include for example, soaps of natural or synthetic origin, which have a high content of C₁₈-C₂₄ fatty acids. Suitable non-surface-active types of foam inhibitors are, for example, organopolysiloxanes and mixtures thereof with microfine, optionally silanised silica and also paraffins, waxes, microcrystalline waxes and mixtures thereof with silanised silica or bis-stearyl ethylenediamide. Mixtures of various foam inhibitors, for example, mixtures of silicones, paraffins or waxes, are also used with advantage. Preferably, the foam inhibitors, especially silicone-containing and/or paraffin-containing foam inhibitors, are loaded onto a granular, water-soluble or dispersible carrier material. Especially in this case, mixtures of paraffins and bis-stearylethylene diamides are preferred.

Compounds for reducing or suppressing the formation of suds can be incorporated into the detergents of the present invention. Suds suppression can be of particular importance in the so-called “high concentration cleaning process” and in front-loading European-style washing machines.

A wide variety of materials can be used as suds suppressors, and suds suppressors are well known to those skilled in the art. See, for example, Kirk Othmer Encyclopedia of Chemical Technology, Third Edition, Volume 7, pages 430-447 (John Wiley & Sons, Inc., 1979). One category of suds suppressor of particular interest encompasses monocarboxylic fatty acid and soluble salts therein. The monocarboxylic fatty acids and salts thereof used as suds suppressor typically have hydrocarbyl chains of 10 to about 24 carbon atoms, preferably 12 to 18 carbon atoms. Suitable salts include the alkali metal salts such as sodium, potassium, and lithium salts, and ammonium and alkanolammonium salts.

The detergent according to the present invention can also contain non-surfactant suds suppressors. These include, for example: high molecular weight hydrocarbons such as paraffin, fatty acid esters (e.g., fatty acid triglycerides), fatty acid esters of monovalent alcohols, aliphatic C₁₈-C₄₀ ketones (e.g., stearone), etc. Other suds inhibitors include N-alkylated amino triazines such as tri- to hexa-alkylmelamines or di- to tetra-alkyldiamine chlortriazines formed as products of cyanuric chloride with two or three moles of a primary or secondary amine containing 1 to 24 carbon atoms, propylene oxide, and monostearyl phosphates such as monostearyl alcohol phosphate ester and monostearyl di-alkali metal (e.g., K, Na, and Li) phosphates and phosphate esters. The hydrocarbons such as paraffin and haloparaffin can be utilized in liquid form. The liquid hydrocarbons will be liquid at room temperature and atmospheric pressure and will have a pour point in the range of about −40° C. and about 50° C., and a minimum boiling point not less than about 110° C. (atmospheric pressure). It is also known to utilize waxy hydrocarbons, preferably having a melting point below about 100° C. Hydrocarbon suds suppressors are known in the art and include aliphatic, alicyclic, aromatic, and heterocyclic saturated or unsaturated hydrocarbons having from about 12 to about 70 carbon atoms. The term “paraffin,” as used in this suds suppressor discussion, is intended to include mixtures of true paraffins and cyclic hydrocarbons.

Another preferred category of non-surfactant suds suppressors comprises silicone suds suppressors. This category includes the use of polyorganosiloxane oils, such as polydimethylsiloxane, dispersions or emulsions of polyorganosiloxane oils or resins, and combinations of polyorganosiloxane with silica particles wherein the polyorganosiloxane is chemisorbed or fused onto the silica. Silicone suds suppressors are well known in the art.

Other silicone suds suppressors are disclosed in U.S. Pat. No. 3,455,839, incorporated herein in its entirety, which relates to compositions and processes for defoaming aqueous solutions by incorporating therein small amounts of polydimethylsiloxane fluids.

Mixtures of silicone and silanised silica are described, for instance, in DE-OS 2124526, incorporated herein in its entirety. Silicone defoamers and suds controlling agents in granular detergents are disclosed in U.S. Pat. No. 4,652,392, incorporated herein in its entirety.

In the preferred silicone suds suppressor used herein, the solvent for a continuous phase is made up of certain polyethylene glycols or polyethylene-polypropylene glycol copolymers or mixtures thereof (preferred), or polypropylene glycol. The primary silicone suds suppressor is branched/crosslinked and preferably not linear.

The silicone suds suppressor herein preferably comprises polyethylene glycol and a copolymer of polyethylene glycol/polypropylene glycol, all having an average molecular weight of less than about 1,000, preferably between about 100 and 800. The polyethylene glycol and polyethylene/polypropylene copolymers herein have a solubility in water at room temperature of more than about 2% by weight, preferably more than about 5% by weight.

The preferred solvent herein is polyethylene glycol having an average molecular weight of less than about 1,000, more preferably between about 100 and 800, most preferably between 200 and 400, and a copolymer of polyethylene glycol/polypropylene glycol, preferably PPG 200/PEG 300. Preferred is a weight ratio of between about 1:1 and 1:10, most preferably between 1:3 and 1:6, of polyethylene glycol:copolymer of polyethylene-polypropylene glycol.

The preferred silicone suds suppressors used herein do not contain polypropylene glycol, particularly of 4,000 molecular weight. They also preferably do not contain block copolymers of ethylene oxide and propylene oxide, like PLURONIC® L101.

Other suds suppressors useful herein comprise the secondary alcohols (e.g., 2-alkyl alkanols) and mixtures of such alcohols with silicone oils. The secondary alcohols include the C₆-C₁₆ alkyl alcohols having a C₁-C₁₆ chain. A preferred alcohol is 2-butyl octanol, which is available from Condea under the trademark ISOFOL® 12. Mixtures of secondary alcohols are available under the trademark ISALCHEM® 123 from Enichem. Mixed suds suppressors typically comprise mixtures of alcohol and silicone at a weight ratio of 1:5 to 5:1.

The detergent compositions herein will generally comprise from 0 to about 5% of suds suppressor. When utilized as suds suppressors, monocarboxylic fatty acids, and salts therein, will be present typically in amounts up to about 5% by weight of the detergent composition. Preferably, from about 0.5 to about 3% of fatty monocarboxylate suds suppressor is utilized. Silicone suds suppressors are typically utilized in amounts up to about 2.0% by weight of the detergent composition, although higher amounts can be used. This upper limit is practical in nature, due primarily to concern with keeping costs minimized and effectiveness of lower amounts for effectively controlling sudsing. Preferably from about 0.01 to about 1% of silicone suds suppressor is used, more preferably from about 0.25 to about 0.5%. As used herein, these weight percentage values include any silica that can be utilized in combination with polyorganosiloxane, as well as any adjunct materials that can be utilized. Monostearyl phosphate suds suppressors are generally utilized in amounts ranging from about 0.1 to about 2% by weight of the detergent composition. Hydrocarbon suds suppressors are typically utilized in amounts ranging from about 0.01 to about 5.0%, although higher levels can be used. The alcohol suds suppressors are typically used at 0.2 to 3% by weight of the finished compositions.

### Chelating Agents/Sequestrants and Other Complexing Agents

Furthermore, the detergent compositions according to the present invention can also optionally contain one or more chelating agents, capable of complexing iron, manganese and/or calcium ions. This additionally allows for a softening of water.

Chelating agents can be present in the acid or salt form including alkali metal, ammonium, and substituted ammonium salts thereof, and mixtures thereof.

Preferably the chelating agent is selected from the group consisting of amino carboxylates, phosphonates or mixtures thereof.

These agents as used herein include those chemicals which interact with divalent ions, cations and anions, having tendency to precipitate in their saturated aqueous solutions.

Suitable sequestrants/chelating agents are for example:

Useful amino carboxylate chelating agents include, but are not limited to, the following: N-(1,2-dicarboxy-ethyl)-D,L-aspartic acid (IDS), N-(2-hydroxyethyl)iminodiacetic acid (EDG), aspartic acid-N-monoacetic acid (ASMA), aspartic acid-N,N-diacetic acid (ASDA), aspartic acid-N-mono-propionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), a-alanine-N,N-diacetic acid (a—ALDA), serine-N,N-diacetic acid (SEDA), isoserine-N,N-diacetic acid (ISDA), phenylalanine-N,N-diacetic acid (PHDA), anthranilic acid-N,N-diacetic acid (AND A), sulfanilic acid-N, N-diacetic acid (SLDA), taurine-N,N-diacetic acid (TUDA), sulfomethyl-N,N-diacetic acid (SMDA), N-(hydroxyethyl)-ethylidenediaminetriacetate (HEDTA), diethanolglycine (DEG), aminotris(methylenephosphonic acid) (ATMP).

The preferred chelating agent may contain an amino group and may be, e.g., an amino-polycarboxylate or a phosphonate. It may be a monomeric molecule comprising one, two or three amino groups (typically secondary or tertiary amino groups), and it may contain two, three, four or five carboxyl groups or even more carboxyl groups. The chelating agents may be phosphorus containing or without phosphorus. Suitable chelating agents includes those based on carboxylate groups includes EDTA (ethylene diamine tetraacetate), NTA (2,2′,2″-nitrilotriacetate), citrate, 2-hydroxypropan-1,2,3-tricarboxylate, DTPA (diethylenetriaminepentaacetic acid), MGDA (methylglycinediacetic acid OT N,N′-bis(carboxymethyl)alanine), EGTA (ethylene glycol tetraacetic acid), EDDS (ethylenediamine-N,W-disuccinic acid), GLDA (L-Glutamic acid, N, N-diacetic acid), The composition preferably may also include other polycarboxylates such as PAA [poly(acrylic acid)], PAA/PMA [copoly(acrylic acid/maleic acid)], or mixtures thereof.

Another group of preferred chelating agents includes phosphonates. Aminoalkane and/or hydroxyalkane phosphonates are preferably used as phosphonates. Suitable examples of these phosphonate chelating agent includes HEDP (I-hydroxyethylidene-1,1-diphosphonic acid), EDTMP [ethylenediamine tetra(methylene phosphonic acid], EDTMPA (ethylenediaminetetramethylene-tetraphosphonic acid), DTPMP (diethylenetriamine penta (methylene phosphonic acid), DTMPA (diethylenetriaminepenta(methylenephosphonic acid)) nitrilotris(methylenephosphonic acid) (NTMP), 2-phosphonobutane-1,2,4-tricarboxylic acid (PBTC), ethylenediamine tetramethylene phosphonate (EDTMP), and the higher homologs thereof. Among the hydroxyalkane phosphonates, 1-hydroxyethane-1,1-diphosphonate (HEDP) is of particular importance. The chelating agents may contain nitrogen such as in EDTA, NTA, DTPA, PDTA, GLDA, MGDA, EDDS, EDTMP, EDTMPA, and DTPMP or ASMA, ASDA, ASMP, IDA, SMAS, SEAS, SMGL, SEGL, MIDA, a-ALDA, SEDA, ISDA, PHDA, ANDA, SLDA, TUDA, SMDA, HEDTA, DEG, ATMP, or mixtures thereof.

Particularly preferred chelating agents includes but are not limited to the following: ethylene-diamine-tetra-acetic acid (EDTA), diethylene triamine pentamethylene phosphonic acid (DTMPA, DTPMP), hydroxy-ethane diphosphonic acid (HEDP), ethylenediamine N,N-disuccinic acid (EDDS), methyl glycine di-acetic acid (MGDA), diethylene triamine penta acetic acid (DTPA), propylene diamine tetraacetic acid (PDTA), 2-hydroxypyridine-N-oxide (HPNO), methyl glycine diacetic acid (MGDA), glutamic acid N,N-diacetic acid (N,N-dicarboxymethyl glutamic acid tetrasodium salt (GLDA) and nitrilotriacetic acid (NTA) or mixtures thereof. The chelating agent may be present in their acid form or a salt, preferably the chelating agents may be present as a sodium, ammonium or potassium salt.

Especially preferred chelating agent includes diethylenetriamine pentacetic acid (DTPA), ethylenediamine-N,N′-disuccinic acid (EDDS) and 1,1-hydroxyethane diphosphonic acid (HEDP) or the alkali metal, potassium, alkaline earth metal, ammonium or substituted ammonium salts thereof, or mixtures thereof. The most preferred chelating agent is a phosphonate. The phosphonate chelating agent includes HEDP in its acid form or salt form with alkali metal, potassium, alkaline earth metal, ammonium or substituted ammonium.

Most preferred are the following chelating agents: GLDA, MGDA, citrate, HEDP, and any mixture thereof.

In the composition according to the present invention, the chelating agent is present in an amount from 0.1 to 10.0% by weight, preferably from 0.1 to 5.0% by weight, more preferably from 0.1% by weight to 3.0% by weight, more preferably from 0.1 to 1.0% by weight, based on the total weight of the composition.

Preferably the composition comprises at least 0.2% by weight chelating agent, based on the total weight of the composition, still preferably at least 0.3% by weight, still preferably at least 0.5% by weight, most preferably at least 0.6% by weight.

If utilized, these chelating agents are comprised from about 0.1 to about 10% by weight, based on the total weight of the detergents. More preferably, if utilized, the chelating agents are comprised from about 0.1 to about 3.0% by weight of such compositions.

### Anti-Redeposition Agents

The detergent composition disclosed herein can optionally contain one or more anti-redeposition agents preventing soil particles in the wash liquor from depositing back onto the surface of the cleaned fabric throughout the washing and rinsing cycle.

The detergent compositions of the present invention can optionally contain water-soluble ethoxylated amines having anti-redeposition properties. Granular detergent compositions which contain these compounds typically contain from about 0.01 to about 10.0% by weight of the water-soluble ethoxylates amines; liquid detergent compositions typically contain about 0.01 to about 5% by weight.

The most preferred anti-redeposition agent is ethoxylated tetraethylenepentamine. Exemplary ethoxylated amines are further described in U.S. Pat. No. 4,597,898. Other groups of preferred clay soil removal/anti-redeposition agents are the cationic compounds disclosed in EP 0111965 A1, the ethoxylated amine polymers disclosed in EP 0111984 A1, the zwitterionic polymers disclosed in EP 0112592 A1, and the amine oxides disclosed in U.S. Pat. No. 4,548,744. Another type of preferred antiredeposition agent includes the carboxy methyl cellulose (CMC) materials. These materials are well known in the art.

In a preferred variant, the anti-redeposition agent is selected from the group consisting of consisting of polyesters, polyacrylic acids, polyacrylates, such as sodium polyacrylate, polycarboxylic acids, such as polyaspartic acid (PAA), polycarboxylates, water-soluble ethoxylated amines, cellulose derivatives such as methylcellulose, ethylcellulose, hydroxyethyl cellulose, hydroxypropyl cellulose, sodium carboxymethyl cellulose (CMC), cellulose acetate, sodium carboxymethyl inulin, polyvinylpyrrolidone (PVP), polyvinylacetate (PVAC), polyvinylalcohol (PVA), polyethylene glycol (PEG), sodium alginate, modified starches, and any mixture thereof.

In the detergent compositions according to the present invention, the anti-redeposition agent is typically present in an amount of 0.01 to 10.0% by weight, preferred in an amount of 0.05 to 8.0% by weight, more preferred in an amount of 0.5 to 6.0% by weight, most preferred in an amount of 1.0 to 4.0% by weight, based on the total weight of the composition.

### Greying Inhibitors

Greying inhibitors have the function of maintaining the dirt that was removed from the fibers suspended in the washing liquor, thereby preventing the dirt from resettling. Water-soluble colloids of mostly organic nature are suitable for this, for example, the water-soluble salts of (co)polymeric carboxylic acids, glue, gelatines, salts of ether carboxylic acids or ether sulfonic acids of starches or celluloses, or salts of acidic sulfuric acid esters of celluloses or starches. Water-soluble, acid group-containing polyamides are also suitable for this purpose. Moreover, soluble starch preparations and others can be used as the above-mentioned starch products, e.g., degraded starches, aldehyde starches etc. Polyvinyl pyrrolidone can also be used. Preference, however, is given to the use of cellulose ethers such as carboxymethyl cellulose (Na salt), methyl cellulose, hydroxyalkyl celluloses and mixed ethers such as methyl hydroxyethyl cellulose, methyl hydroxypropyl cellulose, methyl carboxymethyl cellulose and mixtures thereof, as well as polyvinyl pyrrolidone, which can be added, for example, in amounts of 0.1 to 5 wt. %, based on the composition.

### Optical Brighteners and UV Adsorbers

The detergents according to the present invention can optionally contain from about 0.005 to 5% by weight of certain types of hydrophilic optical brighteners which also provide a dye transfer inhibition action. If used, the compositions herein will preferably comprise from about 0.01 to 1% by weight of such optical brighteners.

One preferred brightener is 4,4′-bis[(4-anilino-6-(N-2-bis-hydroxyethyl)-s-triazine-2-yl)amino]-2,2′-stilbenedisulfonic acid and disodium salt. This particular brightener species is commercially marketed under the trade name Tinopal-UNPA-GX® by Ciba-Geigy Corporation. Tinopal-UNPA-GX is the preferred hydrophilic optical brightener useful in the detergent compositions herein.

Another preferred brightener is 4,4′-bis[(4-anilino-6-(N-2-hydroxyethyl-N-methylamino)-s-triazine-2-yl)amino]2,2′-stilbenedisulfonic acid disodium salt. This particular brightener species is commercially marketed under the trade name Tinopal 5BM-GX® by Ciba-Geigy Corporation.

Another preferred brightener is 4,4′-bis[(4-anilino-6-morphilino-s-triazine-2-yl)amino]2,2′-stilbenedisulfonic acid, sodium salt. This particular brightener species is commercially marketed under the trade name Tinopal AMS-GX® by Ciba Geigy Corporation.

The specific optical brightener species selected for use in the present invention provide especially effective dye transfer inhibition performance benefits when used in combination with the selected dye transfer inhibiting agents described hereinbefore.

The combination of such selected polymeric materials (e.g., PVNO and/or PVPVI) with such selected optical brighteners (e.g., Tinopal UNPA-GX, Tinopal 5BM-GX and/or Tinopal AMS-GX) provides significantly better dye transfer inhibition in aqueous wash solutions than does either of these two detergent composition components when used alone. Without being bound by theory, it is believed that such brighteners work this way because they have high affinity for fabrics in the wash solution and therefore deposit relatively quick on these fabrics. The extent to which brighteners deposit on fabrics in the wash solution can be defined by a parameter called the “exhaustion coefficient”. The exhaustion coefficient is in general as the ratio of a) the brightener material deposited on fabric to b) the initial brightener concentration in the wash liquor. Brighteners with relatively high exhaustion coefficients are the most suitable for inhibiting dye transfer in the context of the present invention.

Of course, it will be appreciated that other, conventional optical brightener types of compounds can optionally be used in the present compositions to provide conventional fabric “brightness” benefits, rather than a true dye transfer inhibiting effect. Such usage is conventional and well-known to detergent formulations.

Any optical brighteners or other brightening or whitening agents known in the art can be incorporated at levels typically from about 0.05 to about 1.2% by weight, based on the total weight of the detergents.

Commercial optical brighteners which can be useful in the present invention can be classified into subgroups, which include, but are not necessarily limited to, derivatives of stilbene, pyrazoline, coumarin, carboxylic acid, methinecyanines, dibenzothiphene-5,5-dioxide, azoles, 5- and 6-membered-ring heterocycles, and other miscellaneous agents.

Preferred brighteners include the PHORWHITE® series of brighteners from Verona. Other brighteners disclosed in this reference include: Tinopal® UNPA, Tinopal CBS and Tinopal 5BM; available from Ciba-Geigy; Artic White® CC and Artic White CWD, available from Hilton-Davis; the 2-(4-stryl-phenyl)-2H-napthol [1,2-d]triazoles; 4,4′-bis-(1,2,3-triazol-2-yl)-stilbenes; 4,4′-bis(stryl)bisphenyls; and the aminocoumarins. Specific examples of these brighteners include 4-methyl-7-diethyl-amino coumarin; 1,2-bis(-venzimidazol-2-yl)ethylene; 1,3-diphenyl-phrazolines; 2,5-bis(benzoxazol-2-yl)thiophene; 2-stryl-napth-[1,2-d]oxazole; and 2-(stilbene-4-yl)-2H-naphtho-[1,2-d]triazole. Anionic brighteners are preferred herein.

The compositions may comprise e.g., derivatives of diaminostilbene disulfonic acid or alkali metal salts thereof as the optical brighteners. Suitable optical brighteners are, for example, salts of 4,4′-bis-(2-anilino-4-morpholino-1,3,5-triazinyl-6-amino)stilbene-2,2′-di-sulfonic acid or compounds of similar structure which contain a diethanolamino group, a methylamino group, an anilino group or a 2-methoxyethylamino group instead of the morpholino group. Brighteners of the substituted diphenylstyryl type may also be present, for example, the alkali metal salts of 4,4′-bis(2-sulfostyryl)diphenyl, 4,4′-bis(4-chloro-3-sulfostyryl)diphenyl or 4-(4-chlorostyryl)-4′-(2-sulfostyryl)diphenyl. Mixtures of the mentioned brighteners may also be used.

In addition, UV absorbers may also be added. These are compounds with distinct absorption abilities for ultra-violet radiation, which contribute as UV stabilizers as well as to improve the light stability of colourants and pigments both for textile fibers as well as for the skin of the wearer of textile products by protecting against the UV radiation that penetrates the fabric. In general, the efficient radiation-less deactivating compounds are derivatives of benzophenone, substituted with hydroxyl and/or alkoxy groups, mostly in position(s) 2 and/or 4. Also suitable are substituted benzotriazoles, additionally acrylates that are phenyl-substituted in position 3 (cinnamic acid derivatives), optionally with cyano-groups in position 2, salicylates, organic Ni complexes, as well as natural substances such as umbelliferone and the endogenous urocanic acid. In a preferred embodiment, the UV absorbers absorb UV-A and UV-B radiation as well as possible UV-C radiation and re-emit light with blue wavelengths, such that they additionally have an optical brightening effect. Preferred UV absorbers encompass triazine derivatives, e.g., hydroxyaryl-1,3,5-triazine, sulfonated 1,3,5-triazine, o-hydroxyphenylbenzotriazole and 2-aryl-2H-benzotriazole as well as bis(anilinotriazinyl-amino)stilbene disulfonic acid and their derivatives. Ultra-violet absorbing pigments like titanium dioxide can also be used as UV absorbers.

### Thickener

The compositions can also comprise common thickeners as well as viscosity regulators such as polyacrylates, polycarboxylic acids, polysaccharides and their derivatives, polyurethanes, polyvinyl pyrrolidones, castor oil derivatives, polyamine derivatives such as quaternized and/or ethoxylated hexamethylenediamines as well as any mixtures thereof. Preferred compositions have a viscosity below 10,000 mPa*s, measured with a Brookfield viscosimeter at a temperature of 20° C. and a shear rate of 50 min⁻

### Inorganic Salts

Further suitable ingredients of the composition are water-soluble inorganic salts such as bicarbonates, carbonates, amorphous silicates or mixtures of these, alkali carbonate and amorphous silicate are particularly used, principally sodium silicate with a molar ratio Na₂O:SiO₂ of 1:1 to 1:4.5, preferably of 1:2 to 1:3.5. Preferred compositions comprise alkaline salts, builders and/or co-builders, preferably sodium carbonate, zeolite, crystalline, layered sodium silicates and/or trisodium citrate, in amounts of 0.5 to 70% by weight, preferably 0.5 to 50% by weight, particularly 0.5 to 30% by weight anhydrous substance.

### Perfumes and Colourants/Dyes

The compositions can comprise further typical detergent composition ingredients such as perfumes and/or colourants, wherein such colourants are preferred that leave no or negligible colouration on the fabrics being washed. Preferred amounts of the totality of the added colourants are below 1 wt. %, preferably below 0.1 wt. %, based on the composition. The compositions can also comprise white pigments such as e.g., TiO₂.

### Antimicrobial Agent

The detergents can further include an antimicrobial agent.

Suitable antimicrobial agents include, but are not limited to, the antimicrobial classes such as phenolics, quaternary ammonium compounds, metal derivatives, amines, alkanol amines, nitro derivatives, analides, organosulfur and sulfur-nitrogen compounds and miscellaneous compounds. Exemplary phenolic agents include pentachlorophenol, orthophenylphenol, phenoxyethanol. Exemplary quaternary antimicrobial agents include benzalkonium chloride, cetylpyridiniumchloride, amine and nitro containing antimicrobial compositions such as hexahydro-1,3,5-tris(2-hydroxyethyl)-s-triazine, dithiocarbamates such as sodium dimethyldithiocarbamate, and a variety of other materials known in the art for their antimicrobial properties. Other exemplary antimicrobial agents include gluteraldehyde, Bronopol (2-bromo-2-nitropropane-1,3-diol), silver, and isothiazolones such as methylisothiazolinone, ethyl lauroyl arginate HCl, sold under the tradename Neolone™, sodium benzoate, benzyl alcohol, or methylbenzyl alcohol.

In a preferred variant according to the first and second aspect of the present invention, the detergent compositions are further combined with benzyl alcohol, methylbenzyl alcohol, phenoxyethanol, and any mixture thereof. Said substances have a broad-spectrum activity against microorganisms and are added to the detergent compositions for preservative and stabilizing purposes. In particular, the antimicrobial agents are added to liquid detergents due to their higher water content, which makes such compositions susceptible against microbial growth.

If an antimicrobial agent is included in the inventive detergent compositions, it is preferably in an amount between about 0.001% by weight and about 5% by weight.

The at least one dye transfer inhibitor is present in the detergent according to the first and second aspect of the present invention in an amount of 0.01 to 10% by weight, based on the total weight of the composition. Preferably, the at least one dye transfer inhibitor is present in an amount of 0.05 to 8.0% by weight, based on the total weight of the composition. More preferred, the detergent according to the first and second aspect of the present invention includes the at least one dye transfer inhibitor in an amount of 0.1 to 6.0% by weight, based on the total weight of the composition. Most preferred, the at least one dye transfer inhibitor is present in the detergent composition according to the first and second aspect in an amount of 0.5 to 3.0% by weight, based on the total weight of the composition.

For dye transfer inhibitor mixture the above amounts relate to the total content of the dye transfer inhibitors in the mixture, i.e. the amount is the sum of the content of all dye transfer inhibitors in the mixture.

The 1,2-heptanediol (b1) or the 2,3-heptanediol (b2) or the mixture comprising 1,2-heptanediol and 2,3-heptanediol (b3) according to the first aspect of the present invention is present in the detergent in an amount of 0.001 to 15.0% by weight, based on the total weight of the composition. In a preferred variant, the detergent comprises the 1,2-heptanediol (b1) or the 2,3-heptanediol (b2) or the mixture comprising 1,2-heptanediol and 2,3-heptanediol (b3) in an amount of 0.01 to 10.0% by weight, based on the total weight of the composition. In a more preferred variant, the 1,2-heptanediol (b1) or 2,3-heptanediol (b2) or the mixture comprising 1,2-heptanediol and 2,3-heptanediol (b3) is advantageously used in the detergent in an amount of at 0.1 to 5.0% by weight, based on the total weight of the composition. In a still more preferred variant, the 1,2-heptanediol (b1) or 2,3-heptanediol (b2) or the mixture comprising 1,2-heptanediol and 2,3-heptanediol (b3) is advantageously used in the detergent in an amount of at 0.3 to 3.0% by weight, based on the total weight of the composition. In a most preferred variant, the 1,2-heptanediol (b1) or 2,3-heptanediol (b2) or the mixture comprising 1,2-heptanediol and 2,3-heptanediol (b3) is advantageously used in the detergent in an amount of at 0.5 to 1.0% by weight, based on the total weight of the composition.

For the heptanediol mixture (b3), the above amounts relate to the total content of the 1,2-heptanediol and the 2,3-heptanediol in the mixture, i.e. the amount is the sum of the content of 1,2-heptanediol and 2,3-heptanediol in the mixture.

The at least one dye transfer inhibitor boosting agent (b) according to the second aspect of the present invention is present in the detergent in an amount of 0.001 to 15.0% by weight, based on the total weight of the composition. In a preferred variant, the detergent comprises the at least one dye transfer inhibitor boosting agent (b) in an amount of 0.01 to 10.0% by weight, based on the total weight of the composition. In a more preferred variant, the at least one dye transfer inhibitor boosting agent (b) is advantageously used in the detergent in an amount of at 0.1 to 5.0% by weight, based on the total weight of the composition. In a still more preferred variant, the at least one dye transfer inhibitor boosting agent (b) is advantageously used in the detergent in an amount of at 0.3 to 3.0% by weight, based on the total weight of the composition. In a most preferred variant, the at least one dye transfer inhibitor boosting agent (b) is advantageously used in the detergent in an amount of at 0.5 to 1.0% by weight, based on the total weight of the composition.

For the alkane mixture comprising at least one first linear alkanediol and one or more second linear alkanediol, the above amounts relate to the total content of the first linear alkanediol and the second linear alkanediol(s) in the mixture, i.e. the amount is the sum of the content of the first linear alkanediol and the second linear alkanediol in the mixture.

In a particular preferred variant according to the first aspect of the present invention, the detergent comprises the 2,3-heptanediol or the 2,3-heptanediol of the mixture comprising 1,2-heptanediol and 2,3-heptanediol (b3) in an amount of 0.001 to 15.0% by weight, preferred in an amount of 0.01 to 10.0% by weight, more preferred in an amount of 0.1 to 5.0% by weight, still more preferred in an amount of 0.3 to 3.0% by weight, and most preferred in an amount of 0.5 to 1.0% by weight, based on the total weight of the composition.

Even more preferred, the detergent comprises the 2,3-heptanediol or the 2,3-heptanediol of the mixture comprising 1,2-heptanediol and 2,3-heptanediol (b3) in an amount of 0.001 to 0.5% weight, preferably in an amount of 0.005 to 0.1% by weight and most preferably in an amount of 0.01 to 0.075% by weight, based on the total weight of the composition or homecare product.

In a particular preferred variant according to the second aspect of the present invention, the detergent comprises the 2,3-alkandediol as linear alkanediol or of the mixture comprising at least one first linear alkanediol and one or more second linear alkanediol in an amount of 0.001 to 15.0% by weight, preferably in an amount of 0.01 to 10.0% by weight, more preferred in an amount of 0.1 to 5.0% by weight, still more preferred in an amount of 0.3 to 3.0% by weight, and most preferred in an amount of 0.5 to 1.0% by weight, based on the total weight of the composition or homecare product.

Even more preferred, the detergent comprises the 2,3-alkanediol as linear alkanediol or of the mixture comprising at least one first linear alkanediol and one or more second linear alkanediol in an amount of 0.001 to 0.5% weight, preferably in an amount of 0.005 to 0.1% by weight and most preferably in an amount of 0.01 to 0.075% by weight, based on the total weight of the composition or homecare product.

Typically, the at least one surfactant is present in the detergent composition according to the first and second aspect of the present invention in an amount of 0.001 to 90% by weight, based on the total weight of the composition. Preferably, the surfactant is present in an amount of 0.001 to 60% by weight, based on the total weight of the composition. More preferred, the detergent according to the present invention comprises the surfactant in an amount of 0.01 to 50% by weight and most preferred in an amount of 0.1 to 40% by weight, based on the total weight of the composition.

For a surfactant mixture the above amounts relate to the total content of the surfactants in the mixture, i.e. the amount is the sum of the content of all surfactants in the mixture.

By contrast, light-duty compositions according to the first and second aspect of the present invention comprise the at least one surfactant in an amount of 0.001 to 40% by weight, based on the total weight of the composition. Preferably, the surfactant is present in an amount of 0.005 to 30% by weight, based on the total weight of the composition. The dish cleaning and/or rinsing composition according to the present invention comprises the surfactant in an amount of 0.01 to 25% by weight and preferred in an amount of 0.1 to 20% by weight, based on the total weight of the composition.

The enzyme(s) is/are normally incorporated into the detergent according to the disclosure in an amount sufficient to yield effective cleaning during a washing procedure. An amount effective for cleaning refers to an amount that produces a clean, sanitary, and, preferably, corrosion free appearance to the material cleaned, particularly for medical or dental devices or instruments. An amount effective for cleaning also can refer to an amount that produces a cleaning, stain removal, soil removal, whitening deodorizing, or freshness improving effect on substrates such as medical or dental devices or instruments and the like. Such a cleaning effect can be achieved with amounts of enzyme as low as about 0.02% by weight of the detergent.

In the detergents of the present disclosure, suitable cleaning can typically be achieved when an enzyme is present at about 0.0001 to about 35 wt-%; preferably about 2 to about 15 wt-%; preferably about 3 to about 10 wt-%; preferably about 4 to about 8 wt-%; preferably about 4, about 5, about 6, about 7, or about 8 wt-%. The higher enzyme levels are typically desirable in highly concentrated cleaning formulations.

The enzyme is present in the detergent according to the first and second aspect of the present invention in an amount of 0.0001 to 5% by weight, based on the total weight of the composition. Preferably, the enzyme is present in an amount of 0.0001 to 4% weight, based on the total weight of the composition. More preferred the detergent according to the present invention comprises the enzyme in an amount of 0.001 to 3% by weight, based on the total weight of the composition. Most preferred the enzyme is present in the detergent in an amount of 0.01 to 2% by weight, based on the total weight of the composition.

Typically, the enzyme is present in the detergent according to the first and second aspect of the present invention in an amount of 0.05 to 2.0% by weight. Usually, proteases and amylase are used in higher concentrations in the detergents, namely proteases in an amount of 0.4 to 1.5% by weight, amylases in an amount of 0.05 to 0.6% by weight, based on the total weight of the composition.

For an enzyme cocktail the above amounts relate to the total content of the enzymes in the mixture, i.e. the amount is the sum of the content of all enzymes in the mixture. When an enzyme formulation, as defined above, is used, the above amounts relate to the concentration of the enzyme in the detergent composition.

It is unexpectedly observed that adding a dye transfer inhibitor booster or a mixture thereof as defined herein improves the efficacy of a dye transfer inhibitor in a detergent composition during the washing process.

It is surprisingly observed that the addition of a dye transfer inhibitor boosting agent or a dye transfer inhibitor boosting cocktail as specified above enhances the inhibitory effect of a dye transfer inhibitor in a detergent.

Surprisingly, it has been found that the addition of an effective amount of 1,2-heptanediol or 2,3-heptanediol or a mixture comprising 1,2-heptanediol and 2,3-heptanediol or a specific type of dye transfer inhibitor booster, such as alkanediols, glyceryl caprylate, 4-hydroxyacetophenone, ethyl hexyl glycerin or tropolone, to a detergent comprising a dye transfer inhibitor, has a positive influence on the dye transfer inhibitor in that they significantly enhance overall performance of a detergent composition by efficiently enhancing the activity of the dye transfer inhibitor.

The detergent compositions of the current disclosure, comprising a combination of a dye transfer inhibitor and a dye transfer inhibitor boosting agent, are found, surprisingly, to provide a superior stability against dye transfer during laundry. By adding a dye transfer inhibitor boosting agent or a dye transfer inhibitor boosting cocktail as specified above to a detergent containing a dye transfer inhibitor transfer of colour of coloured textiles to uncoloured or differently coloured textiles during their joint washing in an aqueous liquor can be prevented or at least reduced. As a result, dye transfer, and, thus, discolouration during laundry does not occurs or is at least minimize. Thus, the detergents according to the present invention have a better overall performance compared to detergents without the addition of an inventive dye transfer inhibitor boosting agent. Thus, dye transfer or discolouration upon laundry is prevented or at least minimized.

Without being bound by theory, it is assumed that with the addition of a dye transfer inhibitor booster as specified herein, a protective layer, specially preferred a coating, is created on the surface of the substrate to be washed; this protective layer prevents dye loss. In addition, alkanediols reduce the surface tension, thus giving detergent ingredients access to soil, surface etc. The reduction of the surface tension also facilitates dye transfer inhibitors to access the surface and protect the dyes.

Surprisingly, with the dye transfer inhibitor boosting agent according to the present invention, the detergent shows an improved dye transfer inhibition effect, and, thus are superior to compositions comprising only a customary dye transfer inhibitor. Without the use of an inventive dye transfer inhibitor boosting agent, the dye transfer inhibitory effect of a detergent comprising a dye transfer inhibitor, would be inferior, so that overall performance of the detergent would be reduced upon use. Thus, the improvement in turn leads to a better overall performance compared to the performance of a detergents that does not contain such dye transfer inhibitor booster.

Accordingly, the use of a dye transfer inhibitor boosting agent as described herein in a detergent, has numerous beneficial results, including improving dye transfer inhibition of a dye transfer inhibitor, and, thus minimizing the transfer of colour of coloured textiles to uncoloured or differently coloured textile during their joint washing. Thus, the cleaning property of the detergent is better than in a detergent that does not contain said dye transfer inhibitor boosting agent.

Surprisingly, the dye transfer inhibitor boosting agents provides for an anti-redeposition enhancing effect over broad washing temperature ranges. Hence, the inventive dye transfer inhibitor boosting agents are not only efficient in a wash or cleaning process at high washing temperatures such as from 40 to 90° C., but also in low washing temperatures ranging from 20 to 40° C. which makes them specifically suitable for low temperature washing, e.g. washing of synthetic fabrics, while not diminishing the dye transfer inhibition and cleaning performance.

Unexpectedly, the dye transfer inhibitor boosting effect is not achieved only with cotton fabrics but also with synthetic fabric, such as a polyester, nylon and the like, or a synthetic-cotton blend.

Additionally, it was found that the dye transfer inhibitor boosting agents have a good solubility in a broad range of detergents compositions, thus require relatively low dosages in order to achieve the desired dye transfer inhibitor boosting effect.

The dye transfer inhibitor boosting effect is demonstrated in the following examples by real washing/cleaning tests. As shown in this disclosure, a use solution produced from the detergent according to the present invention, results in minimizing discolouration or does not result in discolouration compared to a detergent without the addition of an inventive dye transfer inhibitor boosting agent. This dye transfer inhibitor boosting effect results in a more effective detergent composition.

Beneficially, the dye transfer inhibition improvement further allows to reduce the amount of dye transfer inhibitors commonly found in detergents. Because of the enhanced inhibitory effect by the addition of the dye transfer inhibitor boosting agent in the detergent of the present disclosure, it is possible for the detergent composition to use less dye transfer inhibitor to achieve a similar dye transfer inhibiting effect.

Because of the superior dye transfer inhibiting effect of the detergent of the present disclosure, it is possible for the composition to have reduced or to even be free of other stabilizers commonly found in existing detergents, such as hydrophilic optical brighteners which also provide a dye transfer inhibition action. Such specific hydrophilic optical brighteners are described below.

According to a further aspect of the present invention, the detergent according to the first and second aspect of the present invention is used as such or for the preparation of a detergent product.

The combination of dye transfer inhibitors and dye transfer inhibitor boosting agents such as alkanediols, glyceryl caprylate, 4-hydroxyacetophenone, ethyl hexyl glycerin and/or tropolone in a detergent composition provides for an improved dye transfer inhibition during laundry/cleaning. Thus, the detergent compositions according to the present invention are particularly suitable detergents for laundry. Especially, the detergent compositions according to the present invention are particularly beneficial in preventing or minimizing the transfer of colour of coloured textiles to uncoloured or differently coloured textiles during their joint washing and rinsing in an aqueous liquor.

The detergents or products as specified herein can be employed in a variety of washing or cleaning methods. As used herein, the term “cleaning” refers to perform, facilitate, or aid in soil removal, bleaching, microbial population reduction, disinfection, etc. Preferably, the detergents or products are useful for textile cleaning, laundry, fabric care, namely for household, medical, institutional and industrial application.

As used herein, the term “fabric cleaning” includes detergents designed for cleaning soiled substrate. Such compositions include but are not limited to, laundry detergent compositions, fabric softening compositions, fabric enhancing compositions, fabric freshening compositions, laundry prewash, laundry pre-treat, laundry additives, spray products, dry cleaning agents or compositions, laundry rinse additive, wash additive, post-rinse fabric treatment, ironing aids, unit dose formulations, delayed delivery formulations, detergent contained on or in a porous substrate or nonwoven sheet, substrate having fibres preferably said fibres including active agents, and other suitable forms that may be apparent to one skilled in the art.

Suitable examples of detergent products encompass heavy-duty detergents, colour-care detergents, light-duty detergents, all-purpose washing agents, fabric softeners, fabric laundry scents, scent lotions, laundry wipes, stain removers, bleach, laundry additives, and the like.

The afore-mentioned detergent compositions are preferably in liquid, solid, gelled, bar, paste, spray, tablet, encapsulated, diluted or concentrated form and optionally in two-compartment or multi-compartment form.

As used herein, liquid includes free-flowing liquids, as well as pastes, gels, foams and mousses. Gases, e.g. suspended bubbles, or solids, e.g. particles, may be included within the liquids.

A solid as used herein, includes powders, flakes, granules, pellets, tablets, microcapsules, beads, noodles, pearlized balls, lozenges, pucks, briquettes, bricks, blocks, or another solid form known to those of skill in the art.

A solid detergent or product can be provided as a pressed solid block, a cast solid block, an extruded pellet or block, or a tablet. Furthermore, a solid detergent composition or product may be provided in the form of a unit dose. A unit dose refers to a solid detergent unit sized so that the entire unit is used during a single washing cycle.

A solid detergent or product may also be provided in the form of a multiple use (e.g., multi-use) solid, such as, a block or a plurality of pellets, and can be repeatedly used to generate aqueous use solutions of the detergent composition for multiple cycles or a predetermined number of dispensing cycles. A multiple use solid detergent composition can be repeatedly used to generate an aqueous detergent composition, e.g., use solution, for multiple washing cycles. Pressed solid detergent blocks are made suitable to provide stability such that reactive components in the compositions do not react with each other until a point of dilution and/or use. In some aspects, the order of introducing the components to form the solid are non-limiting as there is minimal and/or no water introduced into the solid compositions. However, in some aspects, pressed solid detergent blocks are made by using a binding system to minimize any damage to the coated granules which may be employed. Beneficially, a pressing process to make the pressed solid detergent blocks generates a pressed solid detergent block and prevents the reaction or mix of the components. In an aspect of the disclosure, the solid detergent composition remains unreacted or unmixed until a point of use, e.g. dilution.

In a pressed solid process, a flowable solid, such as granular solids or other particle solids including binding agents are combined under pressure. In a pressed solid process, flowable solids of the compositions are placed into a form (e.g., a mold or container). The method can include gently pressing the flowable solid in the form to produce the solid cleaning composition.

The detergents or products can be provided in concentrated form and diluted to a use solution or provided in a use solution. Preferably, the use compositions are diluted to a concentration between about 500 ppm and about 5000 ppm, more preferably between about 750 ppm and about 4500 ppm, most preferably between about 1000 ppm and about 4000 ppm.

The detergents or products according to the present invention are used for household cleaning, medical cleaning, institutional cleaning, such as cleaning in schools, airport, hospitals, or industrial cleaning.

The detergents or products according to the present invention can be prepared by combining and mixing the various ingredients according to usual and known methods. Preferably, the enzyme is added last to prevent denaturation or inactivation of the enzyme. Mixing can be performed by any suitable automatic or manual method. For example, automatic or manual stirring can be performed. The detergent compositions can be prepared in batch or continuous process.

Based on its advantageous dye transfer inhibiting effect, the detergent composition according to the present invention, comprising a combination of a dye transfer inhibitor and dye transfer inhibitor boosting agents such as alkanediols, glyceryl caprylate, 4-hydroxyacetophenone, ethyl hexyl glycerin and/or tropolone, is particularly efficient during the joint washing of coloured textiles and uncoloured or differently coloured textiles. No dye transfer of colour of coloured textiles to uncoloured or differently coloured textiles during their joint washing and rinsing in an aqueous liquor takes place, and, thus discolouration upon laundry is prevented or at least minimized

Thus, the present invention relates in a further aspect to a method of treating a stained and/or soiled substrate, comprising the steps of
treating the substrate with the detergent composition or product according to the present invention; and
rinsing said substrate in water to remove said composition or product.

Preferably, the method of treating a stained and/or soiled substrate takes place in a washing containing a wash liquor comprising water and the detergent composition according to the present invention. The wash liquor may be applied to the substrate or the substrate may be immersed into the wash liquor.

The method may alternatively comprise direct application of the detergent composition, i.e. undissolved without water, on to part or whole of the substrate, so as to directly treat a stain and/or soil on the substrate. Such a process is preferably a pre-treatment and may be followed by treatment with or within a wash liquor.

The method according to the present invention is applied at both higher temperatures and well as lower temperatures. Laundry applications, for example, clean laundry at temperatures in excess of approximately 40° C., or in excess of approximately 50° C., or between approximately 65° C. to 90° C.

Preferably, the method is applied at low temperatures where removal of stain and/or soil is more problematic. Preferably, the treatment temperature is less than 50° C. and preferably less than 40° C. and more preferably less than 30° C.

Surprisingly it turned out, that the detergent composition or product according to the present invention is particularly efficient at said low temperatures.

Thus, the method allows for removal of stain and/or soil in a low temperature range.

This is particularly advantageous in the treatment of sensitive substrates such as wool, silk, and synthetic fibers such as polyester, polyacrylic, nylon, which can be washed or cleaned only at low temperatures.

Preferably, the substrate is cotton.

More preferably, the substrate is wool or silk.

Still more preferred, the substrates are blended fabrics such as cotton and polyester, or synthetic fibers, such as polyester, polyacrylic, or nylon.

It was surprisingly found that the use of 1,2-heptanediol or 2,3-heptanediol or a mixture comprising 1,2-heptanediol and 2,3-heptanediol or at least one boosting agent (b) as specified herein enhances the activity of a dye transfer inhibitor in a detergent during laundry. Hence, with the addition of said dye transfer inhibitor boosting agents to a detergent, laundry, washed with such detergent does not discolour, when uncoloured laundry items are washed together with coloured laundry items or different coloured laundry items are washed together. The use of the above substances in combination with a dye transfer inhibitor in a detergent prevents discolouration in laundry, where coloured textiles and uncoloured or differently coloured textiles are washed together.

The dye transfer inhibitor increasing effect in turn leads to a better overall performance of the detergent composition compared to the performance of a detergent that does not contain such dye transfer inhibitor booster.

Due to the above-described boosting effect, the dye transfer inhibiting boosting agents alkanediols, glyceryl caprylate, 4-hydroxyacetophenone, ethyl hexyl glycerin and/or tropolone, as defined herein, are particularly beneficial in improving the dye transfer inhibition when used in combination with dye transfer inhibitors commonly used in a detergent composition. The use of the detergent or product according to the present invention minimizes of prevents the transfer of colour of coloured textiles to uncoloured or differently coloured textiles during their joint washing and rinsing in an aqueous liquor, and, thus, results in an improved overall cleaning performance. Therefore, the detergent composition or product is highly beneficial in a method of washing textiles.

Based on the advantageously boosting effect, as described above for the dye transfer inhibitor boosters, the present invention relates in a further aspect to the use of 1,2-heptanediol or 2,3-heptanediol or a mixture comprising 1,2-heptanediol and 2,3-heptanediol or at least one dye transfer inhibitor boosting agent (b) selected from the group consisting of
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined herein;
(b^{II}) glyceryl caprylate;
(bIII) 4-hydroxyacetophenone;
(b^{IV}) ethyl hexyl glycerin;
(b^{V}) tropolone; and
any mixture thereof;
for enhancing the activity of a dye transfer inhibitor in a detergent.

With respect to the dye transfer inhibitors and preferred variants thereof, reference is made to the previous description of the dye transfer inhibitors in connection with the detergents according to the present invention, which is equally valid in connection with the use of 1,2-heptanediol or 2,3-heptanediol or a mixture comprising 1,2-heptanediol and 2,3-heptanediol or at least one dye transfer inhibitor booster (b) for boosting/enhancing the activity of a dye transfer inhibitor in a detergent, in order to avoid repetition.

Preferably, the dye transfer inhibitor is selected from the group consisting of polyamine-N-oxide polymers, copolymers of N-vinylpyrrolidone and N-vinylimidazole, polyvinylpyrrolidone polymers, poylvinyloxazolidones, polyvinylimidazoles, manganese phthalocyanine, copolymers based on vinylmonomers and carboxamides, pyrrolidone group containing polyesters and polyamides, grafted polyamidoamines and polyethyleneimines, polyvinyl alcohols, copolymers based on acrylamidoalkenylsulfonic acids, polyvinylpyridine-N-oxide, poly-N-carboxymethyl-4-vinylpyridiumchlorid, and any mixture thereof.

In a preferred variant, the dye transfer inhibitor is selected from the group consisting of copolymers of N-vinylpyrrolidone and N-vinylimidazole, polyvinylpyrrolidone polymers, and any mixture thereof.

Surprisingly, it has been found that the use of an effective amount of 1,2-heptanediol or 2,3-heptanediol or a mixture comprising 1,2-heptanediol and 2,3-heptanediol or a specific type of dye transfer inhibitor boosting agents, such as alkanediols, glyceryl caprylate, 4-hydroxyacetophenone, ethyl hexyl glycerin or tropolone, to a detergent, has a positive influence on a dye transfer inhibitor contained therein, in that they significantly enhance overall performance by efficiently enhancing the activity of the dye transfer inhibitor. Thus, dye transfer or discolouration upon laundry is prevented or at least minimized.

Hence, the use of the dye transfer inhibitor booster according to the present invention is beneficial for enhancing the activity of a dye transfer inhibitor in a detergent.

The improvement also allows for the reduction of the amount of dye transfer inhibitor and/or of optical brighteners, which also provide a dye transfer inhibition action, in a detergent composition.

Based on the advantageously boosting effect, as described above for the dye transfer inhibitor boosters, the present invention relates in a further aspect to a method of enhancing the inhibitory effect of a dye transfer inhibitor in a detergent when using in laundry, comprising the steps of
(i) providing a detergent comprising a dye transfer inhibitor; and
(ii) adding thereto an effective amount of 1,2-heptanediol or 2,3-heptanediol or a mixture comprising 1,2-heptanediol and 2,3-heptanediol or at least one dye transfer inhibitor boosting agent (b) selected from the group consisting of
   (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined in any one of claims 2 to 10;
   (b^{II}) glyceryl caprylate;
   (b^{III}) 4-hydroxyacetophenone;
   (b^{IV}) ethyl hexyl glycerin;
   (b^{V}) tropolone; and
   any mixture thereof.

With respect to the dye transfer inhibitors and preferred variants thereof, reference is made to the previous description of the dye transfer inhibitors in connection with the detergents according to the present invention, which is equally valid in connection with the method of enhancing the activity of a dye transfer inhibitor in a detergent, in order to avoid repetition.

Preferably, the dye transfer inhibitor is selected from the group consisting of polyamine-N-oxide polymers, copolymers of N-vinylpyrrolidone and N-vinylimidazole, polyvinylpyrrolidone polymers, poylvinyloxazolidones, polyvinylimidazoles, manganese phthalocyanine, copolymers based on vinylmonomers and carboxamides, pyrrolidone group containing polyesters and polyamides, grafted polyamidoamines and polyethyleneimines, polyvinyl alcohols, copolymers based on acrylamidoalkenylsulfonic acids, polyvinylpyridine-N-oxide, poly-N-carboxymethyl-4-vinylpyridiumchlorid, and any mixture thereof.

In a preferred variant, the dye transfer inhibitor is selected from the group consisting of copolymers of N-vinylpyrrolidone and N-vinylimidazole, polyvinylpyrrolidone polymers, and any mixture thereof.

Surprisingly, the combination of a dye transfer inhibitor and dye transfer inhibitor boosting agents according to the present invention such as alkanediols, glyceryl caprylate, 4-hydroxyacetophenone, ethyl hexyl glycerin and/or tropolone, in a detergent results in an improved overall performance in comparison to a detergent without the use of such dye transfer inhibitor boosters. The detergent composition according to the present invention exhibit improved dye transfer inhibition, so that dye transfer and discolouration of laundry is prevented or at least minimized, when coloured textiles and uncoloured or differently coloured textiles are washed together in an aqueous liquor.

Hence, the addition of the dye transfer inhibitor boosting agents according to the present invention to a detergent composition, comprising a dye transfer inhibitor is beneficial in a method of enhancing the activity of a dye transfer inhibitor in a detergent composition.

Based on this advantageous effect, the detergents according to the present invention are highly suitable in laundry resulting in a better overall cleaning performance.

The improvement also allows for the reduction of the amount of dye transfer inhibitor and/or optical brighteners, which also provide a dye transfer inhibition action, in said method.

As shown in this disclosure, a use solution produced from the detergent according to the present invention, minimizes or prevents discolouration in a washing process compared to a detergent without the addition of an inventive dye transfer inhibitor boosting agent. This dye transfer inhibitor boosting effect results in a more effective detergent composition.

Surprisingly, it turned out that 4-hydroxyacetophenone has a particularly distinctive dye transfer inhibitor boosting property.

Hence, the present invention relates in a final aspect to the use of 4-hydroxyacetophenone as dye transfer inhibitor.

The present invention shall now be described in detail with reference to the following examples, which are merely illustrative of the present invention, such that the content of the present invention is not limited by or to the following examples.

### EXAMPLES

### Example 1

The following tests are performed to show dye transfer inhibition of different detergents comprising a dye transfer inhibitor in combination with different dye transfer inhibition boosting agents. according to the present invention.

### Example 1.1: Dye Transfer Inhibition According to AISE Test Protocol

The test is performed, according to AISE test protocol, in a GYROWASH (laundering device) which contains about 100 times lower water volume and used in a washing machine.

Colour donators (coloured fabrics) are mixed with white fabrics called colour acceptors (cotton and polyamide). The overall materials (donor and acceptor) are washed at 60° C. and 2.5 mmol/L.

After the washing process, colour bleeding is assessed by measuring the loss of colour (dE) in comparison with the unwashed fabric, by a spectrophotometer.

The measurements are converted in greying scale from 1 to 5: Score 1 means a huge dye transfer and score 5 means no dye transfer.

### Example 1.2: Dye Transfer Inhibition According to Revised EU Ecolabel Protocol for Testing Laundry Detergents

Laundering device: Linitest (preferred) or Tergotometer. The laundering device is described in EN ISO 105:C061997 “Textiles. Test of colourfastness. Colourfastness to domestic and commercial laundering”.

A water bath containing a routable shaft which supports, radially stainless steel containers (diameter 7.5±0.5 cm, height 12.0±0.5 cm) with 525±50 ml capacity each), the bottom of the containers is being 4.5±1 cm from the centre of the shaft. The shaft/container assembly is rotated at a frequency of 40±2 rpm. The temperature of the water bath is thermostatically controlled to maintain the test solution at the prescribed temperature±2° C.

The same liquor concentration and water hardness is used as in the washing machine. The product in test (amount for 1 l) is dispersed in 1 l of lukewarm water using a magnetic stirrer and then rapidly heated until the liquor reaches 40° C. Dye donator (0.3 g) and dye accepter (cotton and polyamide) are placed in the container (no addition of steel balls). Both textiles are not fixed to each other. The volume to give the correct liquor: fabric ratio 100:1 is added and the containers are placed in the preheated (40° C.) machine. Temperature raises 2° C. up to 60° C. and the wash is continued for 20 min at this temperature

Both dye acceptors (cotton and polyamide) are used for all 4 dye donators. After washes the textiles are removed and rinsed twice for 1 min in running warm water and then in cold running water for 10 min (same hardness as the test). Textiles are dried hanging in the air (no direct sun) To assess the dye transfer after one wash, colour differences between the standard cotton or polyamide piece washed without and with dye donator is determined by using a spectrophotometer.

The results are reported as “grey scale” figures. The colour differences are calculated according to EN ISO 105-J03:2009 “Textiles. Test for colour fastness. Calculation of colour differences”. Measurements are taken at two defined areas of the dye acceptor using an appropriate device as described in CIE 15:2004 “colourimetry”. The instrumental assessments on colour fastness are done according to EN ISO 105-A04:1997 “Textiles. Method for the instrumental assessment of the degree of staining of adjacent fabrics”. They are based on EN 20105-A03:1995 “Textiles. Test for colour fastness. Grey scale for assessing staining”. The measurement for all products to be compared is performed using one common calibration under the same conditions. -Measuring geometry: d/8°—D65/10° observer—With UV-filter (420 nm cut off)—Measuring diameter: minimum 20 mm—Gloss: without—Calibration: measurements shall be carried out at the latest 8 h after calibration with white tile and black trap.

As can be seen from the above tests, the detergent compositions according to the present invention show a better dye transfer inhibition effect, i.e. less dye transfer or discolouration, compared to a detergent composition comprising the same dye transfer inhibitor but without a dye transfer inhibitor boosting agent.

### Example 3: Formulation Examples

TABLE F1
Detergent liquid light duty

| No | Ingredients | Amount (%) |
|---|---|---|
| 1 | Cocos fatty acid | 0.85 |
| 2 | potassium hydroxide | 0.45 |
| 3 | 2-octyl-2H-isothiazol-3-one | 0.2 |
| 4 | Sulfonic acid, C 13-17-sec-Alkyl-, Sodium salt | 20 |
| 5 | Sodium Laureth Sulfate | 3 |
| 6 | Trideceth-9 | 5 |
| 7 | Sodium Chloride | 1.3 |
| 8 | 2,3-octanediol | 0.1 |
| 9 | 1,2-heptanediol | 0.9 |
| 10 | Fragrance | 0.5 |
| 11 | Protease (Subtilisin) | 0.6 |
| 12 | Amylase | 0.3 |
| 13 | Copolymers of N-vinylpyrrolidone and N- | 0.8 |
| | vinylimidazole | |
| 14 | Aqua | add to 100 |

TABLE F2
Detergent liquid light duty

| No | Ingredients | Amount (%) |
|---|---|---|
| 1 | Cocos fatty acid | 0.85 |
| 2 | potassium hydroxide | 0.45 |
| 3 | 2-octyl-2H-isothiazol-3-one | 0.2 |
| 4 | Sulfonic acid, C 13-17-sec-Alkyl-, Sodium salt | 20 |
| 5 | Sodium Laureth Sulfate | 3 |
| 6 | Trideceth-9 | 5 |
| 7 | Sodium Chloride | 1.3 |
| 8 | 2,3-heptanediol | 0.1 |
| 9 | 1,2-heptanediol | 0.9 |
| 10 | Fragrance | 0.5 |
| 11 | Protease (Subtilisin) | 0.5 |
| 12 | Copolymers of N-vinylpyrrolidone and N- | 0.8 |
| | vinylimidazole | |
| 13 | Aqua | add to 100 |

TABLE F3
Fabric softener

| No | Ingredients | Amount (%) |
|---|---|---|
| 1 | Di-(Talg Carboxyethyl) Hydroxyethyl | 5.5 |
| | methylammonium-methosulfate | |
| 2 | Simethicone | 0.3 |
| 3 | 2-octyl-2H-isothiazol-3-one | 0.1 |
| 4 | 1,2-heptanediol | 0.5 |
| 5 | Fragrance | 0.2 |
| 6 | Cellulase | 0.3 |
| 7 | Polyvinylpyrrolidone (PVP) | 0.7 |
| 8 | Aqua | add 100 |

TABLE F4
Fabric softener concentrate, encapsulated

| No | Ingredients | Amount (%) |
|---|---|---|
| 1 | Di-(Talg Carboxyethyl) Hydroxyethyl | 16.6 |
| | methylammonium-methosulfate | |
| 2 | 2-octyl-2H-isothiazol-3-one | 0.1 |
| 3 | Simethicone | 0.3 |
| 4 | magnesium chloride | 0.8 |
| 5 | encapsulated perfume oil | 0.3 |
| 6 | crosslinked cationic polymer | 0.15 |
| 7 | 1,2-heptanediol | 0.5 |
| 8 | Fragrance | 0.6 |
| 9 | Cellulase | 0.5 |
| 10 | Polyvinylpyrrolidone (PVP) | 0.7 |
| 11 | Aqua | add 100 |

TABLE F5
Fabric softener concentrate, encapsulated

| No | Ingredients | Amount (%) |
|---|---|---|
| 1 | Di-(Talg Carboxyethyl) Hydroxyethyl | 16.6 |
| | methylammonium-methosulfate | |
| 2 | 2-octyl-2H-isothiazol-3-one | 0.1 |
| 3 | Simethicone | 0.3 |
| 4 | magnesium chloride | 0.8 |
| 5 | encapsulated perfume oil | 0.3 |
| 6 | crosslinked cationic polymer | 0.15 |
| 7 | 2,3-heptanediol | 0.05 |
| 8 | 1,2-heptanediol | 0.5 |
| 9 | Fragrance | 0.6 |
| 10 | Cellulase | 0.5 |
| 11 | Polyvinylpyrrolidone (PVP) | 0.7 |
| 12 | Aqua | add 100 |

1. A detergent, comprising or consisting of
(a1) at least one dye transfer inhibitor;
(b1) 1,2-heptanediol;
(c1) at least one surfactant; and
(d1) optionally at least one enzyme or an enzyme formulation, comprising at least one enzyme;
or
(a2) at least one dye transfer inhibitor;
(b2) 2,3-heptanediol;
(c2) at least one surfactant; and
(d2) optionally at least one enzyme or an enzyme formulation, comprising at least one enzyme;
or
(a3) at least one dye transfer inhibitor;
(b3) a mixture comprising 1,2-heptanediol and 2,3-heptanediol;
(c3) at least one surfactant; and
(d3) optionally at least one enzyme or an enzyme formulation, comprising at least one enzyme.

2. A detergent, comprising or consisting of
(a) at least one dye transfer inhibitor;
(b) at least one dye transfer inhibitor booster selected from the group consisting of
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
(b^{II}) glyceryl caprylate;
(b^{III}) 4-hydroxyacetophenone;
(b^{IV}) ethyl hexyl glycerin;
(b^{V}) tropolone; and
any mixture thereof;
(c) at least one surfactant; and
(d) optionally at least one enzyme or an enzyme formulation, comprising at least one enzyme.

3. The detergent according to claim 2, wherein the at least one dye transfer inhibitor is selected from the group consisting of
polyamine-N-oxide polymers,
copolymers of N-vinylpyrrolidone and N-vinylimidazole,
polyvinylpyrrolidone polymers,
poylvinyloxazolidones,
polyvinylimidazoles,
manganese phthalocyanine
copolymers based on vinylmonomers and carboxamides,
pyrrolidone group containing polyesters and polyamides,
grafted polyamidoamines and polyethyleneimines,
polyvinyl alcohols,
copolymers based on acrylamidoalkenylsulfonic acids,
polyvinylpyridine-N-oxide,
poly-N-carboxymethyl-4-vinylpyridiumchlorid,
and any mixture thereof.

4. The detergent according to claim 2, wherein the at least one linear alkanediol or the first linear alkanediol is selected from the group consisting of pentanediol, hexanediol, heptanediol, octanediol, nonanediol, decanediol, undecanediol, dodecanediol, tridecanediol, and tetradecanediol; and/or
the second linear alkanediol is selected from the group consisting of pentanediol, hexanediol, heptanediol, octanediol, nonanediol, decanediol, undecanediol, dodecanediol, tridecanediol, and tetradecanediol.

5. The detergent according to claim 2, wherein the at least one linear alkanediol, the first linear alkanediol and/or the second linear alkanediol is an (x,x+1) constitutional isomer, wherein x stands for the number of the carbon atom in the alkanediol chain, to which the OH groups of the alkanediol are chemically bonded, in particular a 1,2-alkanediol, a 2,3-alkanediol, a 3,4-alkanediol, or mixtures thereof, preferably a 1,2-alkanediol or a 2,3-alkanediol.

6. The detergent according to claim 2, wherein the at least one linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof; and/or
the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

7. The detergent according to claim 6, wherein the at least linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof.

8. The detergent according to claim 6, wherein the mixture comprising at least one first linear alkanediol and one or more second linear alkanediol is selected from the group consisting of
a mixture comprising 1,2-pentanediol and 2,3-pentanediol;
a mixture comprising 1,2-hexanediol and 2,3-hexanediol;
a mixture comprising 1,2-heptanediol and 2,3-heptanediol;
a mixture comprising 1,2-octanediol and 2,3-octanediol;
a mixture comprising 1,2-nonanediol and 2,3-nonanediol;
a mixture comprising 1,2-decanediol and 2,3-decanediol;
a mixture comprising 1,2-undecanediol and 2,3-undecanediol;
a mixture comprising 1,2-dodecanediol and 2,3-dodecanediol;
a mixture comprising 1,2-tridecanediol and 2,3-tridecanediol; and
a mixture comprising 1,2-tetradecanediol and 2,3-tetradecanediol.

9. The detergent according to claim 6, wherein the linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and any mixture thereof.

10. The detergent according to claim 2,
(i) wherein the mixture comprising 1,2-heptanediol and 2,3-heptanediol comprises the 1,2-heptanediol and the 2,3-heptanediol in a ratio in a range of 90:10 to 95:5; or
(ii) wherein the mixture comprising at least one first linear alkanediol and one or more second linear alkanediol comprises the first linear alkanediol and the second alkanediol in a ratio in a range of 90:10 to 95:5.

11. The detergent according to claim 2, wherein the at least one surfactant is selected from the group consisting of anionic surfactants, cationic surfactants, nonionic surfactants, amphoteric/zwitterionic surfactants, and any mixture thereof.

12. The detergent according to claim 2, wherein
the anionic surfactant is selected from the group consisting of
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide;
and any mixture thereof;
the cationic surfactant is selected from the group consisting of
quaternary C8 to C18 alkyl ethanolamines;
quaternary C8 to C18 alkyl ammonium compounds;
C8 to C18 alkyl ammonium methosulfates;
and any mixture thereof;
the non-ionic surfactant is selected from the group consisting of
C6 to C18 fatty alcohols, ethoxylated with 1 to 12 moles ethylene oxide;
alkoxylated C6 to C18 fatty alcohols such as
C6 to C18 fatty alcohols, ethoxylated with 1 to 25 moles ethylene oxide,
C6 to C18 fatty alcohols, propoxylated with 1 to 15 moles propylene oxide,
C6 to C18 fatty alcohols, butoxylated with 1 to 10 moles butylene oxide,
and combinations thereof;
C6 to C18 sophorolipids;
C6 to C18 rhamnolipids;
C5 to C18 alkyl polyglycosides;
C6 to C18 alkanolamides;
C6 to C18 fatty acid ester alkoxylates;
and any mixture thereof; and
the amphoteric/zwitterionic surfactant is selected from the group consisting of
C10 to C18 N-(alkyl)-N,N-dimethylamine oxide;
C10 to C18 N-(alkyl)-N,N-bis(2-hydroxyethyl)amine oxide;
C10 to C18 alkyl amido propyl dimethyl amine oxide;
C10 to C18 alkylbetaines;
C10 to C18 alkylamidobetaines;
C10 to C18 sulfobetaines;
an any mixture thereof;
and any mixture of the above specified cationic, anionic, non-ionic and amphoteric/zwitterionic surfactants.

13. The detergent according to claim 2, wherein the at least one enzyme is selected from the group consisting of proteases, amylases, lipases, cellulases, cutinases, gluconases, peroxidases, pectinases, mannanases, esterases, hemicellulases, xylanases, phospholipases, pectate lyases, keratinases, reductases, nucleases (including DNase and/or RNase), phenoloxidases, lipoxygenases, ligninases, pullulanases, tannases, pentosanases, malanases, β-glucanases, arabinosidases, hyaluronidases, chondroitinases, oxidoreductases, and any mixture thereof.

14. The detergent according to claim 2, further comprising active substances and/or additives selected from the group consisting of solvents, builders, bleaching agents, soil release agents, dispersing agents, foam inhibitors, sequestrant agents, chelating agents, anti-redeposition agents, dye scavengers, dyes, greying inhibitors, optical brighteners, ultraviolet light absorbers, thickeners or rheology modifiers, hydrotropes, solubility modifiers, pH-adjusting agents, buffers, solvents, anti-static agents, anti-wrinkling agents, antimicrobial agents, odor removal/odor capturing agents, ultraviolet light protection agents, fragrances, sanitizing agents, disinfecting agents, water repellency agents, insect repellency agents, anti-pilling agents, souring agents, mildew removing agents, allergicide agents, and any mixture thereof.

15. The detergent according to claim 2, wherein the antimicrobial agent is selected from the group consisting of benzyl alcohol, methylbenzyl alcohol, phenoxyethanol, and any mixture thereof.

16. The detergent according to claim 2, comprising the dye transfer inhibitor in an amount of 0.5 to 3.0% by weight, based on the total weight of the composition.

17. The detergent according to claim 2, comprising the 1,2-heptanediol (b1) or the 2,3-heptanediol (b2) or the mixture comprising 1,2-heptanediol and 2,3-heptanediol (b3) or the at least one dye transfer inhibitor booster (b) in an amount of 0.5 to 1.0% by weight, based on the total weight of the composition.

18. The detergent according to claim 2, comprising the at least one surfactant in an amount of 0.1 to 40% by weight, based on the total weight of the composition.

19. The detergent according to claim 2, comprising the enzyme in an amount of 0.05 to 2% by weight, based on the total weight of the composition.

20.-22. (canceled)

23. A method of treating a stained and/or soiled substrate, comprising the steps of
treating the substrate with the detergent of claim 2; and
rinsing said substrate in water to remove said composition or product.

24.-26. (canceled)
